(19) United States
(12) Patent Application Publication
(10) Pub. No.: US 2018/0082521 A1
(43) Pub. Date: Mar. 22, 2018

(54) Gaming Machine

(71) Applicants: Universal Entertainment Corporation, Tokyo (JP); Aruze Gaming (Hong Kong) Limited, Kowloon (HK)

(72) Inventors: Hiroki MUNAKATA, Tokyo (JP); Bungo MATSUMURA, Tokyo (JP); Yoshikatsu MITSUISHI, Tokyo (JP)

(21) Appl. No.: 15/530,678

(22) Filed: Sep. 21, 2016

(51) Int. Cl. G07F 17/32; G07F 17/34

(52) U.S. Cl. CPC G07F 17/3213; G07F 17/3286; G07F 17/3246; G07F 17/34; G07F 17/3216; G07F 17/3267

(57) ABSTRACT

A gaming machine in which, in relation to repetitive game play, the monotony of the game involving the selection of an option is resolved is provided. When a predetermined condition is satisfied in a game run in a gaming machine, a selection game is executed so that one of options is selected and a benefit corresponding to the selected option is awarded. In the selection game, a process of displaying benefits associated with the respective options along with the options, a process of hiding the benefits associated with the respective options, a process of performing a display effect of shuffling the options, and a process of displaying the benefit corresponding to the selected option are executed.

### BACKGROUND OF THE INVENTION

### 1. Field of the Invention

The present invention relates to a gaming machine.

### 2. Description of Related Art

In a known gaming machine such as a slot machine, a bonus is awarded when a predetermined condition is established (e.g., a predetermined number of bonus symbols are stop-displayed). For example, in a known gaming machine, a gaming medium such as a coin is awarded or a game different from a slot game is awarded, when a predetermined condition is established.

In the game different from the slot game, plural options are displayed, one of the options is selected in response to an input from a player through an input device such as a button, and a benefit corresponding to the selected option is awarded (see, e.g., U.S. Patent Publication No. 2009/0104973 and U.S. Pat. No. 7,578,736B2).

In the game in which an option is selected as above, what benefit is to be awarded is typically unknown until an option is selected. Furthermore, the game in which an option is selected may be arranged such that, the type of a benefit to be awarded is randomly determined in advance before one of the options is selected, and the benefit having been randomly determined in advance is awarded no matter which option is selected by the player. The selection of an option loses substance in such a game, and hence the game involving the selection of an option is monotonous for players.

### BRIEF SUMMARY OF THE INVENTION

An object of the present invention is to provide a gaming machine in which, in relation to repetitive game play, the monotony of the game involving the selection of an option is resolved.

The present invention relates to a gaming machine including: a display device capable of displaying options; and
a storage device configured to store a benefit table in which benefits to be associated with the options are stored;
an input device which allows the options to be selectable; and a controller programmed to execute the processes of:
(A1) causing the options displayed on the display device to be randomly associated with the benefits stored in the benefit table, respectively;
(A2) displaying the benefits associated with the options, together with the options;
(A3) hiding the displayed benefits associated with the options;
(A4) executing effect display of shuffling the options;
(A5) receiving, by the input device, an input of selecting one of the options;
(A6) displaying the benefit associated with the one of the options selected by the input device; and
(A7) repeating the processes (A5) and (A6) for a predetermined number of times.

In the arrangement above, to begin with, as the benefits randomly associated with the options are displayed, the player recognizes in advance what types of benefits are available before the selection of the options. As such, it is possible to inform the whole picture of the benefits to the player. Thereafter, the displayed benefits are hidden, and effect display of mixing the options is executed, with the result that the options are shuffled and it becomes impossible or difficult to recognize which benefit is associated with each option. Subsequently, the selection of the options is received by the input device. As the benefit associated with the selected option is displayed, the player recognizes which benefit is selected from the plural benefits which have been informed in advance.

In addition to the above, the above-described gaming machine of the present invention is arranged such that
the controller is programmed to further execute a process of,
in the effect display of shuffling the options in the process (A4), executing effect display of moving the options so that the options intersect one another.

According to the arrangement above, because the options are moved in an intersecting manner as above, the options are shuffled at the points where the options intersect with one another, with the result that the player is unable to or hardly able to recognize which benefit corresponds to each option.

In addition to the above, the above-described gaming machine of the present invention is arranged such that
the controller is programmed to further execute a process of,
(A8) after the process (A7), displaying the benefits associated the options which are not selected.

This arrangement makes it possible to display the benefits corresponding to the options not selected. Because the benefits corresponding to all options are disclosed to the player, the player is able to verify his/her selection.

In addition to the above, the present invention relates to a gaming machine including: a display device capable of displaying plural options; and
a controller programmed to execute the processes of:
displaying the benefits associated with the options, together with the options;
hiding the displayed benefits associated with the options;
executing effect display of shuffling the options; and
displaying the benefit associated with the selected one of the options.

In the arrangement above, to begin with, as the benefits associated with the options are displayed, the player recognizes in advance what types of benefits are available before the selection of the options. As such, it is possible to inform the whole picture of the benefits to the player. Thereafter, the displayed benefits are hidden, and effect display of mixing the options is executed, with the result that the options are shuffled and it becomes impossible or difficult to recognize which benefit is associated with each option. Subsequently, as the benefit associated with the selected option is displayed, the player recognizes which benefit is selected from the plural benefits which have been informed in advance.

### Advantageous Effects

A gaming machine in which, in relation to repetitive game play, the monotony of the game involving the selection of an option is resolved is provided.

### BRIEF DESCRIPTION OF THE DRAWINGS

FIG. 1 shows the outline of game content of a slot machine according to an embodiment of the present invention.

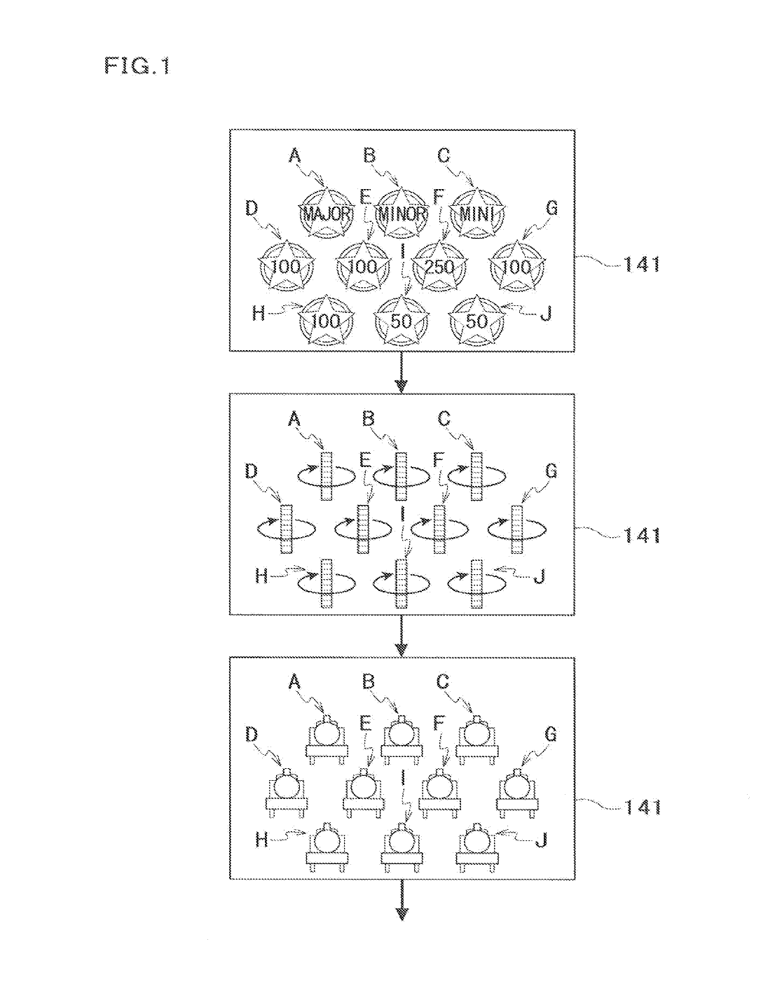

FIG. 2 shows a functional flow of the slot machine of the embodiment of the present invention.

FIG. 3 shows a game system including the slot machine of the embodiment of the present invention.

FIG. 4 shows the overall structure of the slot machine of the embodiment of the present invention.

FIG. 5 shows a control panel of the slot machine of the embodiment of the present invention.

FIG. 6 illustrates screens displayed on an upper image display panel and a lower image display panel of the slot machine of the embodiment of the present invention.

FIG. 7 shows winning lines of the slot machine of the embodiment of the present invention.

FIG. 8 shows symbol arrays on normal game video reels of the slot machine of the embodiment of the present invention.

FIG. 9 shows symbol arrays on normal game video reels of the slot machine of the embodiment of the present invention.

FIG. 10 shows symbol arrays on normal game video reels of the slot machine of the embodiment of the present invention.

FIG. 11 shows symbol arrays on normal game video reels of the slot machine of the embodiment of the present invention.

FIG. 12 shows symbol arrays on normal game video reels of the slot machine of the embodiment of the present invention.

FIG. 13 shows symbol arrays on normal game video reels of the slot machine of the embodiment of the present invention.

FIG. 14 shows symbol arrays on normal game video reels of the slot machine of the embodiment of the present invention.

FIG. 15 shows symbol arrays on normal game video reels of the slot machine of the embodiment of the present invention.

FIG. 16 shows symbol arrays on normal game video reels of the slot machine of the embodiment of the present invention.

FIG. 17 shows symbol arrays on normal game video reels of the slot machine of the embodiment of the present invention.

FIG. 18 shows symbol arrays on normal game video reels of the slot machine of the embodiment of the present invention.

FIG. 19 shows symbol arrays on free game video reels of the slot machine of the embodiment of the present invention.

FIG. 20 shows symbol arrays on free game video reels of the slot machine of the embodiment of the present invention.

FIG. 21 shows symbol arrays on free game video reels of the slot machine of the embodiment of the present invention.

FIG. 22 shows symbol arrays on free game video reels of the slot machine of the embodiment of the present invention.

FIG. 23 shows symbol arrays on free game video reels of the slot machine of the embodiment of the present invention.

FIG. 24 shows symbol arrays on JP free game video reels of the slot machine of the embodiment of the present invention.

FIG. 25 is a block diagram showing an internal structure of the slot machine of the embodiment of the present invention.

FIG. 26 shows a symbol combination table of the slot machine of the embodiment of the present invention.

FIG. 27 shows a payout level random determination table which is referred to by the slot machine of the embodiment of the present invention.

FIG. 28 shows a payout level random determination table which is referred to by the slot machine of the embodiment of the present invention.

FIG. 29 shows a payout level random determination table which is referred to by the slot machine of the embodiment of the present invention.

FIG. 30 shows payouts (in the normal game) of bonus symbols of each level, which are referred to by the slot machine of the embodiment of the present invention.

FIG. 31 shows payouts (in the normal game) of bonus symbols of each level, which are referred to by the slot machine of the embodiment of the present invention.

FIG. 32 shows payouts (in the normal game) of bonus symbols of each level, which are referred to by the slot machine of the embodiment of the present invention.

FIG. 33 shows payouts (in the normal game) of bonus symbols of each level, which are referred to by the slot machine of the embodiment of the present invention.

FIG. 34 shows payouts (in the normal game) of bonus symbols of each level, which are referred to by the slot machine of the embodiment of the present invention.

FIG. 35 shows payouts (in the normal game and the free game) of GOLD symbols of each level, which are referred to by the slot machine of the embodiment of the present invention.

FIG. 36 shows payouts (in the JP free game) of GOLD symbols of each level, which are referred to by the slot machine of the embodiment of the present invention.

FIG. 37 shows payout amounts (WIN) which are referred to by the slot machine of the embodiment of the present invention.

FIG. 38 shows a mystery progressive random determination table which is referred to by the slot machine of the embodiment of the present invention.

FIG. 39 shows a mystery progressive random determination table which is referred to by the slot machine of the embodiment of the present invention.

FIG. 40 shows a mystery progressive random determination table which is referred to by the slot machine of the embodiment of the present invention.

FIG. 41 shows an each-number-of-appearing-bonus-symbols change symbol random determination table which is referred to by the slot machine of the embodiment of the present invention.

FIG. 42 shows a ten-choice payout table random determination table which is referred to by the slot machine of the embodiment of the present invention.

FIG. 43 shows a ten-choice payout table random determination table which is referred to by the slot machine of the embodiment of the present invention.

FIG. 44 shows a ten-choice payout table random determination table which is referred to by the slot machine of the embodiment of the present invention.

FIG. 45 shows a ten-choice payout table which is referred to by the slot machine of the embodiment of the present invention.

FIG. 46 is a flowchart of a main control process in the slot machine of the embodiment of the present invention.

FIG. 47 is a flowchart of a bet/start-check process of the slot machine of the embodiment of the present invention.

FIG. 48 is a flowchart of a free game process of the slot machine related to the embodiment of the present invention.

FIG. 49 is a flowchart of a JP free game process of the slot machine related to the embodiment of the present invention.

FIG. 50 is a flowchart of a ten-choice pick game process of the slot machine related to the embodiment of the present invention.

FIG. 51 illustrates an effect image displayed on a digital signage of the slot machine of the embodiment of the present invention.

FIG. 52 illustrates game progress in the slot machine of the embodiment of the present invention.

FIG. 53 illustrates game progress in the slot machine of the embodiment of the present invention.

FIG. 54 illustrates game progress in the slot machine of the embodiment of the present invention.

FIG. 55 illustrates game progress in the slot machine of the embodiment of the present invention.

FIG. 56 illustrates game progress in the slot machine of the embodiment of the present invention.

FIG. 57 illustrates game progress in the slot machine of the embodiment of the present invention.

FIG. 58 illustrates game progress in the slot machine of the embodiment of the present invention.

FIG. 59 illustrates game progress in the slot machine of the embodiment of the present invention.

FIG. 60 illustrates game progress in the slot machine of the embodiment of the present invention.

FIG. 61 illustrates game progress in the slot machine of the embodiment of the present invention.

FIG. 62 illustrates game progress in the slot machine of the embodiment of the present invention.

FIG. 63 illustrates game progress in the slot machine of the embodiment of the present invention.

FIG. 64 illustrates game progress in the slot machine of the embodiment of the present invention.

FIG. 65 illustrates game progress in the slot machine of the embodiment of the present invention.

FIG. 66 illustrates game progress in the slot machine of the embodiment of the present invention.

FIG. 67 illustrates game progress in the slot machine of the embodiment of the present invention.

FIG. 68 illustrates game progress in the slot machine of the embodiment of the present invention.

FIG. 69 illustrates game progress in the slot machine of the embodiment of the present invention.

FIG. 70 illustrates game progress in the slot machine of the embodiment of the present invention.

FIG. 71 illustrates game progress in the slot machine of the embodiment of the present invention.

FIG. 72 illustrates game progress in the slot machine of the embodiment of the present invention.

FIG. 73 illustrates game progress in the slot machine of the embodiment of the present invention.

FIG. 74 illustrates game progress in the slot machine of the embodiment of the present invention.

FIG. 75 illustrates game progress in the slot machine of the embodiment of the present invention.

FIG. 76 illustrates game progress in the slot machine of the embodiment of the present invention.

FIG. 77 illustrates game progress in the slot machine of the embodiment of the present invention.

FIG. 78 illustrates game progress in the slot machine of the embodiment of the present invention.

FIG. 79 illustrates game progress in the slot machine of the embodiment of the present invention.

FIG. 80 illustrates game progress in the slot machine of the embodiment of the present invention.

FIG. 81 illustrates game progress in the slot machine of the embodiment of the present invention.

### DETAILED DESCRIPTION OF THE PREFERRED EMBODIMENT

### Outline of Embodiment

The following will describe an embodiment of the present invention with reference to the drawings. A slot game is played on a slot machine of the embodiment of the present invention. When a predetermined condition is satisfied in the slot game, a selection game is executed so that one of options is selected and a benefit corresponding to the selected option is awarded. In the selection game, a process of displaying benefits associated with the respective options along with the options, a process of hiding the benefits associated with the respective options, a process of performing a display effect of shuffling the options, and a process of displaying the benefit corresponding to the selected option are executed.

The slot game employs video reels displayed on a display. On the video reels, images of five reels are displayed. That is to say, the video reels are formed of images of a first reel, a second reel, a third reel, a fourth reel, and a fifth reel. In the present embodiment, “Left to Right” type with a different active area in response to a bet is adopted for determining the winning.

In a normal game, symbols to be rearranged in a display window are randomly selected from symbols provided on normal game video reels. The selected symbols are rearranged in the display window, and a result determination is carried out based on a combination of symbols rearranged on a payline activated by a bet. In accordance with the winning, a benefit is awarded. When a predetermined combination of symbols is established according to the result determination, the process proceeds to a free game or a JP free game which will be explained later. In the present embodiment, when a predetermined condition is satisfied in the JP free game, a pick game (selection game: later-described ten-choice pick game) is awarded. It is noted that benefits result not only a payout or an advantage for the player but also a disadvantage such as “lose”.

In the free game (including the JP free game), a game which does to require additional betting is run. The free game is not particularly limited to a specific game. In the present embodiment, a slot game is run in the free game in the same manner as in the normal game.

(Definitions and the Like)

Although the present embodiment describes a slot machine 1 as an example of the gaming machine, the disclosure is not limited to this. The normal game in the present embodiment is run by the slot machine 1. The normal game is a slot game of rearranging symbols. The rearrangement of the symbols in the slot game is performed by the video reels. In the normal game, on condition that a gaming value is bet, symbols are rearranged in the display window by the video reels, and a payout is awarded according to the rearranged symbols. In the present embodiment, the free game may be any type of game, provided that the free game provides a player with a different gaming state from that of the normal game. The “free game” is a game runnable with a bet of fewer gaming values than the normal game. Note that “bet of fewer gaming values” encompasses a bet of zero (0) gaming value. The “free game” therefore may be a game runnable without a bet of a gaming value, which free game awards an amount of gaming values based on symbols rearranged. In other words, the “free game” may be a game which is started without consumption of a gaming value. To the contrary, the “normal game” is a game runnable on condition that a gaming value is bet, which normal game awards an amount of gaming value based on the symbols rearranged. In other words, the “normal game” is a game which starts with consumption of a gaming value. Further, the “free game” is a game to which shifting occurs when a predetermined condition (free game trigger) is satisfied in the normal game.

The symbols here collectively means “WILD”, “RING”, “BIRD”, “DOG”, “SNAKE”, “ACE”, “KING”, “QUEEN”, “JACK”, “TEN”, “BONUS”, “GOLD”, and “FEATURE”.

The gaming value is electrically valuable information such as electronic money and the like. It is to be noted that the gaming value in the disclosure is not limited to these, and for example a gaming medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The term “rearrangement” indicates that the symbols are rearranged after the arrangement of the symbols is dismissed. Arrangement means a state where the symbols can be visually confirmed by a player. More specifically, “rearrangement” is a state in which, after the symbols on the reels are variably displayed as the reels rotate, the variable display of the symbols stops as the rotation of the reels stops, and the symbols stop in the display window.

(Functional Flow)

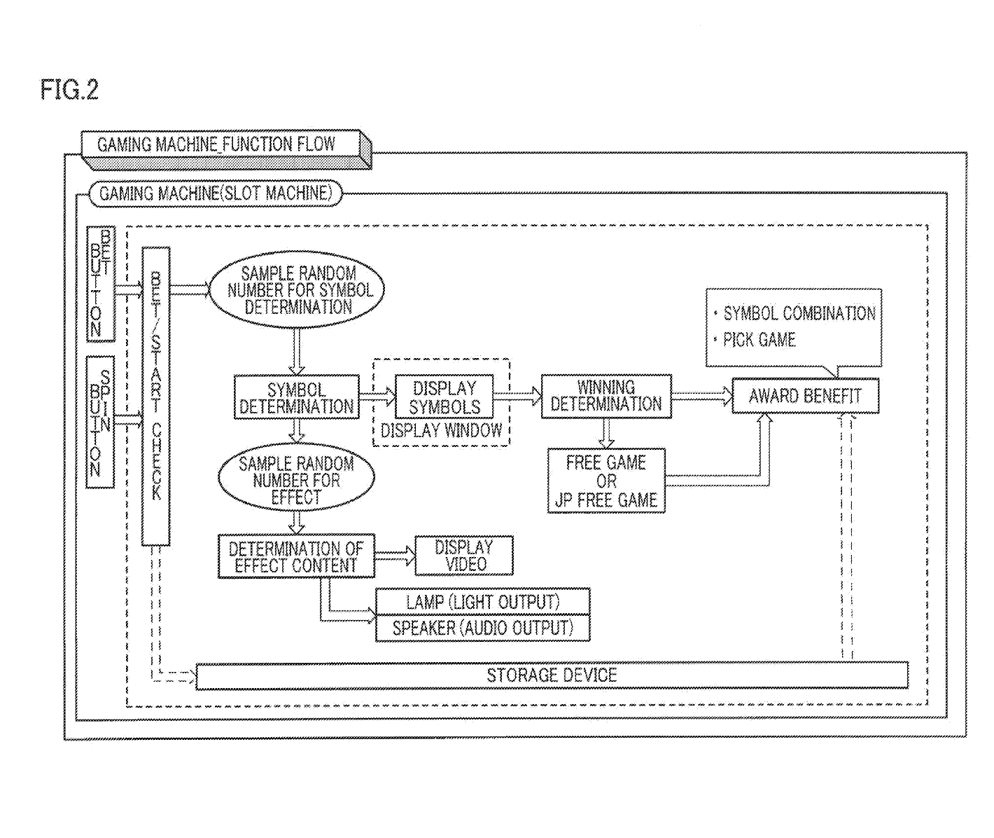

The following describes basic functions of the slot machine related to the embodiment of the present invention, with reference to FIG. 2. FIG. 2 shows the functional flow of the slot machine of the embodiment of the present invention.

<Bet/Start-Check>

First, the slot machine checks whether or not a BET button has been pressed by a player, and subsequently checks whether or not a spin button has been pressed by the player.

<Symbol Determination>

Subsequently, in the slot machine, when the spin button is pressed by the player, symbols to be displayed in the display window are randomly selected from symbols including a predetermined symbol, which are provided on the normal game video reels.

<Reel Display Control>

Thereafter, the slot machine starts the rotation of each reel and stops the rotation of each reel so that the determined symbols are displayed for the player through the display window (symbol display).

<Winning Determination>

Subsequently, as the rotation of each reel is stopped, the slot machine determines whether the combination of the symbols displayed for the player is a combination related to winning.

<Awarding Benefit>

When the combination of the symbols displayed for the player is a combination related to winning, the slot machine offers, to the player, a benefit (payout, free game, or JP free game) according to the combination. For example, when a combination of symbols related to awarding of a credit is displayed, the slot machine awards credits to the player, the amount of which corresponds to the combination of the symbols.

In the JP free game, a pick game is awarded when a predetermined combination of symbols is established. The pick game is a game in which a predetermined number of options are selected (picked) from options displayed on a game screen, and a benefit corresponding to the selected options is awarded.

The slot machine may have other benefits such as a mystery bonus and insurance. In the mystery bonus, a predetermined number of coins are paid out when a winning is achieved in dedicated random determination. When the spin button is pressed, the slot machine extracts a random number for the mystery bonus and randomly determines whether a mystery bonus trigger is established.

The insurance is a function for saving the player when the free game is not executed for a long period of time. Whether the insurance is activated or not is freely determined by an administrator of the slot machine. When the insurance is activated, a predetermined insurance activation amount must be paid. When the insurance is activated, the slot machine starts to count the number of plays of the game. When the counted number of plays reaches a predetermined number without a large amount of payout, the slot machine pays out coins, the amount of which has been set for the insurance.

<Determination of Effect>

The slot machine produces an effect by displaying an image on a display, outputting light from a lamp, and outputting sound from a speaker. The slot machine extracts an effect-use random number and determines the contents of the effect based on randomly determined symbols or the like.

[Overall Structure of Game System]

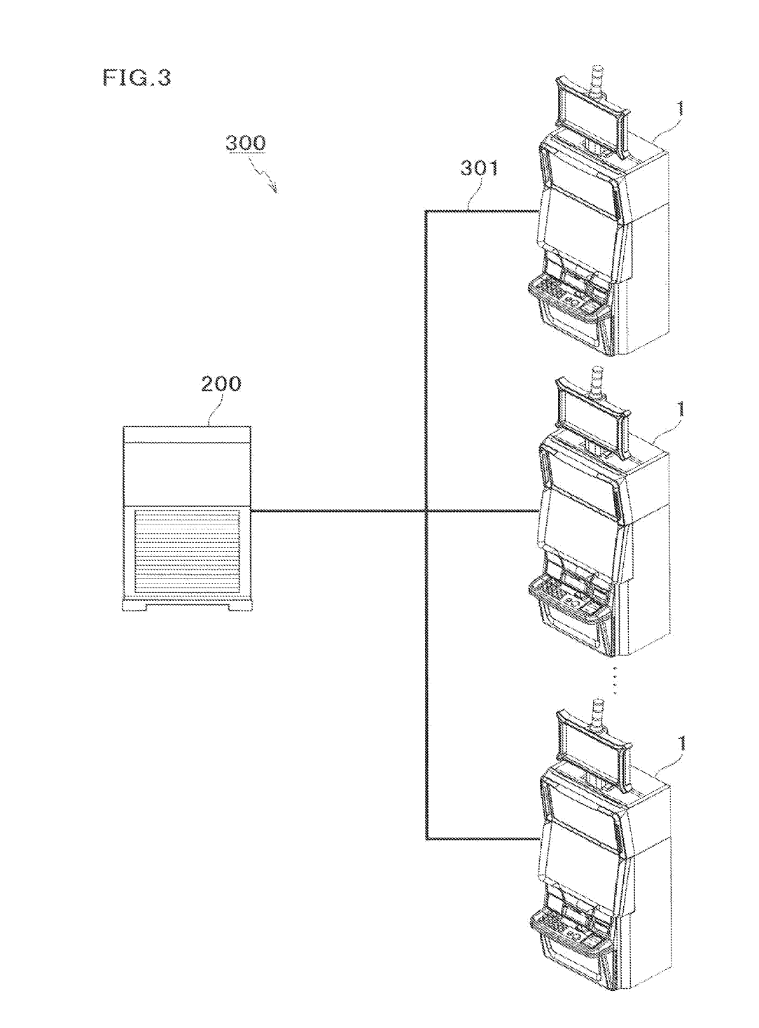

This concludes the description for the basic functions of the slot machine. Now, referring to FIG. 3, a game system including the slot machine will be described. FIG. 3 shows the game system including the slot machines of the embodiment of the present invention.

The game system 300 includes the slot machines 1 and an external controller 200 connected to each slot machine 1 over communication lines 301.

The external controller 200 is configured to control the slot machines 1. In the embodiment of the present invention, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, when transmitting data from the external controller 200 to any of the slot machines 1, the identification number is used for designating the transmission destination.

The game system 300 may be constructed in a single gaming facility such as a casino where various games are playable or may be constructed for a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line, or the like.

The game system 300 is of a network type in which the slot machines 1 are connected with the external controller 200 by a communication line 301, but the game system 300 may be of a standalone type in which each slot machine 1 independently executes a game.

[Overall Structure of Slot Machine]

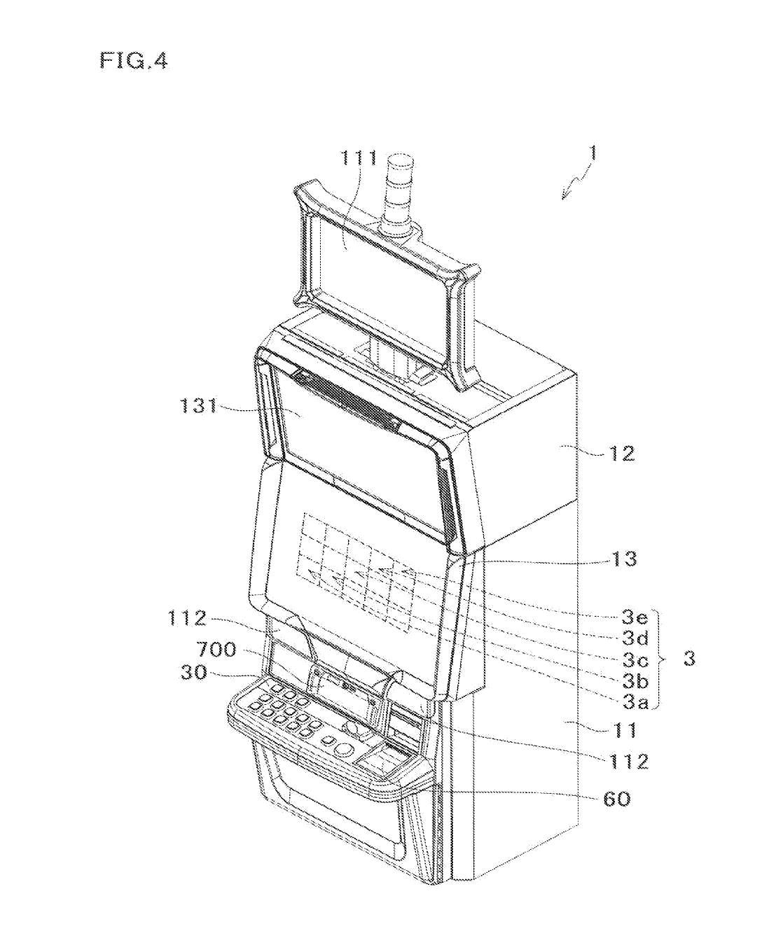

Now, referring to FIG. 4, the overall structure of the slot machine 1 will be described. FIG. 4 shows the overall structure of the slot machine of the embodiment of the present invention.

Electrically valuable information such as electronic money is used as a gaming value in the slot machine 1. It is to be noted that the gaming value is not limited to this, and for example a coin, a medal, a token, a ticket with a bar code and the like can be adopted.

The slot machine 1 includes a cabinet 11, a top box 12 installed on the upper side of the cabinet 11, and a main door 13 provided at the front surface of the cabinet 11. Above the top box 12, a digital signage 111 is provided.

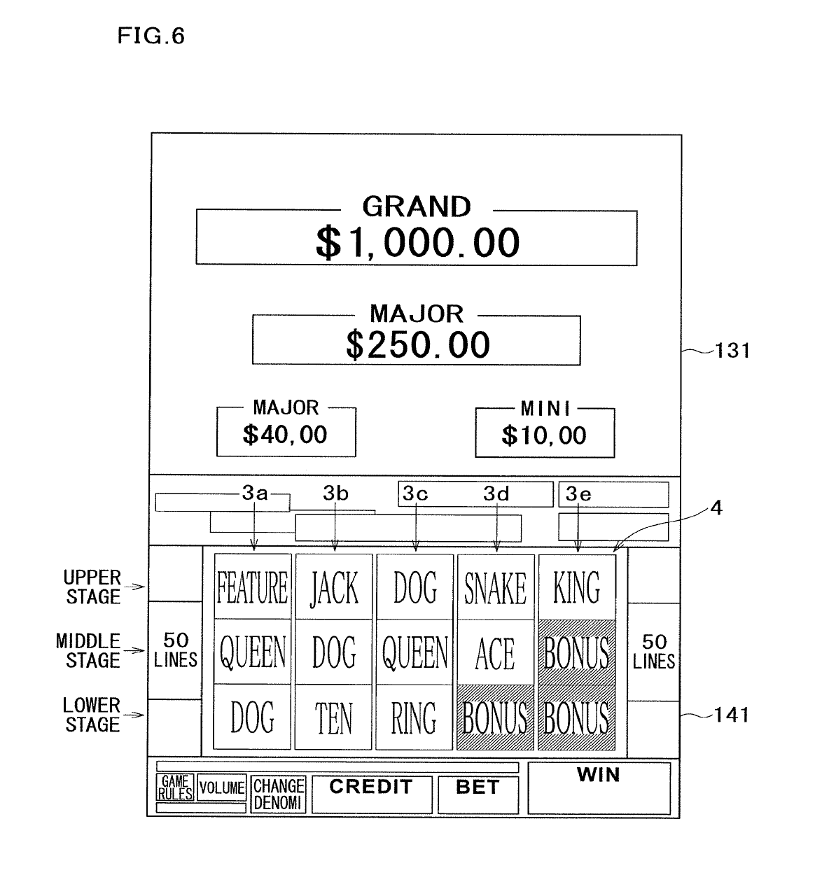

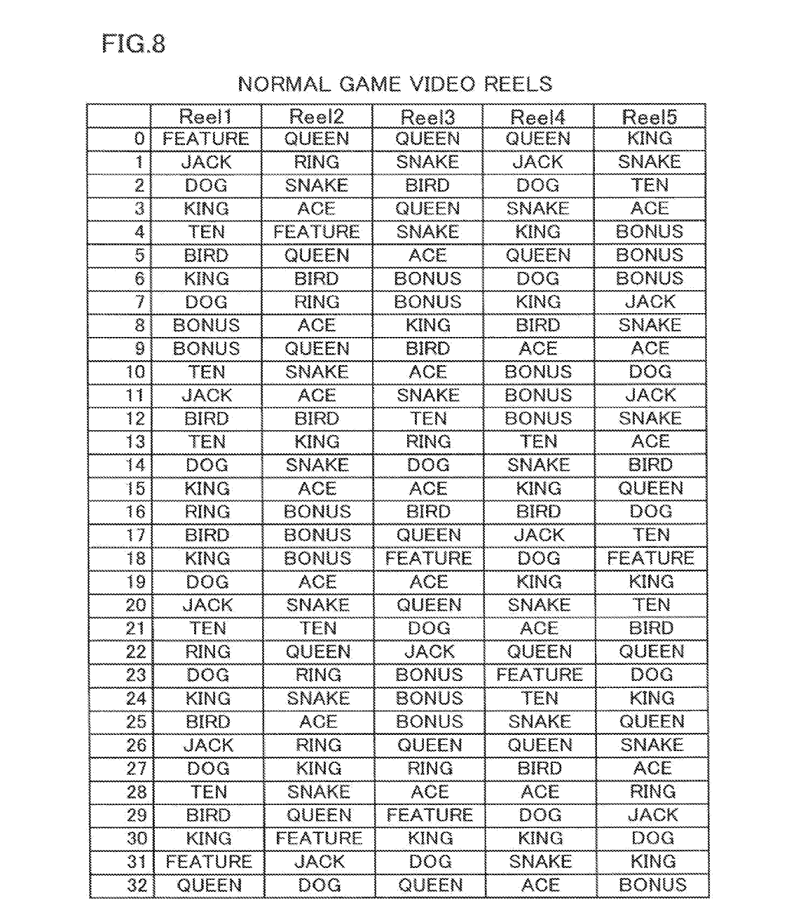

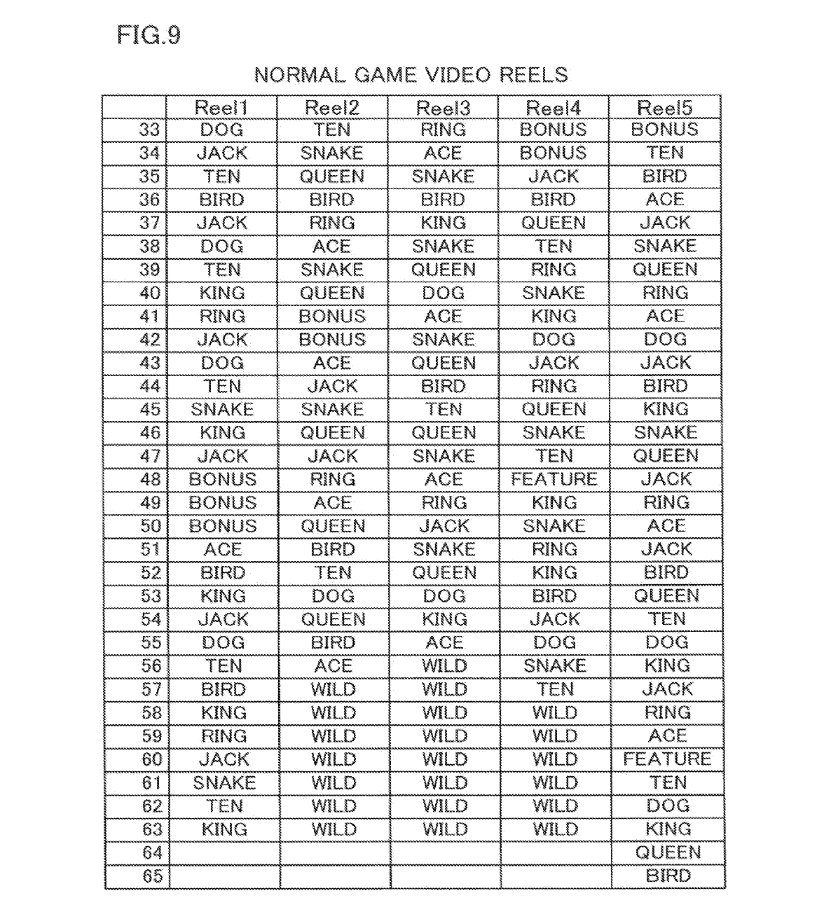

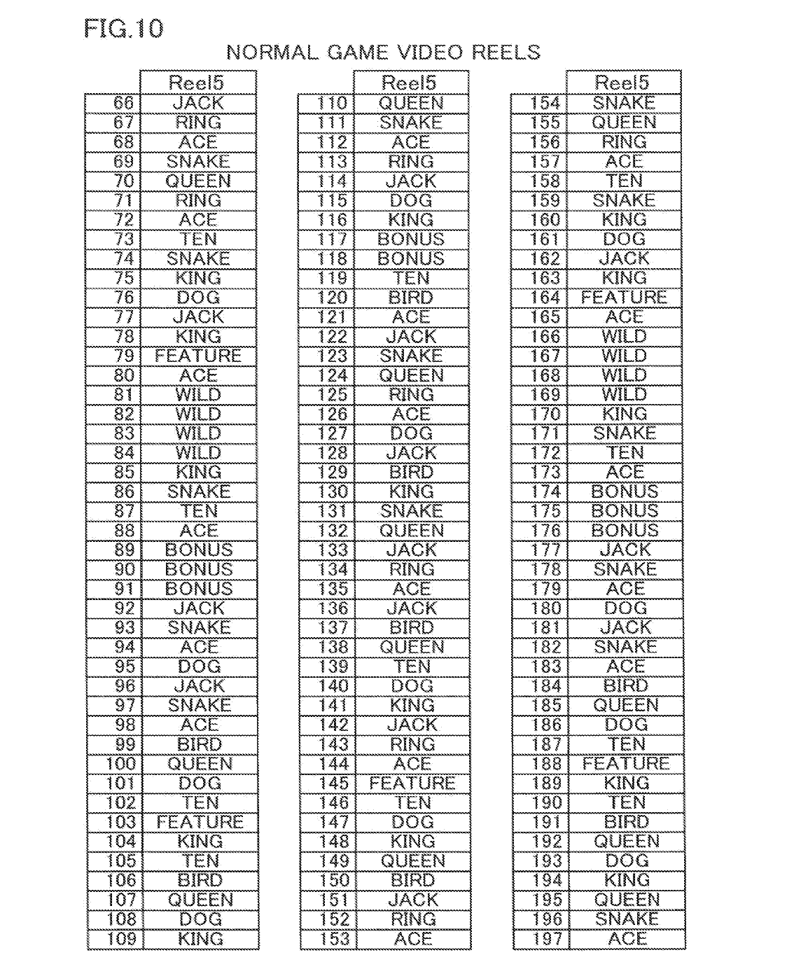

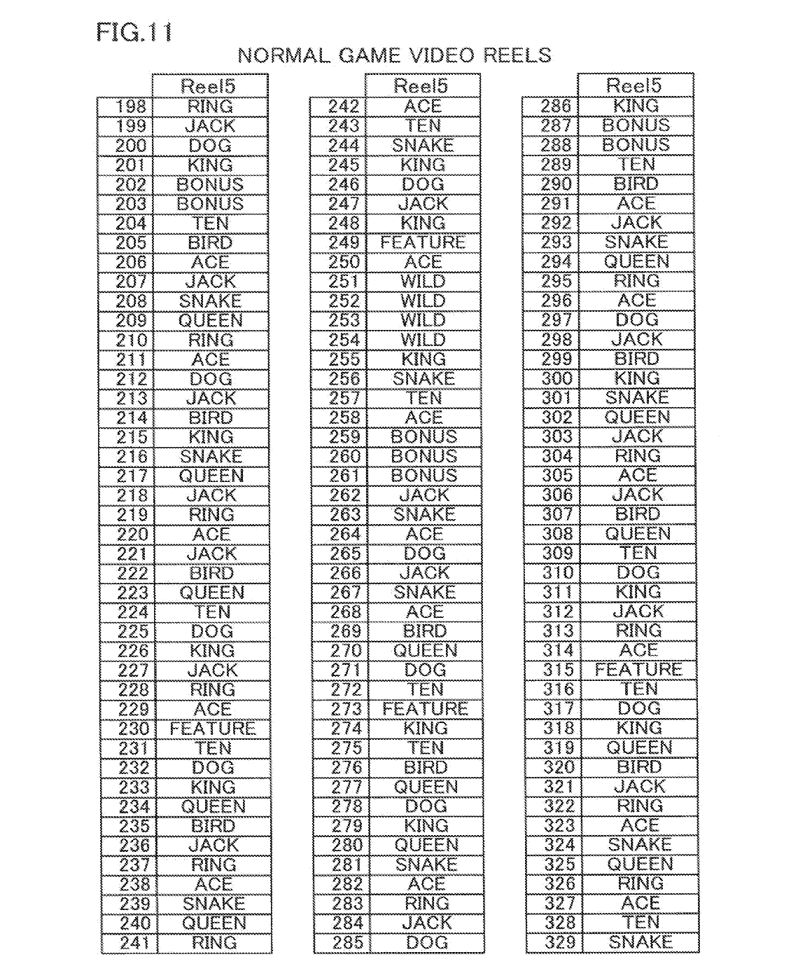

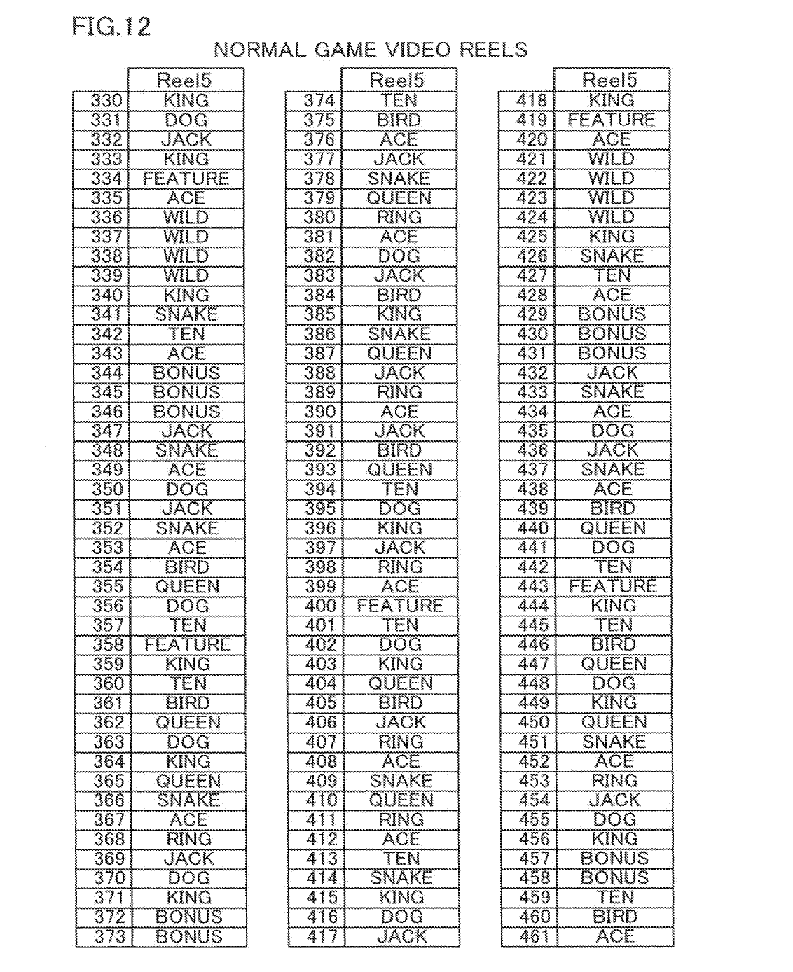

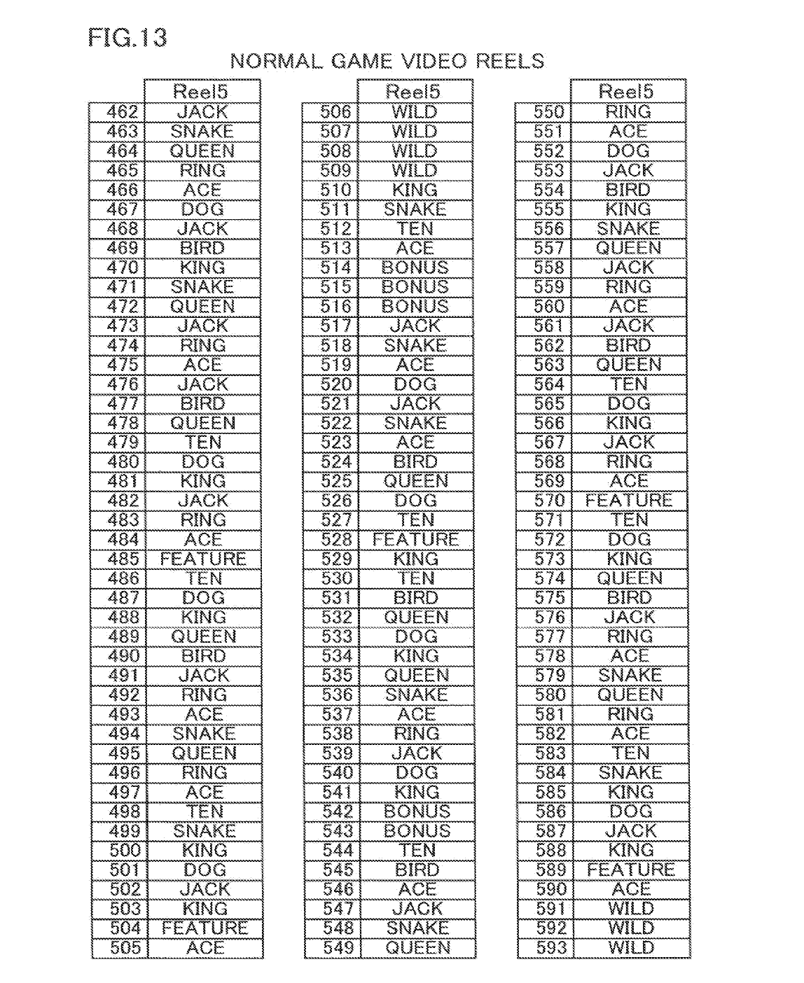

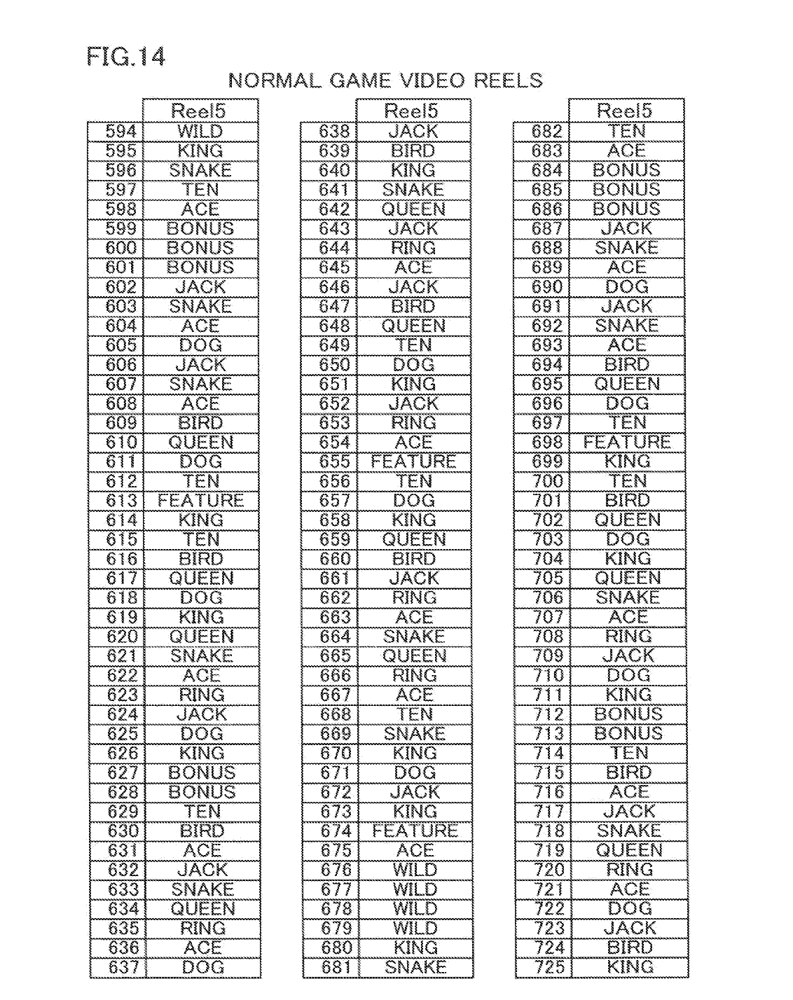

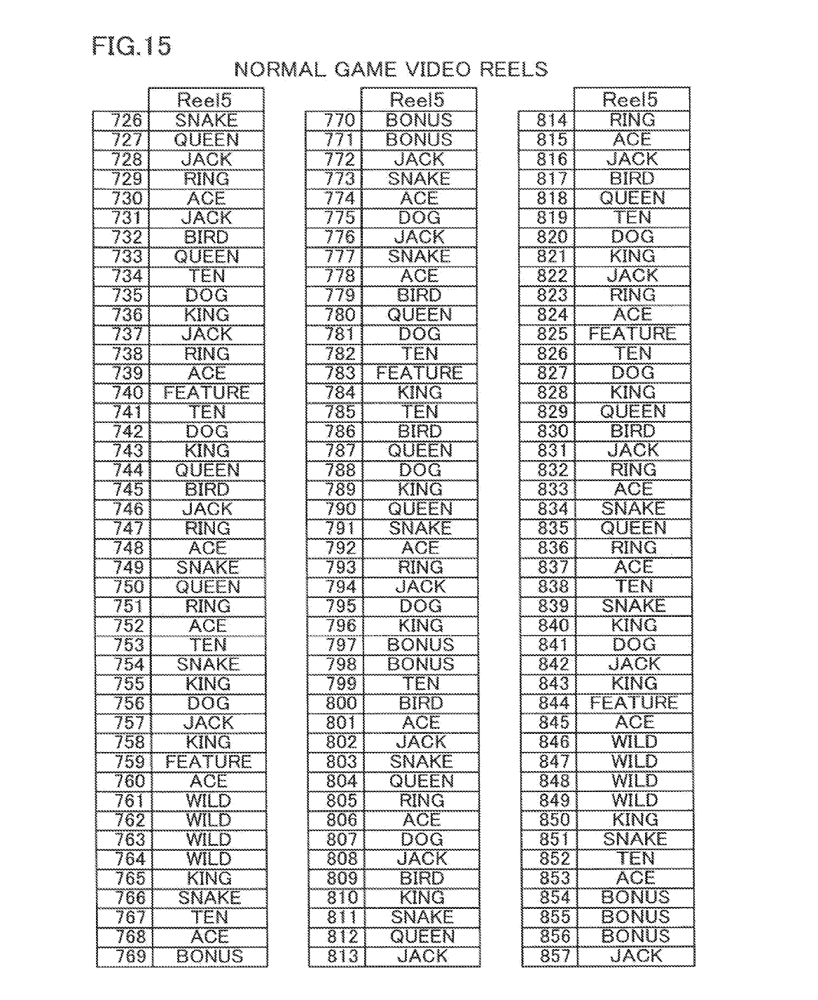

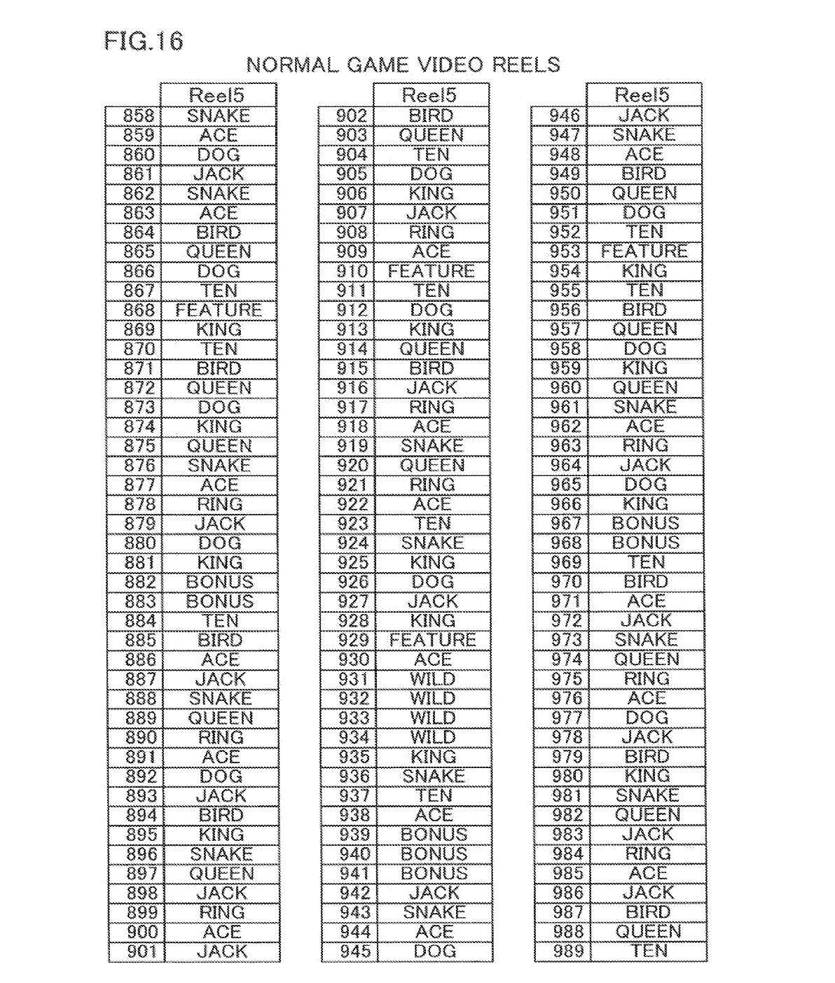

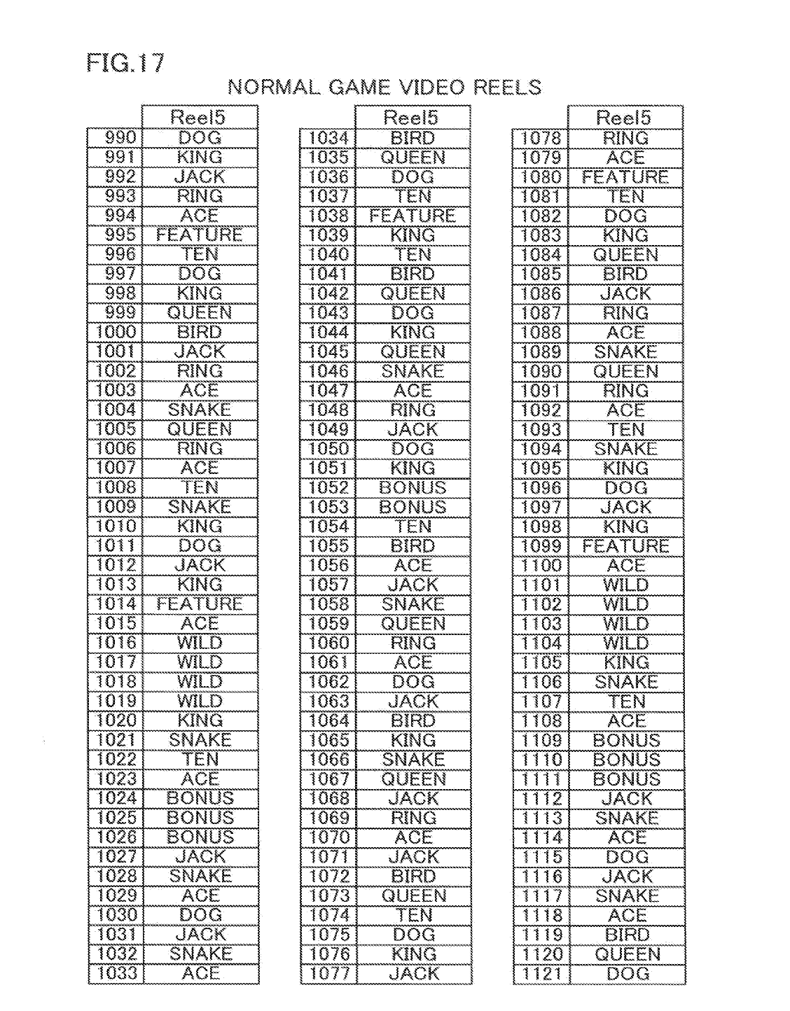

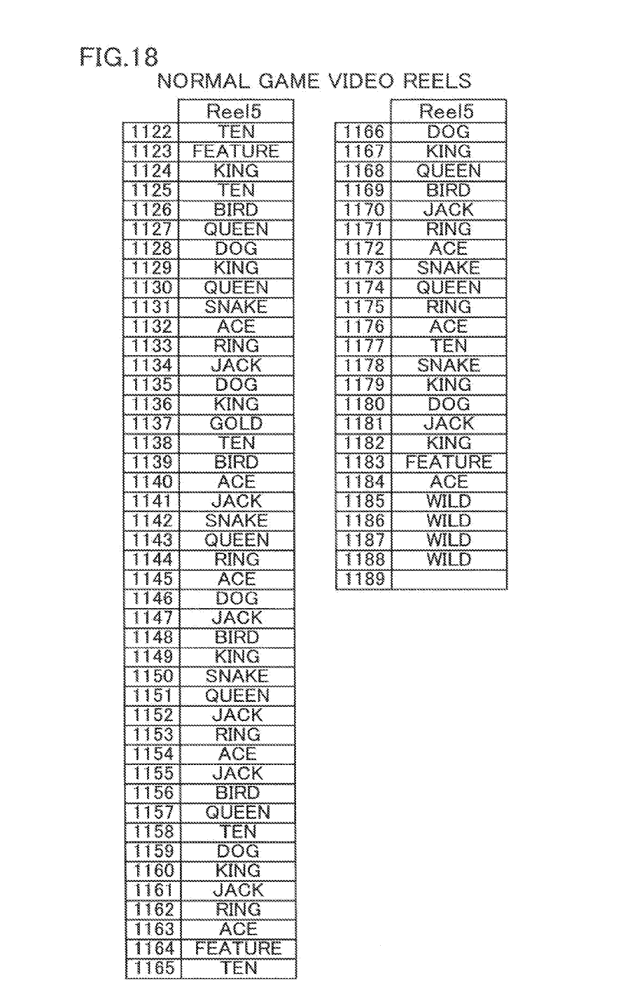

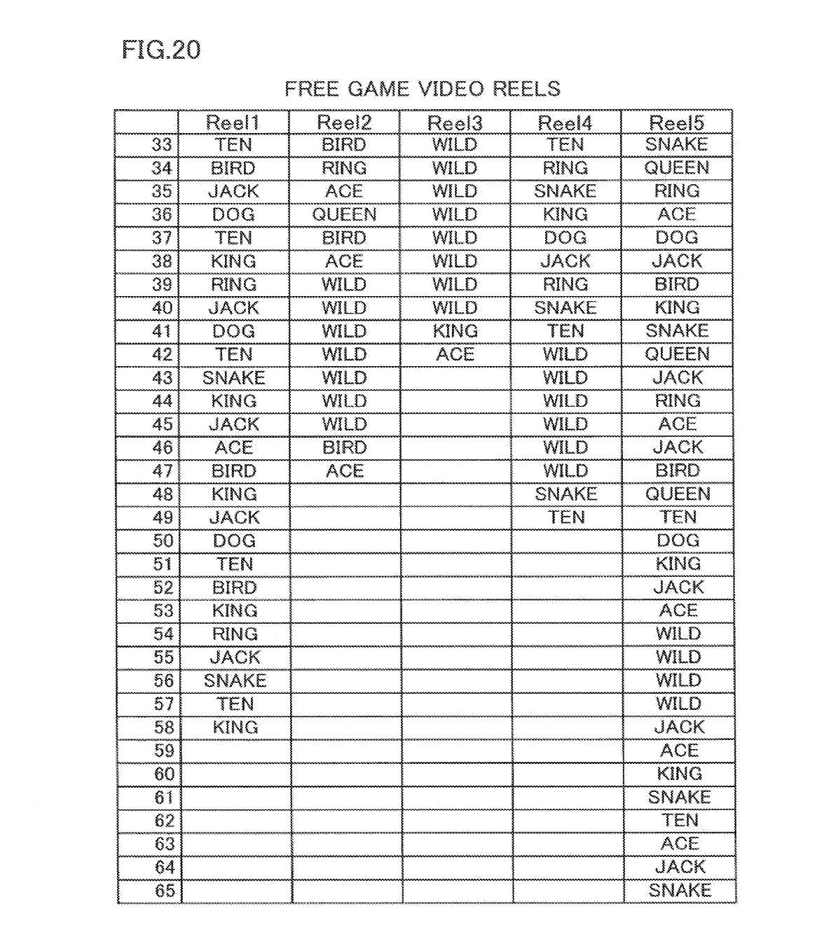

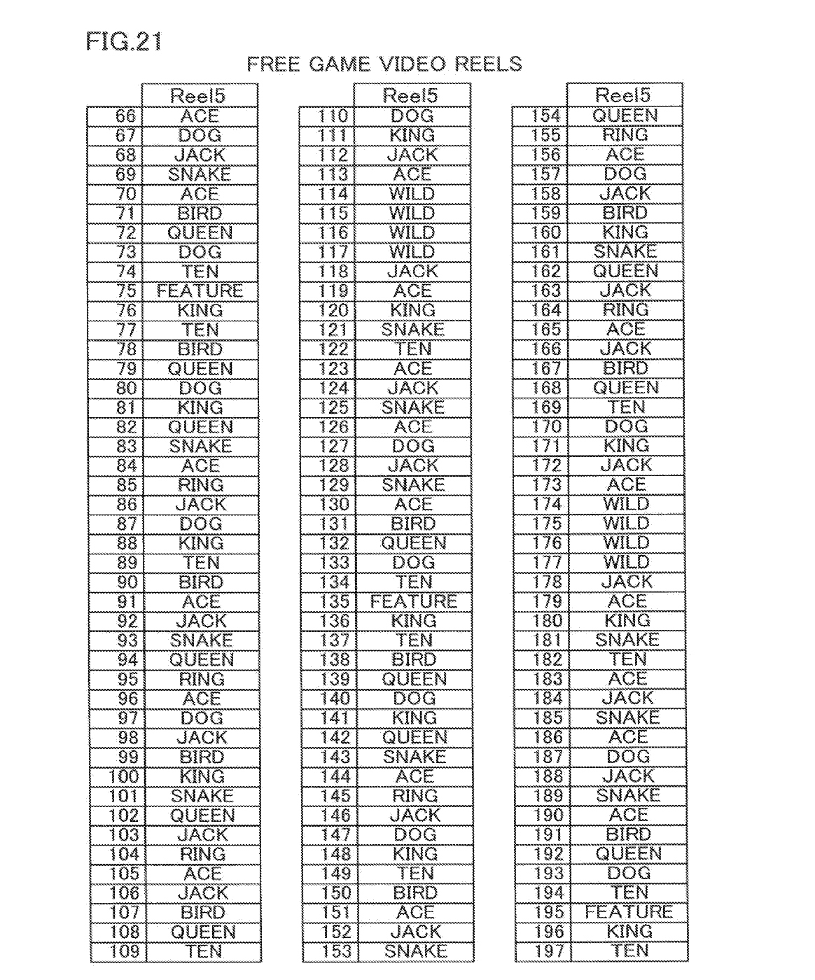

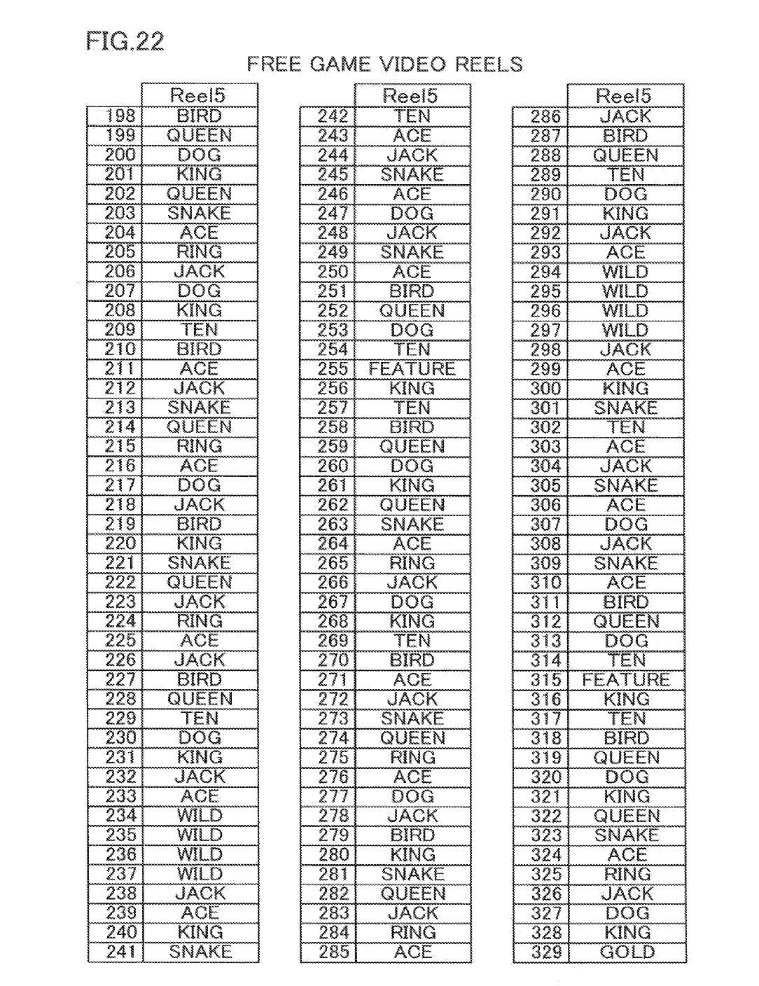

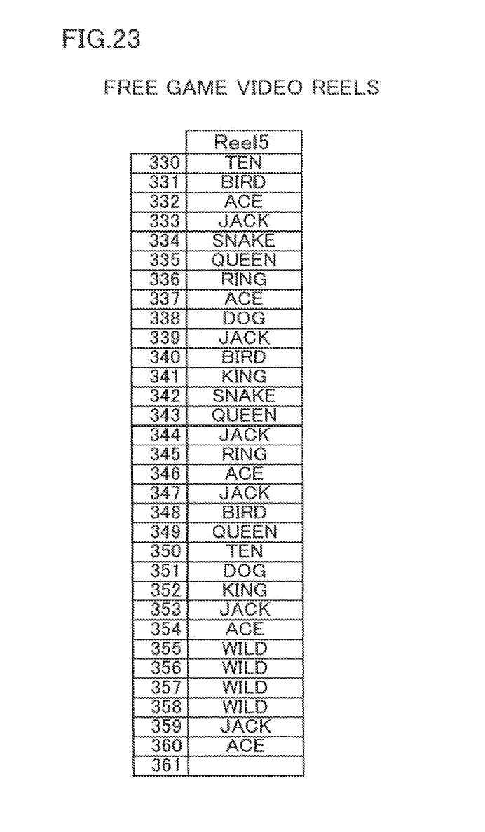

At the center of the main door 13, a lower image display panel 141 (equivalent to a display device) is provided. The lower image display panel 141 is a liquid crystal panel and constitute a display. The lower image display panel 141 has a symbol display area 4. As shown in FIG. 6, five video reels 3 (3a, 3b, 3c, 3d, and 3e) are displayed in the symbol display area 4. In the embodiment of the present invention, the video reels are for expressing in the form of a video rotation and stop of symbols depicted on the circumferential surfaces of mechanical reels. With each video reel 3, a symbol array formed of predetermined symbols is associated (see, e.g., FIGS. 8 to 24 described below).

In the symbol display area 4, symbol arrays associated with the five video reels 3 (3a, 3b, 3c, 3d, and 3e) are scrolled, and are stopped after a predetermined time elapses. As a result, a part of each symbol array (three successive symbols in the embodiment of the present invention) is displayed for the player. In the symbol display area 4, a symbol is displayed in each of the areas in the upper stage, the middle stage, and the lower stage, in each video reel 3. In other words, the symbol display area 4 displays 15 symbols forming a 5×3 matrix (see FIG. 6).

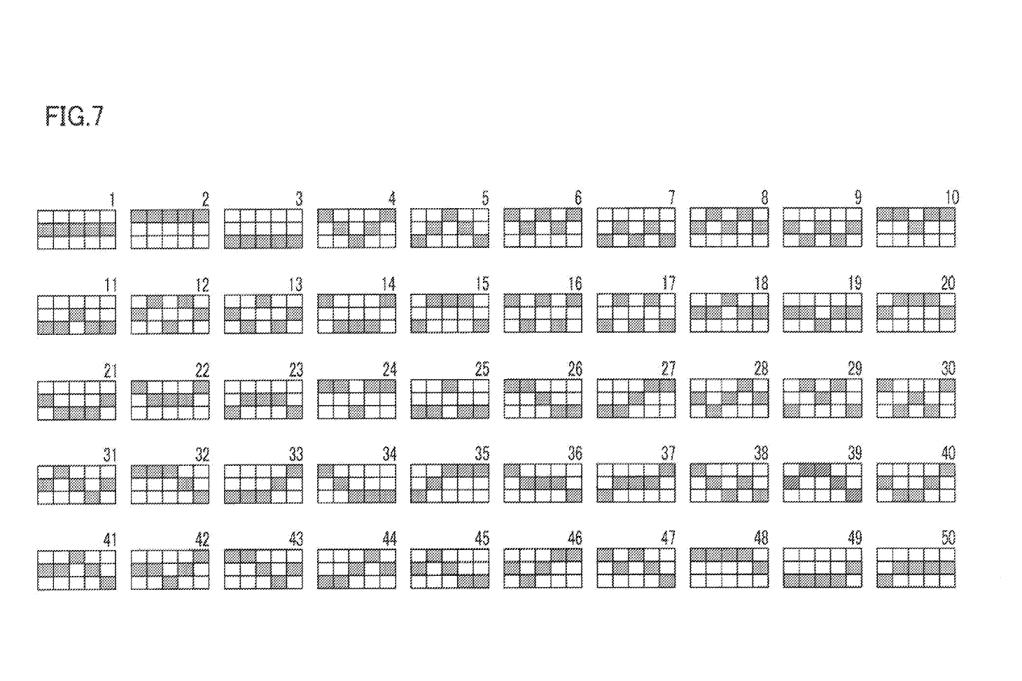

In the embodiment of the present invention, a line formed by connecting ones of three areas of symbol arrays of video reels is a winning line (see FIG. 7). Non-limiting examples of winning lines include a linear line formed by connecting the central areas of the respective video reels 3, a V-shaped line, and a bended line. In regard to the number of the winning lines, while there are 50 winning lines in the embodiment of the present invention as shown in FIG. 7, the number of the winning lines may be 30, for example.

The lower image display panel 141 includes a touch panel 114. The player is allowed to input instructions by touching the lower image display panel 141.

While in the present embodiment the slot machine 1 adopts video reels that display simulated reels, the slot machine 1 may be provided with a reel unit of a mechanical type, or the video reels and the mechanical type may be concurrently employed.

An upper image display panel 131 is provided at the front surface of the top box 12. The upper image display panel 131 includes a liquid crystal panel, and forms the display. The upper image display panel 131 displays images related to effects and images showing introduction of the game contents and explanation of the game rules.

Below the lower image display panel 141, there are provided a control panel 30 having various buttons, a PTS device 700, and a bill entry 115.

The bill entry 115 validates bills and receives genuine bills into the cabinet 11. The bill entry 115 is electrically connected to the PTS device 700, and when a legitimate bill is received, transmits to the PTS device 700 an input signal based on the value of the bill. The input signal includes information on credit data or the like related to the received bill.

The PTS device 700 is a unit in which an LCD (liquid crystal display), a human detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot to which an IC card can be inserted. With this, the player is able to insert an IC card into the card insertion slot and use the credits stored in the IC card in the slot machine 1.

(Structure of Control Panel 30)

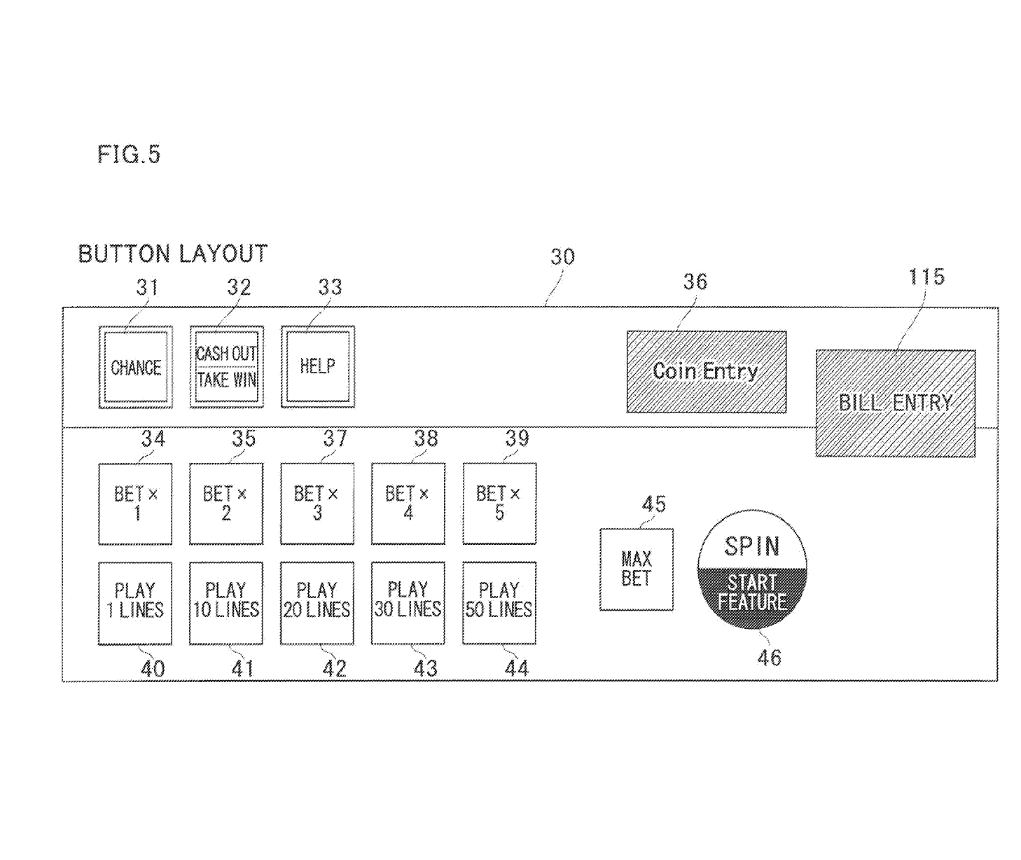

On the control panel 30, as shown in FIG. 5, a change button 31, a cashout/take win button 32, and a help button 33 are arranged in the upper stage of the left side area, while a 1-BET button 34, a 2-BET button 35, a 3-BET button 37, a 4-BET button 38, a 5-BET button 39, a play-1-line button 40, a play-10-line button 41, a play-20-line button 42, a play-30-line button 43, and a play-50-line button 44 are arranged in the lower stage on the left side area. Further, a coin entry 36 and a bill entry 115 for accepting paper money or the like are arranged in the right side area of the upper stage, and a MAX-BET button 45 and a spin button 46 are arranged in the right side area of the lower stage.

The CHANGE button 31 is an operation button to be used when temporarily leaving the seat, or when requesting a staff person of the gaming facility for an exchange. The cashout/take win button 32 is an operation button used when checking out coins (credit) reserved in the slot machine 1 is discharged. The help button 33 is pressed when the operating method of a game is unclear. When the help button 33 is pressed, various types of help information are displayed on the upper image display panel 131 and the lower image display panel 141.

With the 1-BET button 34, a credit of 1 out of the player-owned credit is bet on each active winning line. With the 2-BET button 35, a credit of 2 out of the player-owned credit is bet on each active winning line. With the 3-BET button 37, a credit of 3 out of the player-owned credit is bet on each active winning line. With the 4-BET button 38, a credit of 4 out of the player-owned credit is bet on each active winning line. With the 5-BET button 39, a credit of 5 out of the player-owned credit is bet on each active winning line. With the MAX-BET button 45, the game starts with a credit of 5 bet on each active winning line. As such, the bet amount on each active winning line is determined by pressing the 1-BET button 34, the 2-BET button 35, the 3-BET button 37, the 4-BET button 38, the 5-BET button 39, and the MAX-BET button 45. Each BET button is changeable to one of the 1-BET button 34, the 2-BET button 35, the 3-BET button 37, the 5-BET button 38, and the 10-BET button 39.

The play-1-line button 40, when pressed, activates a winning line (see FIG. 7). In this case, the number of activated winning line is 1. The play-10-line button 41, when pressed, activates winning lines. In this case, the number of activated winning lines is 10. The play-20-line button 42, when pressed, activates winning lines. In this case, the number of activated winning lines is 20. The play-30-line button 43, when pressed, activates winning lines. In this case, the number of activated winning lines is 30. The play-50-line button 44, when pressed, activates winning lines. In this case, the number of activated winning lines is 50.

The spin button 46 is a button for starting scroll of the video reels 3 (3a, 3b, 3c, 3d, and 3e).

The coin entry 36 is used for receiving coins into the cabinet 11. The bill entry 115 validates bills and receives genuine bills into the cabinet 11.

(Symbol Arrays on Video Reels)

Now, with reference to FIG. 8 to FIG. 24, the following describes a configuration of the symbol arrays on the video reels 3 of the slot machine 1. In the present embodiment, normal game video reels, free game video reels (WILD+25), and JP free game video reels are used.

(Normal Game Video Reels)

As shown in FIG. 8 to FIG. 18, to a first reel (Reel1) 3a, a second video reel (Reel2) 3b, a third video reel (Reel3) 3c, and a fourth video reel (Reel4) 3d of the normal game video reels, symbol arrays each formed of symbols corresponding to code numbers 0 to 63 are allocated. For a fifth video reel (Reel5) 3e, a symbol array formed of symbols corresponding to code numbers 0 to 1188 is allocated. The types of the symbols provided on the normal game video reels are “WILD”, “RING”, “BIRD”, “DOG”, “SNAKE”, “ACE”, “KING”, “QUEEN”, “JACK”, “TEN”, “BONUS”, “GOLD”, and “FEATURE”. The “WILD” symbol is a symbol which is able to function as any symbols except the “BONUS”, “GOLD”, and “FEATURE” symbols (i.e., an almighty symbol). The “FEATURE” symbol functions as a trigger of the shift to a later-described free game process. The “BONUS” and “GOLD” symbols function as triggers of the shift to a later-described JP free game. One “GOLD” symbol is provided on the fifth video reel (Reel5) 3e.

For example, in case of the first reel (Reel1) 3a of the normal game video reels, random numbers are defined so that 64 symbols (code numbers 0 to 63) forming the symbol array are selected at equal probabilities (e.g., 1/64). However, because the number of the symbols in 64 symbols is different between the types, the probability of the selection is different between the types of the symbols. For example, the symbol array on the first reel 3a of the normal game video reels include two “FEATURE” symbols and ten “TEN” symbols. On this account, while the “FEATURE” symbol is selected at the probability of 2/64, the “TEN” symbol is selected at the probability of 10/64.

(Free Game Video Reels)

In the present embodiment, free game video reels are prepared for the later-described free game process.

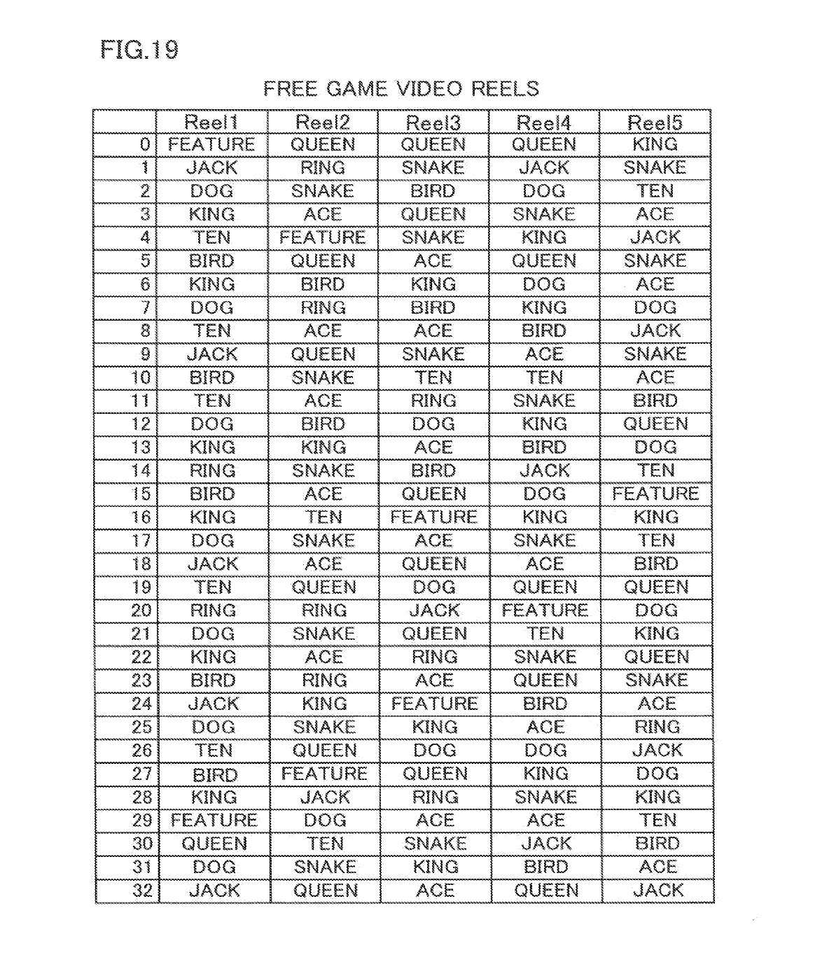

As shown in FIG. 19 to FIG. 23, to a first reel (Reel1) 3a of the free game video reels (WILD+25), a symbol array formed of symbols corresponding to code numbers 0 to 58 is allocated. To a second video reel (Reel2) 3b, a symbol array formed of symbols corresponding to code numbers 0 to 47 is allocated. To a third video reel (Reel3) 3c, a symbol array formed of symbols corresponding to code numbers 0 to 42 is allocated. To a fourth video reel (Reel4) 3d, a symbol array formed of symbols corresponding to code numbers 0 to 49 is allocated. For a fifth video reel (Reel5) 3e, a symbol array formed of symbols corresponding to code numbers 0 to 360 is allocated. The types of the symbols provided on the free game video reels are “WILD”, “RING”, “BIRD”, “DOG”, “SNAKE” , “ACE”, “KING”, “QUEEN”, “JACK”, “TEN”, and “GOLD”.

(JP Free Game Video Reels)

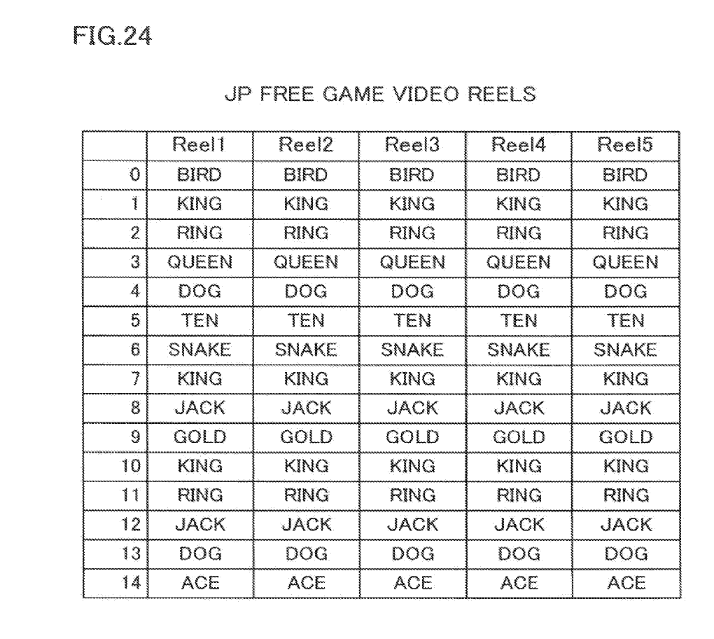

Now, JP free game video reels used in a later-described JP free game process will be described with reference to FIG. 24.

To a first reel (Reel1) 3a to a fifth reel (Reel5) 3e of the JP free game video reels, symbol arrays each formed of symbols corresponding to code numbers 0 to 14 are allocated. The types of the symbols provided on the JP free game video reels are “BIRD”, “DOG”, “SNAKE”, “ACE”, “KING”, “QUEEN”, “JACK”, “TEN”, and “GOLD”. On each of the first reel (Reel1) 3a to the fifth reel (Reel5) 3e of the JP free game video reels, one “GOLD” symbol is provided.

[Structures of Circuits Provided to Slot Machine]

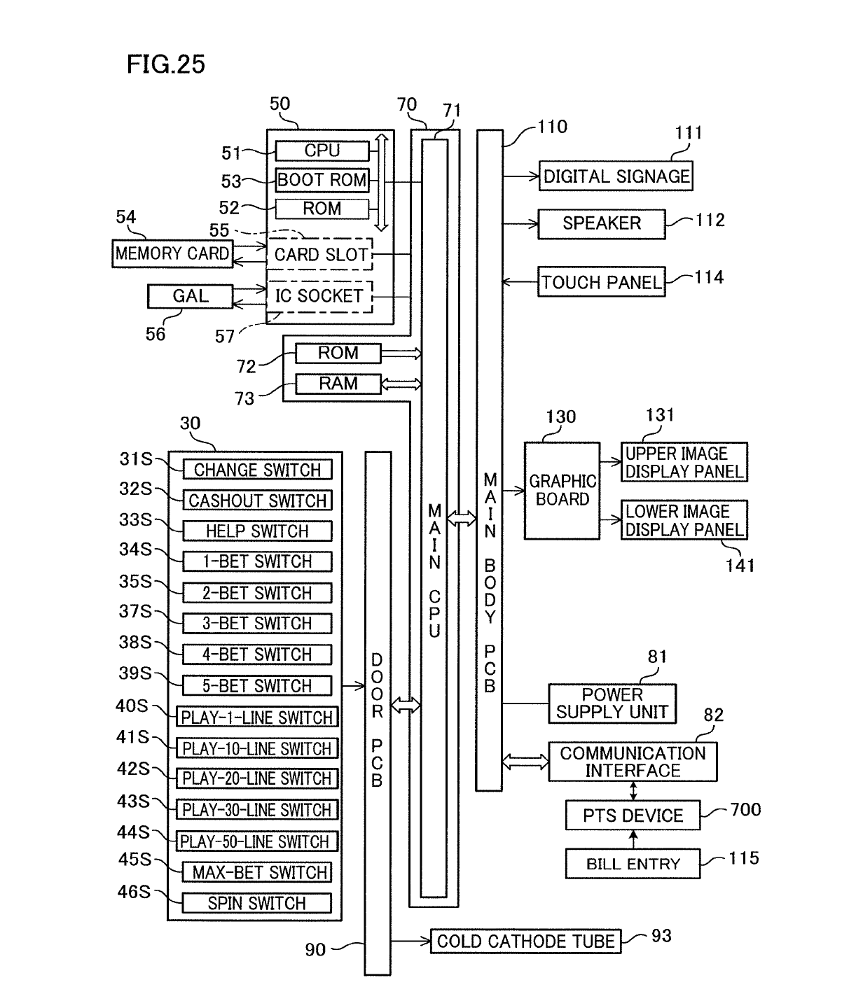

Now, referring to FIG. 25, the configuration of a circuit in the slot machine 1 will be described. FIG. 25 is a block diagram showing an internal structure of the slot machine related to the embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program and a game system program. The game program includes a program related to game progression, a random determination program, and a program for producing effects by images and sounds. Furthermore, the game program includes data (see FIG. 8 to FIG. 24) defining the arrangement of the symbol array allocated to each video reel 3.

The random determination program is a program for determining symbols to be stopped on the video reels 3a, 3b, 3c, 3d, and 3e. The to-be-stopped symbols are data for determining three symbols displayed in the symbol display area 4, among the symbols forming the symbol arrays. In the slot machine 1 of the embodiment of the present invention, symbols displayed in predetermined areas (e.g., areas in the middle stage) among three areas corresponding to each of the video reels 3a, 3b, 3c, 3d, and 3e in the symbol display area 4 are determined as to-be-stopped symbols. As a result of this symbols displayed in three areas (on the upper stage, the middle stage, and the lower stage) of each of the video reels 3a, 3b, 3c, 3d, and 3e in the symbol display area 4 are determined (see FIG. 6).

The aforementioned random determination program includes symbol determination data. The symbol determination data is data in which random numbers are defined so that symbols forming a symbol array are selected at equal probabilities on each of the video reels 3a, 3b, 3c, 3d, and 3e. For example, in case of the first reel (Reel1) 3a of the normal game video reels, random numbers are defined so that 64 symbols (code numbers 0 to 63) forming the symbol array are selected at equal probabilities (e.g., 1/64). However, because the number of the symbols in 64 symbols is different between the types, the probability of the selection is different between the types of the symbols. For example, the symbol array on the first reel 3a of the normal game video reels include two “FEATURE” symbols and ten “TEN” symbols. On this account, while the “FEATURE” symbol is selected at the probability of 2/64, the “TEN” symbol is selected at the probability of 10/64.

Further, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like. The authentication program is a program (falsification check program) for authenticating the game program and the game system program. The pre-authentication program is a program for authenticating the aforementioned authentication program. The authentication program and the pre-authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to the storage means.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program and the game system program stored in the memory card 54 is started.

The processor of the present invention includes the main CPU 71, the ROM 72, and the RAM 73 above and the memory card 54 storing the game program and the game system program, and controls the slot machine by causing the CPU 71 to execute the game program and the game system program. Needless to say, the processor may alternatively store the game program and the game system program in the ROM 72 instead of the memory card 54.

The RAM 73 stores data and programs which are used in operation of the main CPU 71. For example, when the processing of loading the aforementioned game program, game system program or authentication program is conducted, the RAM 73 can store the program. The RAM 73 is provided with working areas used for operations when these programs are executed. Examples of the areas include: an area that stores counters for the number of games, the bet amount, the payout amount, the credit amount and the like; and an area that stores symbols (code numbers) randomly determined.

Further, the motherboard 70 is connected with a door PCB (Printed Circuit Board) 90 and a main body PCB 110 by respective USBs.

The door PCB 90 and the main body PCB 110 are connected with input devices such as a switch and a sensor, and peripheral devices the operations of which are controlled by the main CPU 71. The door PCB 90 is connected with a control panel 30, and a cold cathode tube 93.

For each of the buttons, the control panel 30 includes: a CHANGE switch 31S, a CASHOUT switch 32S, a 1-BET switch 34S, a 2-BET switch 35S, a 3-BET switch 37S, a 4-BET switch 38S, a 5-BET switch 39S, a 1LINE switch 40S, a 10LINES switch 41S, a 20LINES switch 42S, a 30LINES switch 43S, a 50LINES switch 44S, a MAX-BET switch 45S, and a spin switch 46S. Each of the switches outputs a signal to the main CPU 71 upon detection of the pressing of the button corresponding thereto by the player.

The cold cathode tube 93 functions as a backlight installed on the rear face side of the upper image display panel 131 and the lower image display panel 141, and turns on based on a control signal outputted from the main CPU 71.

The main body PCB 110 is connected with a digital signage 111, a speaker 112, a touch panel 114, a graphic board 130, a power supply unit 81, and a communication interface 82.

The digital signage 111 turns on based on a control signal outputted from the main CPU 71. The speaker 112 outputs BGM sound or the like in accordance with a control signal output from the main CPU 71.

The touch panel 114 detects a place on the lower image display panel 141 touched by the player's finger or the like, and outputs to the main CPU 71 a signal corresponding to the detected place.

The graphic board 130 controls image display executed by the respective upper image display panel 131 and lower image display panel 141, based on a control signal outputted from the main CPU 71. The symbol display area 4 of the lower image display panel 141 displays five video reels 3a, 3b, 3c, 3d, and 3e and displays scroll and stop of symbol arrays of the video reels 3a, 3b, 3c, 3d, and 3e. The graphic board 130 is provided with a VDP generating image data, a video RAM temporarily storing the image data generated by the VDP, and the like.

The graphic board 130 is provided with the VDP (Video Display Processor) generating image data based on a control signal outputted from the main CPU 71, the video RAM temporarily storing the image data generated by the VDP, and the like. It is to be noted that the image data used for generating image data by the VDP is included in the game program that has been read from the memory card 54 and stored into the RAM 73.

The power supply unit 81 supplies power to the slot machine 1. When the power is supplied from the power supply unit 81 to the motherboard 70, the main CPU 71 of the motherboard 70 is activated, and then power is supplied to the gaming board 50 through the PCI bus so as to activate the CPU 51.

The communication interface 82 is for communicating with the PTS device 700 and the external controller 200. The PTS device 700, upon reception of an input signal from the bill entry 115, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

(Symbol Combination Table)

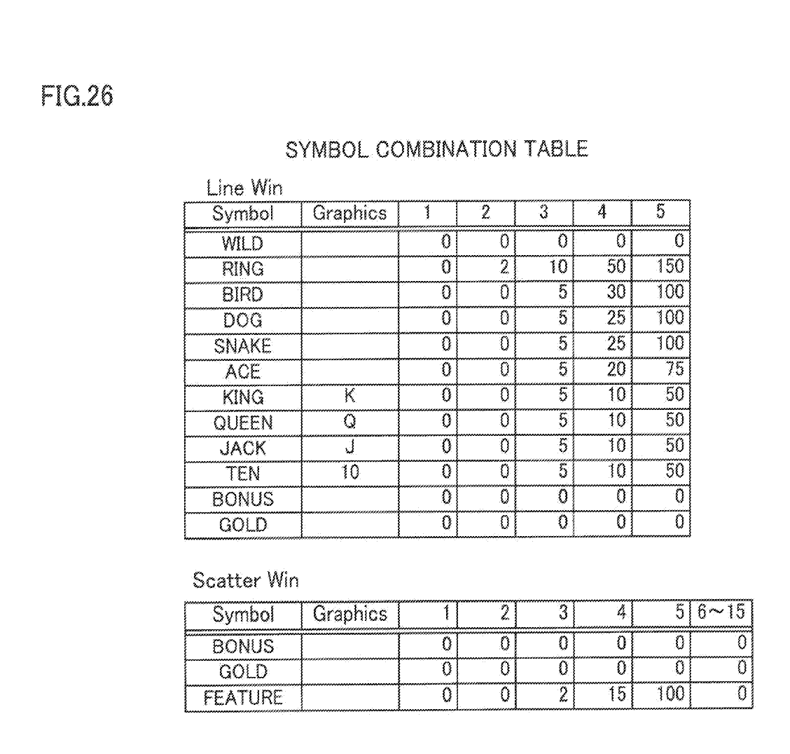

Now, symbol combination tables will be described with reference to FIG. 26. FIG. 26 shows a symbol combination table of the slot machine of the embodiment of the present invention.

The symbol combination table of the present embodiment defines the combinations of symbols (the number of symbols) with which a winning (WIN) is achieved and payout amounts. In the slot machine 1, a winning is achieved when the scroll of the symbol arrays of the video reels 3 are stopped and a predetermined number or more symbols are rearranged on an activated winning line, among the symbols rearranged in the symbol display area 4. In accordance with the type of winning, a benefit will be given to the player in the form of awarding a payout and the like.

Basically, in regard to “RING”, “BIRD”, “DOG”, “SNAKE”, “ACE”, “KING”, “QUEEN”, “JACK”, and “TEN” symbols, a winning is achieved when a predetermined number of (two to five) symbols of one type are rearranged on an activated winning line. It should be noted that, for the “WILD” symbol, any of the following types of symbols is substituted: “RING”, “BIRD”, “DOG”, “SNAKE”, “ACE”, “KING”, “QUEEN”, “JACK”, and “TEN”. The “FEATURE” symbol is a scatter symbol, and a winning is achieved when a predetermined number (three or more) of the symbols are rearranged in the symbol display area 4, irrespective of winning lines. Further, when three or more “FEATURE” symbols are rearranged in the symbol display area 4, a payout is awarded or a trigger of the free game is established (i.e., later-described shift to the free game process) as a benefit. The “GOLD” symbol is a scatter symbol, too, and a winning is achieved when at least one “GOLD” symbol is rearranged in the symbol display area 4, irrespective of winning lines. When the “GOLD” symbol is rearranged in the symbol display area 4, a trigger of the JP free game is established (i.e., later-described shift to the JP free game process). The “BONUS” symbol is a scatter symbol, too, and a winning is achieved when six or more “BONUS” symbols are rearranged in the symbol display area 4, irrespective of winning lines. When six or more “BONUS” symbols are rearranged in the symbol display area 4, a trigger of the JP free game is established (i.e., later-described shift to the JP free game process).

In cases of a winning by “RING”, “BIRD”, “DOG”, “SNAKE”, “ACE”, “KING”, “QUEEN”, “JACK”, or “TEN” symbols, a value calculated by multiplying a bet amount in a unit game by a payout amount defined in the symbol combination table is awarded. For example, when a winning by five “JACK” symbols is achieved with the betting of five credits by the 5-BET button 39, 250 credits are awarded as a result of 50 multiplied by 5. When a winning by “FEATURE” (three or more) symbols is achieved, a value to be awarded is calculated by multiplying a payout amount defined in the symbol combination table by a total bet amount in a unit game (“a bet amount corresponding to the number of activated winning lines”×“a bet amount betted on each activated winning line”). For example, when a winning by three “FEATURE” symbols is achieved with the betting of 50 credits (10×5=50) by the play-10-line button 41 and the 5-BET button 39, 100 credits are awarded as a result of 50 multiplied by 2.

(Payout Level Random Determination Table)

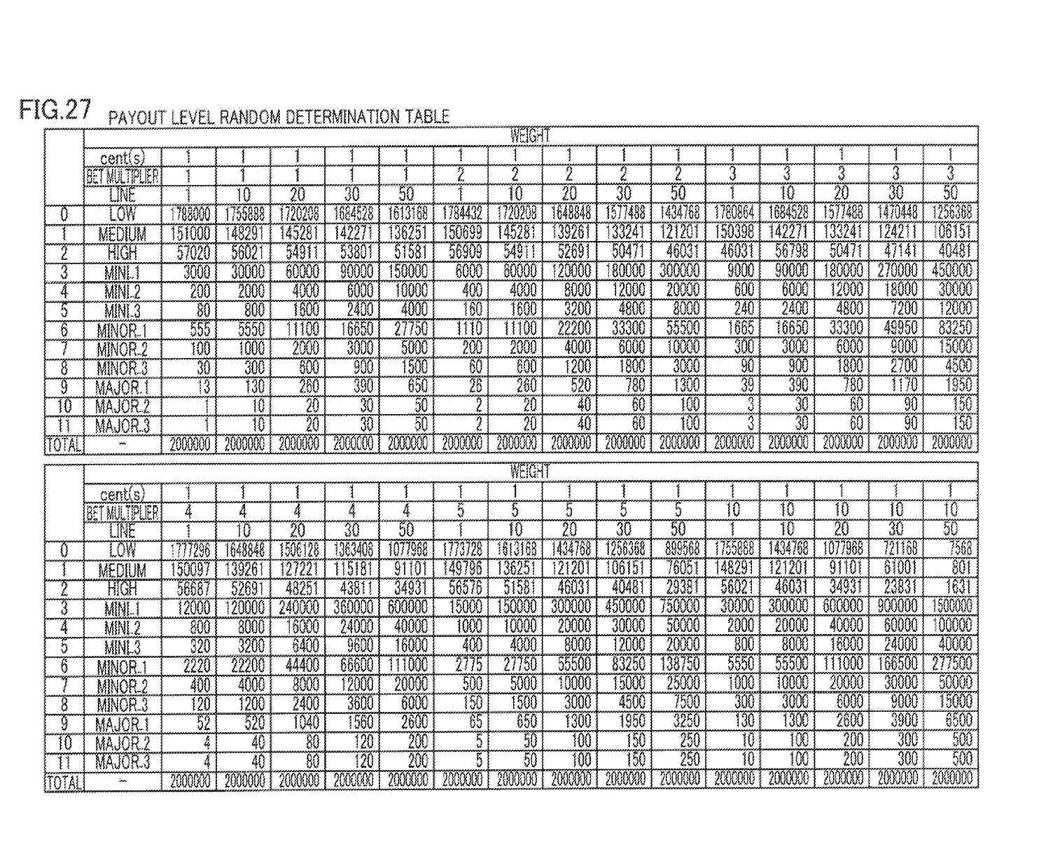

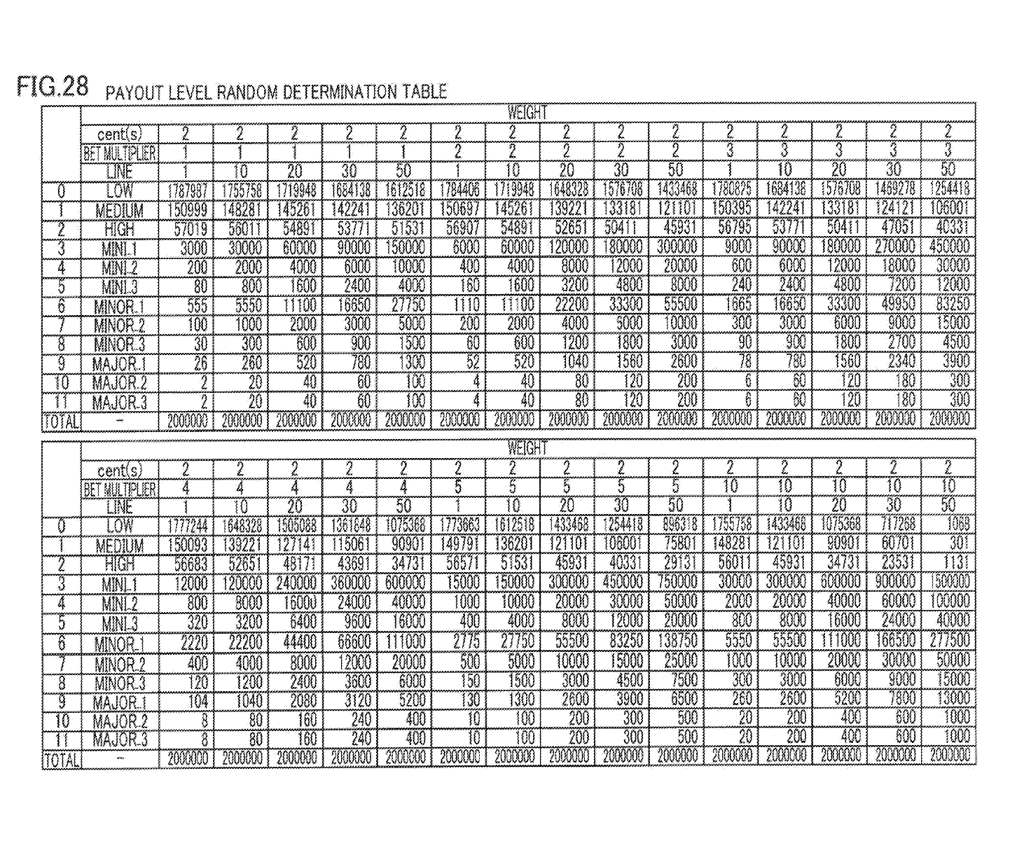

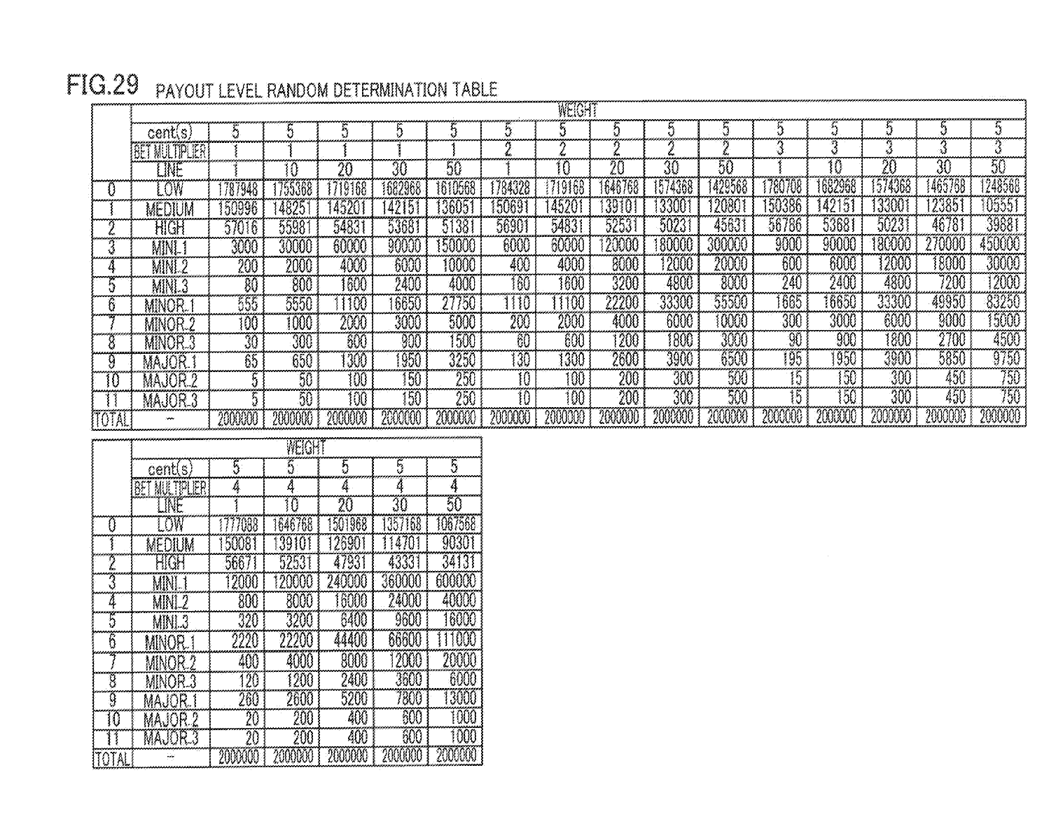

Now, a payout level random determination table will be described with reference to FIG. 27 to FIG. 29. The payout level random determination table is referred to in a main control process which will be described later.

In the payout level random determination table, 80 random determination tables are provided to correspond to “current denominations (1 cent, 2 cents, and 5 cents): cent(s)”, “bet amounts betted on each activated winning line: Bet Multiplier”, and “numbers of activated winning lines: LINE”. In each of the 80 random determination tables, probabilities of selection of each of the following 12 payout levels are defined for determining payout amounts associated with the “BONUS” symbol and the “GOLD” symbol arranged on the normal game video reels: “LOW”, “MEDIUM”, “HIGH”, “MINI1”, “MINI2”, “MINI3”, “MINOR1”, “MINOR2”, “MINOR3”, “MAJOR1”. “MAJOR2”, and “MAJOR3”. For example, when “current denomination” is 1 cent, “bet amount betted on each activated winning line” is 5 bets, and “number of activated winning lines” is 10 lines, a random determination table in which the probabilities are defined as follows is used: the probability of the selection of “LOW” is “1613168/2000000”, the probability of the selection of “MEDIUM” is “136251/2000000”, the probability of the selection of “HIGH” is “51581/2000000”, the probability of the selection of “MINI1” is “150000/2000000”, the probability of the selection of “MINI2” is “10000/2000000”, the probability of the selection of “MINI3” is “4000/2000000”, the probability of the selection of “MINOR1” is “27750/2000000”, the probability of the selection of “MINOR2” is “5000/2000000”, the probability of the selection of “MINOR3” is “1500/2000000”, the probability of the selection of “MAJOR1” is “650/2000000”, the probability of the selection of “MAJOR2” is “50/2000000”, and the probability of the selection of “MAJOR3” is “50/2000000”.

The denomination is a rate against a bet and can be set by a person who installs the slot machine 1.

(Payouts of Bonus Symbols of Each Level (Normal Game))

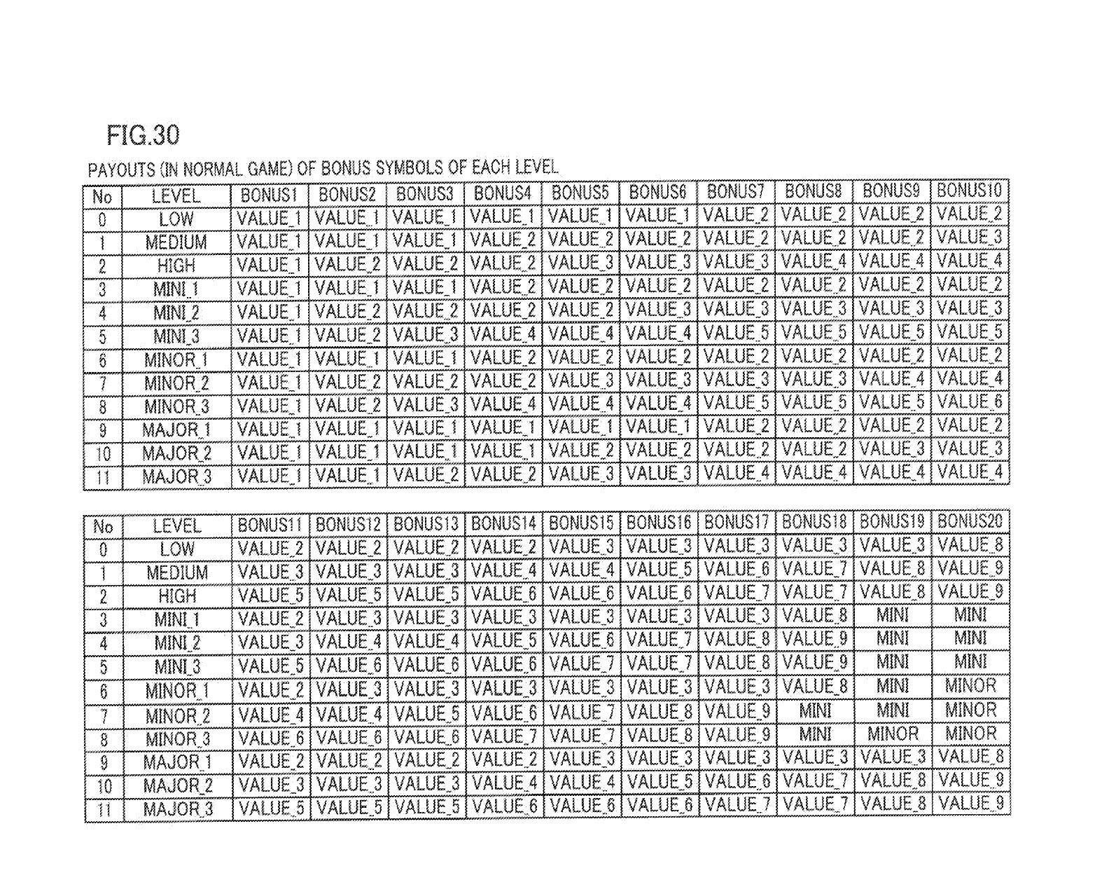

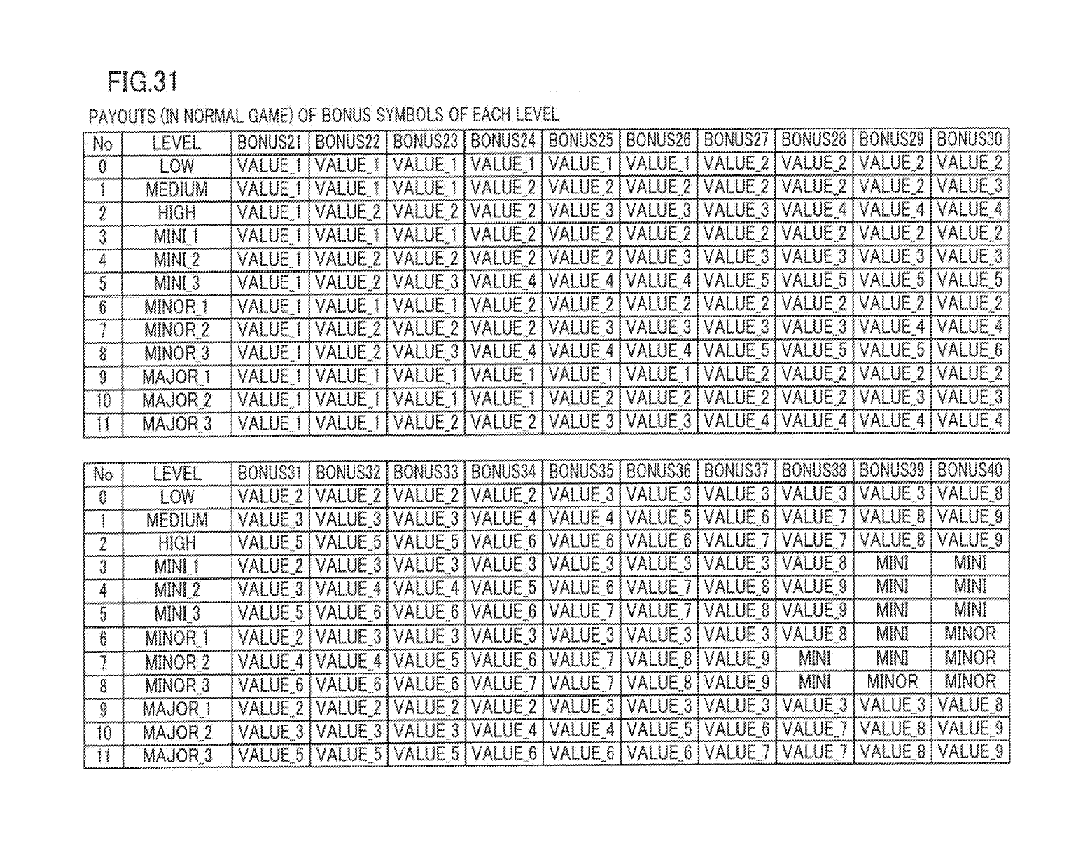

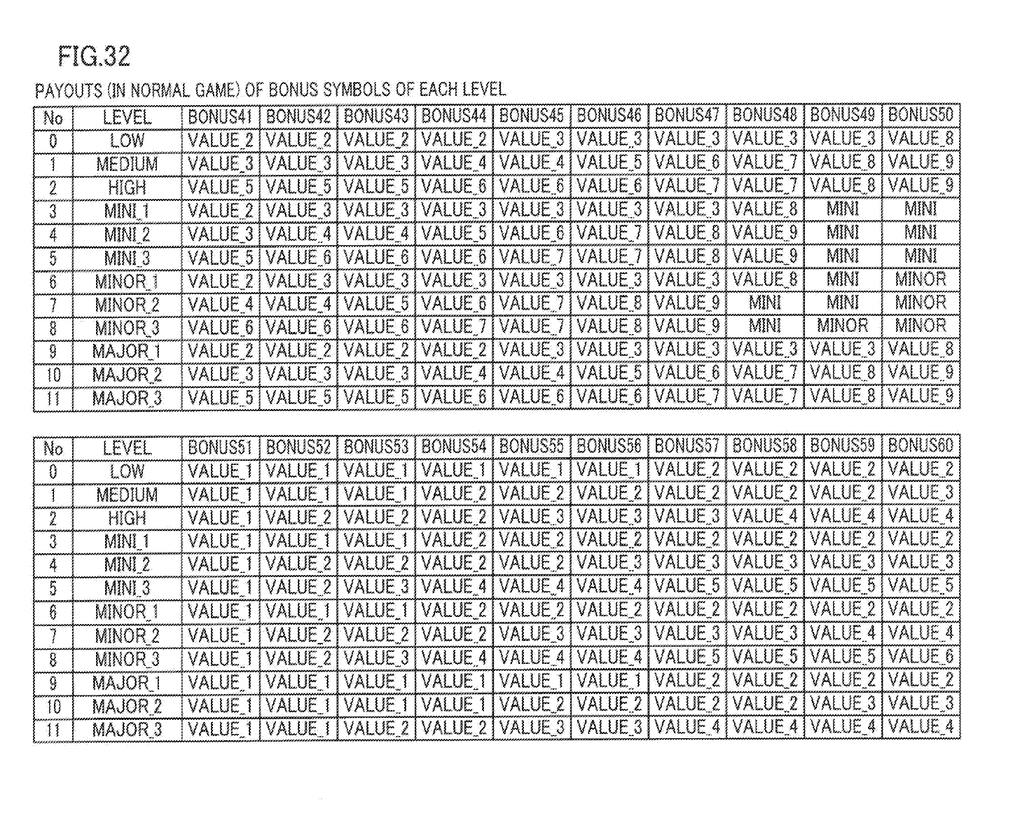

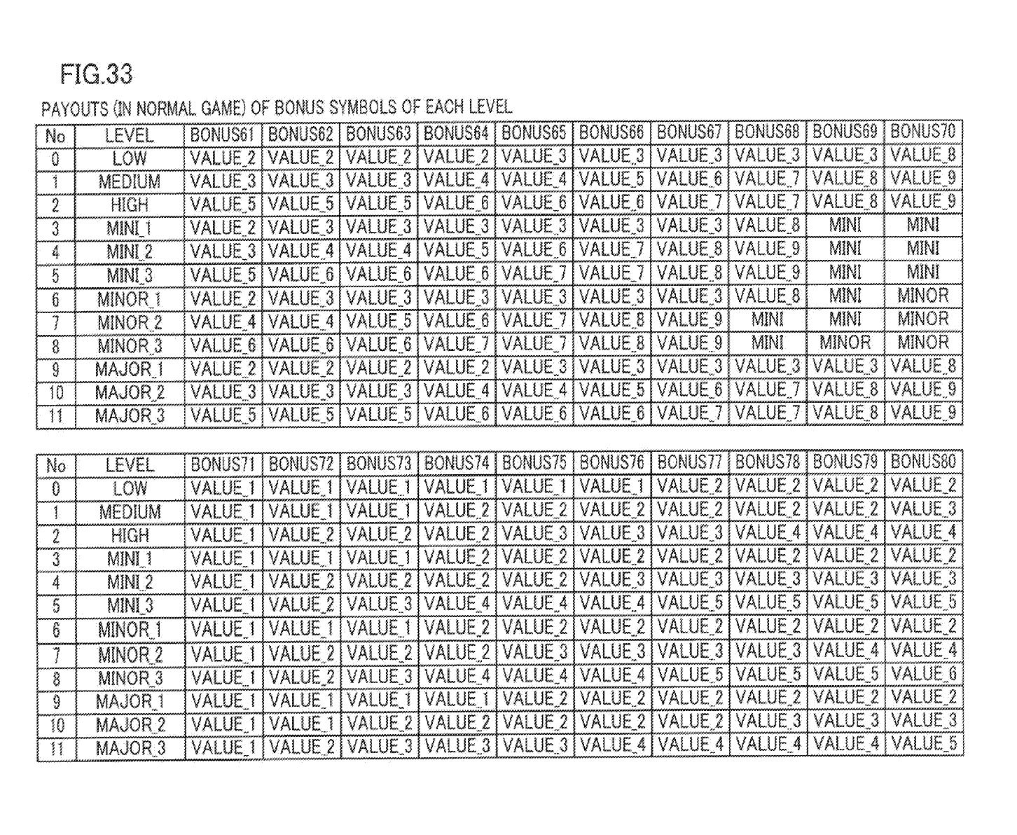

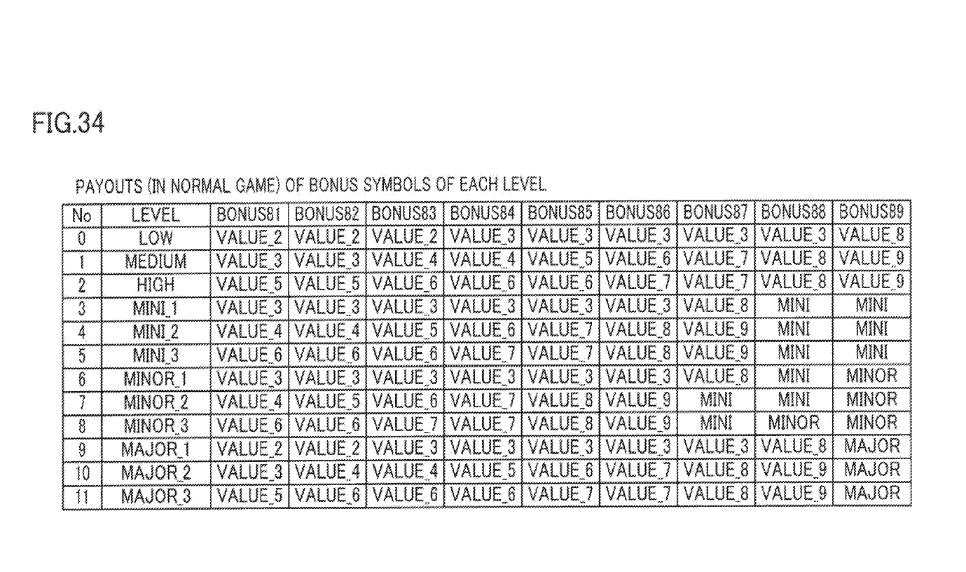

Now, payouts of bonus symbols of each level (normal game) will be described with reference to FIG. 30 to FIG. 34. The payouts of bonus symbols of each level (normal game) are referred to in the main control process which will be described later.

As the payouts of bonus symbols of each game (normal game), payout values (VALUE_1 to VALUE_9, MINI, MINOR, and MAJOR) of each of BONUS1 to BONUS89 corresponding to the payout level randomly determined based on the payout level random determination table are set. The BONUS1 to BONUS89 corresponding to the horizontal axis of the payouts of the bonus symbols of each game (normal game) correspond to the BONUS symbols provided on the normal game video reels shown in FIG. 8 to FIG. 18. To be more specific, BONUS1 to BONUS5 are associated with the code numbers of the first reel (Reel1) 3a in an ascending order. Similarly, the BONUS6 to BONUS89 are associated with BONUS symbols in the second video reel (Reel2) 3b to the fifth video reel (Reel5) 3e. For example, “BONUS” with the code number “48” in the first reel (Reel1) 3a is associated with BONUS3. “BONUS” with the code number “6” in the third reel (Reel3) 3c is associated with BONUS11. “BONUS” with the code number “1111” in the fifth reel (Reel5) 3e is associated with BONUS89.

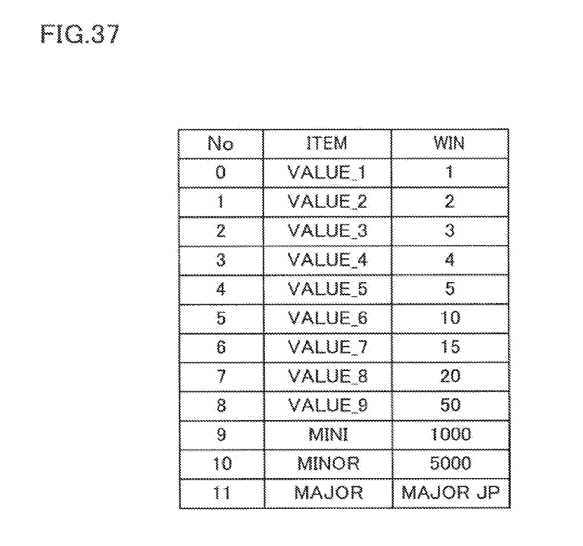

As shown in FIG. 37, payout values (VALUE_1 to VALUE_9, MINI, MINOR, and MAJOR) of each of the BONUS1 to BONUS89 are as follows: “VALUE_1” is 1 credit, “VALUE_2 is 2 credits, “VALUE_3 is 3 credits, “VALUE_4” is 4 credits, “VALUE_5” is 5 credits, “VALUE_6” is 10 credits, “VALUE_7” is 15 credits, “VALUE_8 is 20 credits, “VALUE_9” is 50 credits, “MINI” is 1000 credits, “MINOR” is 5000 credits, and “MAJOR” is a MAJOR jackpot payout (MAJOR JP).

For example, when the payout level is “MAJOR1”, 1 credit of “VALUE_1” is associated with BONUS4, 2 credits of “VALUE_2” is associated with BONUS11, and the MAJOR jackpot payout (MAJOR JP) of “MAJOR” is associated with BONUS89.

(Payouts of GOLD Symbol of Each Level (Normal Game and Free Game))

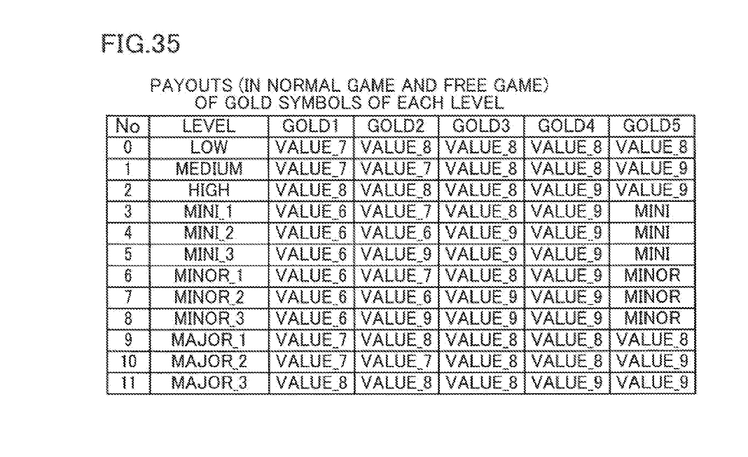

Now, payouts of GOLD symbols of each level (normal game and free game) will be described with reference to FIG. 35. The payouts of GOLD symbols of each level (normal game and free game) are referred to in the main control process which will be described later.

As the payouts of the GOLD symbols of each level (normal game and free game), payout values (VALUE_6 to VALUE_9, MINI, and MINOR) of each of GOLD1 to GOLD5 (GOLD symbols) corresponding to the payout level randomly determined based on the payout level random determination table are set. One of GOLD1 to GOLD5 (GOLD1 in the present embodiment) corresponding to the horizontal axis of the payouts of the GOLD symbols of each level (normal game and free game) corresponds to the GOLD symbol provided on the normal game video reels shown in FIG. 8 to FIG. 18 and the GOLD symbol provided on the free game video reels shown in FIG. 19 to FIG. 23. To be more specific, GOLD1 corresponds to the GOLD symbol with the code number “1137” on the fifth reel 3e of the normal game video reels. Furthermore, GOLD1 corresponds to the GOLD symbol with the code number “329” on the fifth reel 3e of the free game video reels. For the payout values (VALUE_6 to VALUE_9, MINI, and MINOR) of the GOLD1 to GOLD5, FIG. 37 is referred to.

(Payouts of GOLD Symbols of Each Level (JP Free Game))

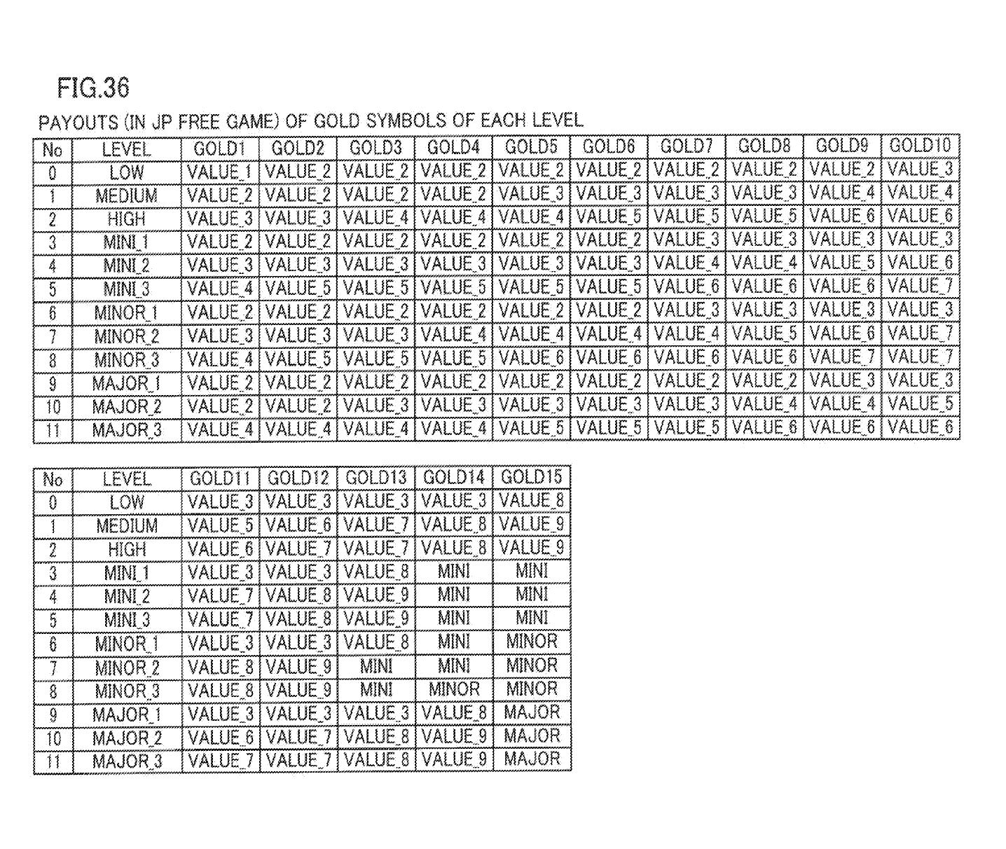

Now, payouts of GOLD symbols of each level (JP free game) will be described with reference to FIG. 36. The payouts of GOLD symbols of each level (JP free game) are referred to in a JP free game process which will be described later.

As the payouts of the GOLD symbols of each level (JP free game), payout values (VALUE_1 to VALUE_9, MINI, MINOR, and MAJOR, see FIG. 37) of each of GOLD1 to GOLD15 (GOLD symbol rearranged and fixed in the symbol display area 4 during the JP free game) corresponding to the payout level randomly determined based on the payout level random determination table are set. GOLD1 to GOLD15 corresponding to the horizontal axis of the payouts of the GOLD symbols of each level (JP free game) correspond to the order of the GOLD symbols rearranged and fixed in the symbol display area 4 shown in FIG. 6 in the JP free game. For example, when the GOLD symbol is rearranged and fixed in the middle stage of the first reel (Reel1) 3a in the first step in the JP free game, GOLD1 is associated. When the GOLD symbol is rearranged and fixed in the lower stage of the third reel (Reel3) 3c in the sixth step, GOLD6 is associated. When the GOLD symbol is rearranged and fixed in the upper stage of the fifth reel (Reel5) 3e in the fifteenth step, GOLD15 is associated.

The payout values (VALUE_1 to VALUE_9, MINI, MINOR, and MAJOR) of GOLD1 to GOLD15 correspond to the values shown in FIG. 37. For example, when the payout level is “MAJOR1”, 2 credits of “VALUE_2” are associated with GOLD1, 2 credits of “VALUE_2” is associated with GOLD6, and the MAJOR jackpot payout (MAJOR JP) of “MAJOR” is associated with GOLD15.

(Mystery Progressive Random Determination Table)

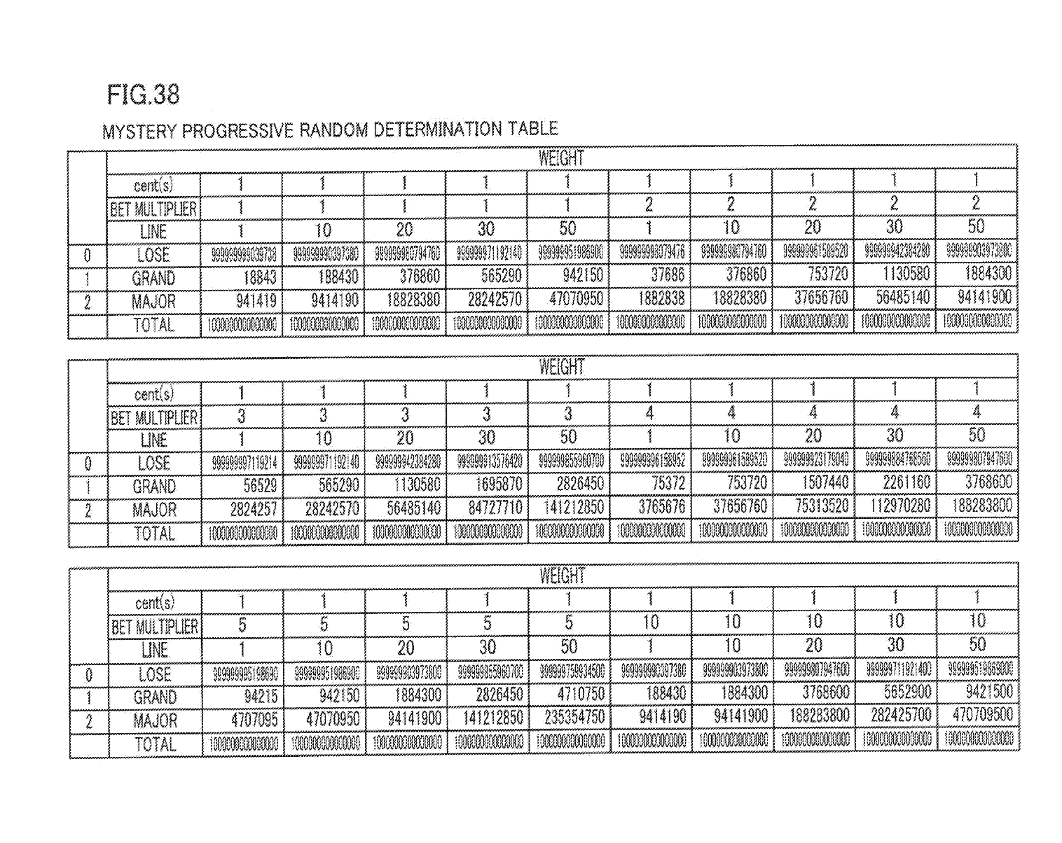

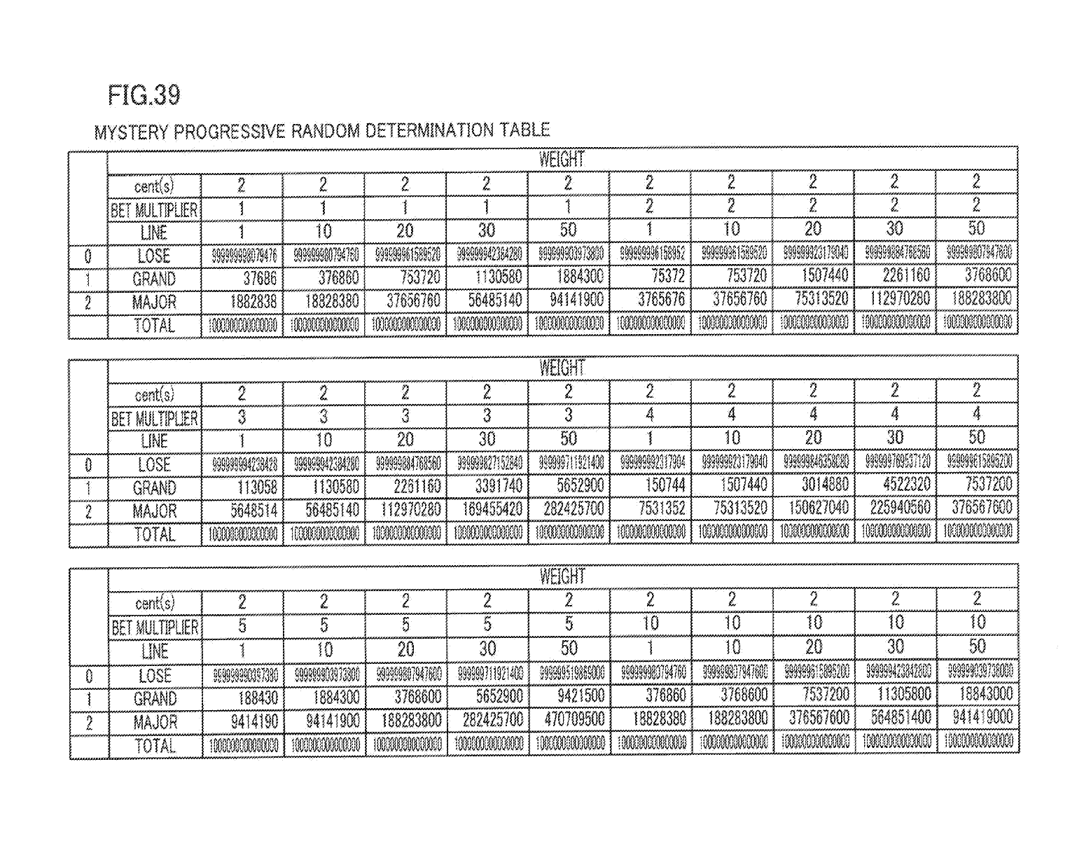

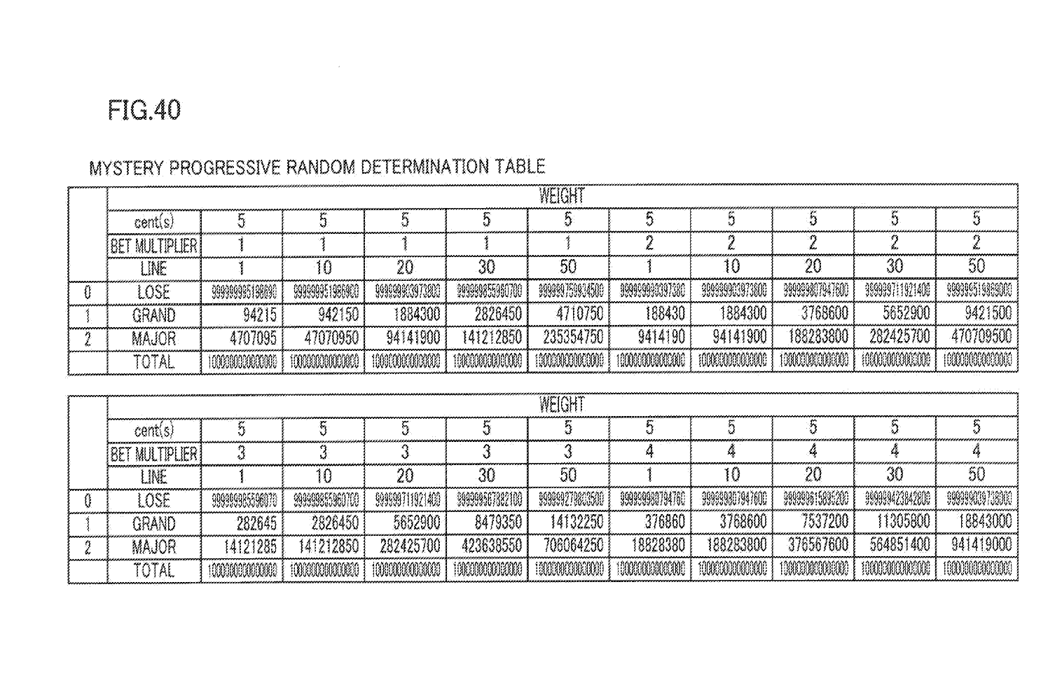

Now, a mystery progressive random determination table will be described with reference to FIG. 38 to FIG. 40. The mystery progressive random determination table is referred to in the main control process which will be described later.

In the mystery progressive random determination table, 80 random determination tables are provided to correspond to “current denominations (1 cent, 2 cents, and 5 cents): cent(s)”, “bet amounts betted on each activated winning line: Bet Multiplier”, and “numbers of activated winning lines: LINE”. In each of the 80 random determination tables, the probability of the selection of each of the types (“GRAND” (GRAND jackpot payout), “MAJOR” (MAJOR jackpot payout), and “LOSE” (lose)) of a mystery payout awarded in a later-described mystery progressive random determination process are defined. For example, when “current denomination” is 1 cent, “bet amount betted on each activated winning line” is 5 bets, and “number of activated winning lines” is 10 lines, a random determination table in which the probabilities are defined as follows is used: the probability of the selection of “LOSE” is “999999951986900/1000000000000000”, the probability of the selection of “GRAND” is “942150/1000000000000000”, and the probability of the selection of “MAJOR” is “47070950/1000000000000000”.

(Each-Number-of-Appearing-Bonus-Symbols Change Symbol Random Determination Table)

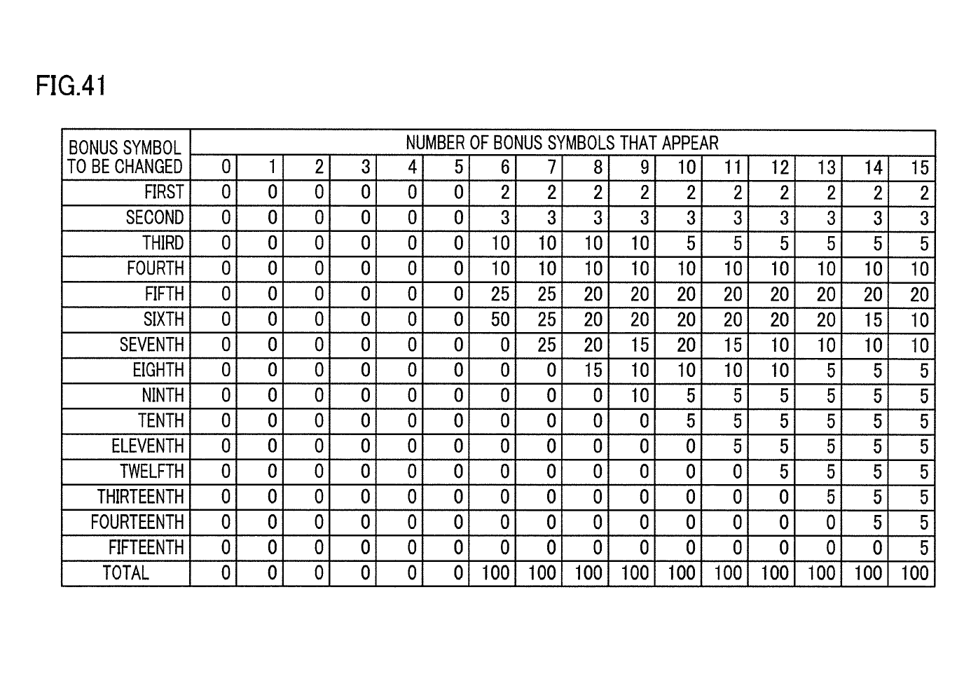

Now, a each-number-of-appearing-bonus-symbols change symbol random determination table will be described with reference to FIG. 41. The each-number-of-appearing-bonus-symbols change symbol random determination table is a table which is referred to in a GOLD symbol change random determination display process in the main control process which will be described later.

The each-number-of-appearing-bonus-symbols change symbol random determination table is a table which is referred to when one “BONUS” symbol is changed to “GOLD” symbol among six or more “BONUS” symbols which are selected as symbols to be rearranged in the symbol display area 4. To be more specific, in accordance with the number of (0 to 15) “BONUS” symbols having been selected to be rearranged in the symbol display area 4 and related to the horizontal axis of the each-number-of-appearing-bonus-symbols change symbol random determination table, which one of the (first to fifteenth) “BONUS” symbols rearranged in order in the symbol display area 4 is changed to the “GOLD” symbol is defined by associating each rank (one of the first to fifteenth) of the rearrangement of the “BONUS” symbol with the winning probability. When plural “BONUS” symbols are simultaneously rearranged in the symbol display area 4, the “BONUS” symbol with the smallest code number is regarded as the symbol rearranged first.

For example, when eight “BONUS” symbols are to be rearranged in the symbol display area 4, as shown in FIG. 41, a random determination table in which the probabilities are set as follows is selected: the probability that the “BONUS” symbol rearranged first is changed to the “GOLD” symbol is “2/100”, the probability that the “BONUS” symbol rearranged second is changed to the “GOLD” symbol is “3/100”, the probability that the “BONUS” symbol rearranged third is changed to the “GOLD” symbol is “10/100”, the probability that the “BONUS” symbol rearranged fourth is changed to the “GOLD” symbol is “10/100”, the probability that the “BONUS” symbol rearranged fifth is changed to the “GOLD” symbol is “20/100”, the probability that the “BONUS” symbol rearranged sixth is changed to the “GOLD” symbol is “20/100”, the probability that the “BONUS” symbol rearranged seventh is changed to the “GOLD” symbol is “20/100”, and the probability that the “BONUS” symbol rearranged eighth is changed to the “GOLD” symbol is “15/100”.

(Ten-Choice Payout Table Random Determination Table)

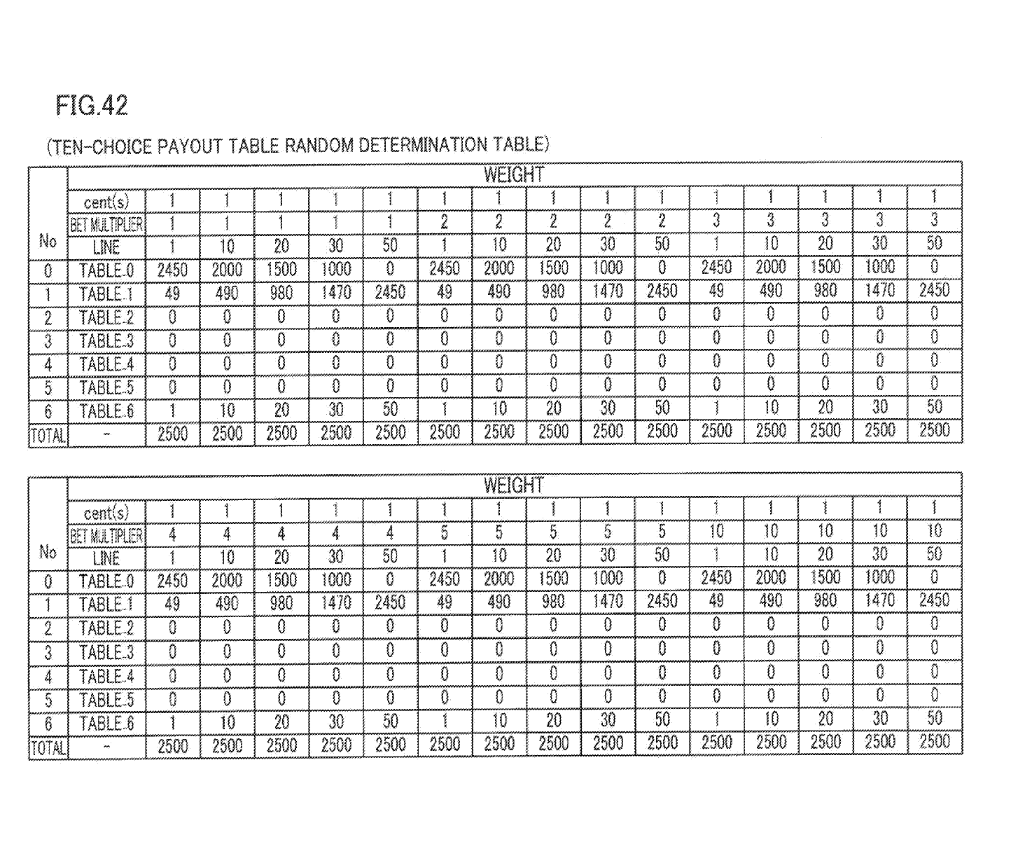

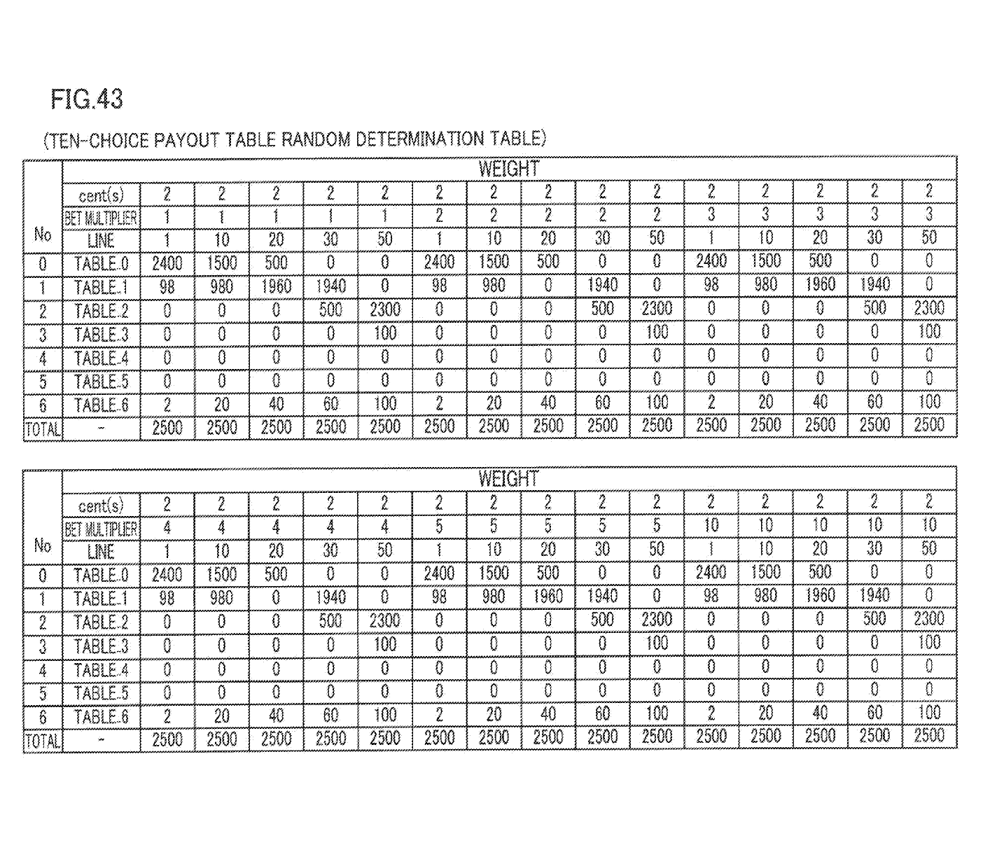

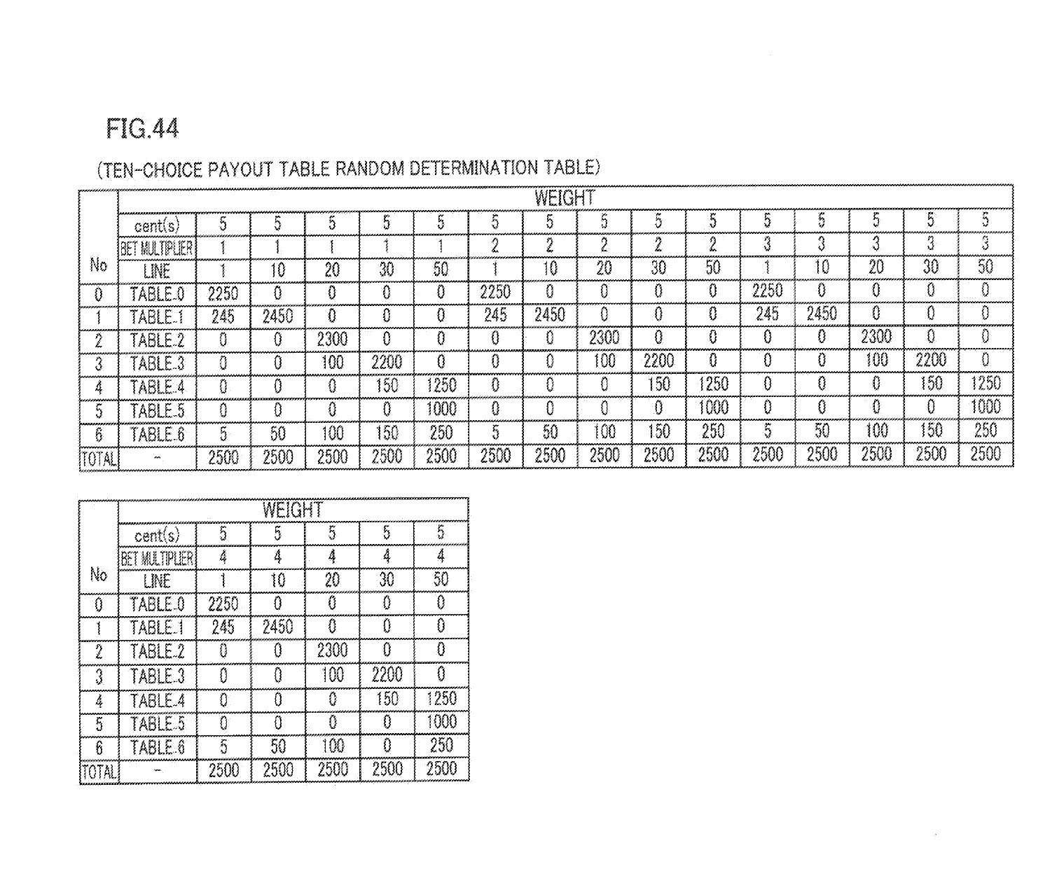

Now, a ten-choice payout table random determination table will be described with reference to FIG. 42 to FIG. 44. The ten-choice payout table random determination table is a table which is referred to in a later-described ten-choice pick game process.

In the ten-choice payout table random determination table, 80 random determination tables are provided to correspond to “current denominations (1 cent, 2 cents, and 5 cents): cent(s)”, “bet amounts betted on each activated winning line: Bet Multiplier”, and “numbers of activated winning lines: LINE”. In each of the 80 random determination tables, probabilities of the selection of seven types of ten-choice payout tables (Table_0, Table_1, Table_2, Table_3, Table_4, Table_5, and Table_6) by which a payout corresponding to each of ten options is determined are set. For example, when “current denomination” is 1 cent, “bet amount betted on each activated winning line” is 5 bets, and “number of activated winning lines” is 10 lines, a random determination table in which the probabilities are defined as follows is used: the probability of the selection of “Table_0” is “2000/2500”, the probability of the selection of “Table_1” is “490/2500”, the probability of the selection of “Table_2” is “0/2500”, the probability of the selection of “Table_3” is “0/2500”, the probability of the selection of “Table_4” is “0/2500”, the probability of the selection of “Table_5” is “0/2500”, and the probability of the selection of “Table_6” is “10/2500”.

(Ten-Choice Payout Table)

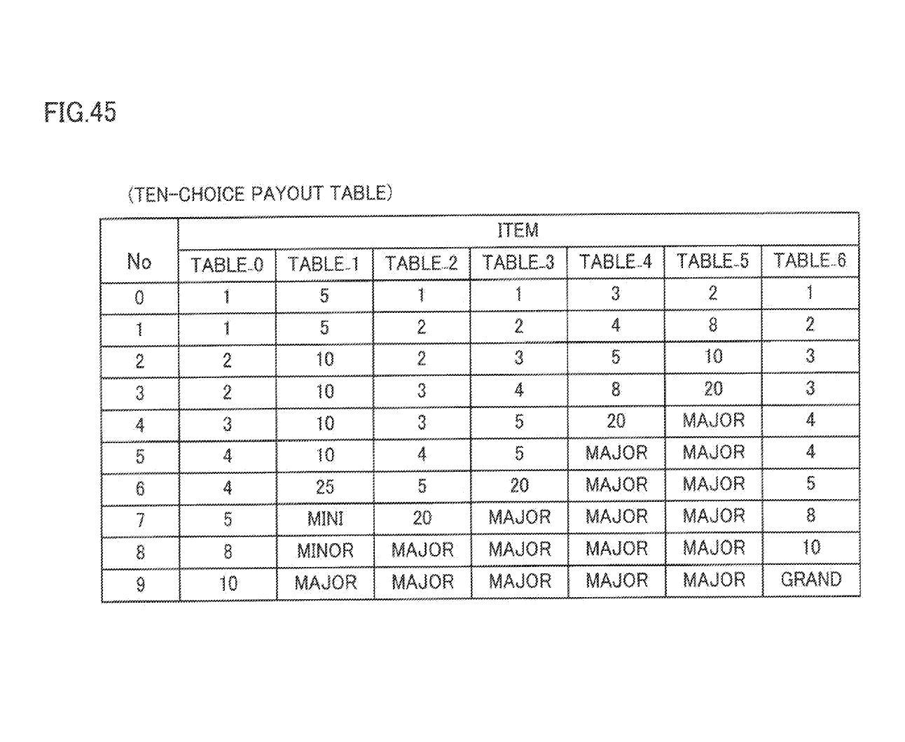

Now, referring to FIG. 45, a ten-choice payout table will be described.

In the ten-choice payout table, ten types of payouts are associated with each of Table_0, Table_1, Table_2, Table_3, Table_4, Table_5, and Table_6. For example, with Table_0, 1 credit, 1 credit, 2 credits, 2 credits, 3 credits, 4 credits, 4 credits, 5 credits, 8 credits, and 10 credits are associated. With Table_3, 1 credit, 2 credits, 3 credits, 4 credits, 5 credits, 5 credits, 20 credits, “MAJOR”, “MAJOR”, and “MAJOR” are associated. With Table_6, 1 credit, 2 credits, 3 credits, 3 credits, 4 credits, 4 credits, 5 credits, 8 credits, 10 credits, and “GRAND” are associated.

[Contents of Program]

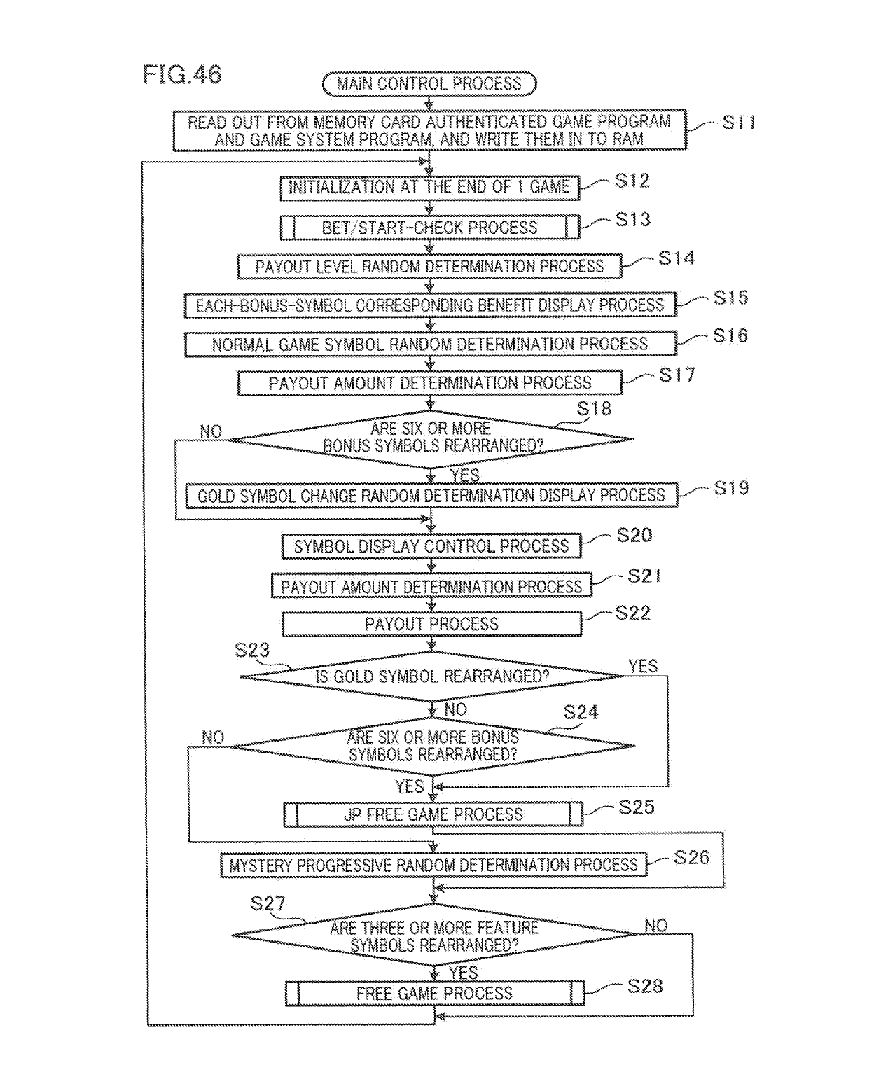

Now, the program to be executed by the slot machine 1 is described with reference to FIG. 46 to FIG. 50.

(Main Control Process)

Referring to FIG. 46, a main control process will be described. The main control process is configured to run a normal game (slot game).

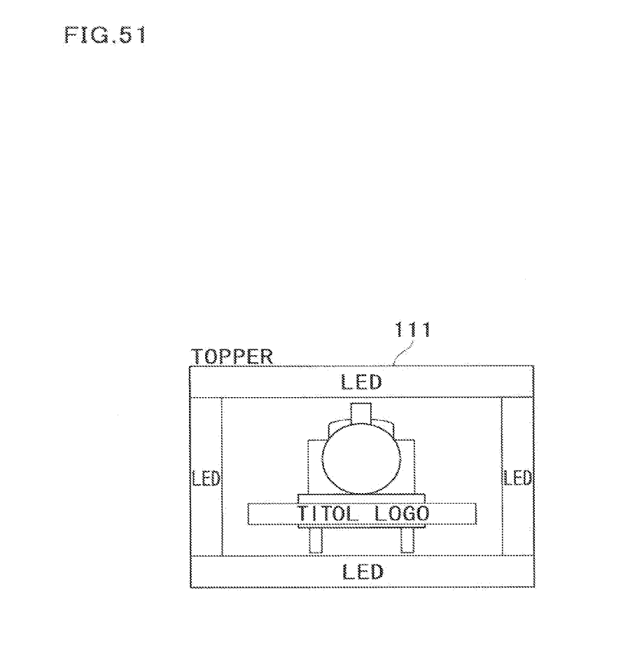

First, when the slot machine 1 is powered on, the main CPU 71 reads an authenticated game program and a game system program from the memory card 54 via the gaming board 50, and then write them in the RAM 73 (S11). At this stage, as shown in FIG. 51, the digital signage 111 displays an effect image of the game, together with the title logo of the slot game.

Subsequently, the main CPU 71 executes an initializing process at the end of each play of the game, in order to start the normal game (S12). This process clears data in a working area of the RAM 73, which becomes unnecessary at the end of each play of the normal game, e.g., a bet amount, randomly determined stop symbols, and the like.

The main CPU 71 then executes a later-described bet/start-check process (S13). In this process is carried out input checking and the like, to: the 1-BET switch 34S, the 2-BET switch 35S, the 3-BET switch 37S, the 4-BET switch 38S, the 5-BET switch 39S, the 1LINE switch 40S, the 10LINES switch 41S, the 20LINES switch 42S, the 30LINES switch 43S, the 50LINES switch 44S, the MAX-BET switch 45S, the spin switch 46S, and the like.

Then, the main CPU 71 executes a payout level random determination process (S14). In the payout level random determination process, to begin with, with reference to the payout level random determination tables (FIG. 27 to FIG. 29), “current denominations (1 cent, 2 cents, and 5 cents): cent(s)”, “bet amount betted on each activated winning line: Bet Multiplier”, and “numbers of activated winning lines: LINE”, one of 12 payout levels (“LOW”, “MEDIUM”, “HIGH”, “MINI1”, “MINI2”, “MINI3”, “MINOR1”, “MINOR2”, “MINOR3”, “MAJOR1”, “MAJOR2”, and “MAJOR3”) is randomly selected. In accordance with the selected payout level and the payouts of the bonus symbols of each level (normal game) (FIG. 30 to FIG. 34), a payout amount to be associated with the “BONUS” symbol provided on the normal game video reels is determined. Furthermore, in accordance with the selected payout level and the payouts of the GOLD symbols of each level (normal game and free game) (FIG. 35), a payout amount to be associated with the “GOLD” symbol provided on the normal game video reels is determined.

For example, when “current denomination” is 1 cent, “bet amount betted on each activated winning line” is 5 bets, and “number of activated winning lines” is 10 lines, a random determination table in which the probabilities are defined as follows is used: the probability of the selection of “LOW” is “1613168/2000000”, the probability of the selection of “MEDIUM” is “136251/2000000”, the probability of the selection of “HIGH” is “51581/2000000”, the probability of the selection of “MINI1” is “150000/2000000”, the probability of the selection of “MINI2” is “10000/2000000”, the probability of the selection of “MINI3” is “4000/2000000”, the probability of the selection of “MINOR1” is “27750/2000000”, the probability of the selection of “MINOR2” is “5000/2000000”, the probability of the selection of “MINOR3” is “1500/2000000”, the probability of the selection of “MAJOR1” is “650/2000000”, the probability of the selection of “MAJOR2” is “50/2000000”, and the probability of the selection of “MAJOR3” is “50/2000000”.

When the payout level is determined to be “MAJOR1” as a result of random determination based on the random determination table, as shown in FIG. 30 to FIG. 34, the payout amounts in the row of “MAJOR1” are associated with the BONUS symbols provided on the normal game video reels. For example, 1 credit of “VALUE_1” is associated with the BONUS3 with the code number “48” on the first reel (Reel1) 3a, 2 credits of the “VALUE_2” are associated with the BONUS11 with the code number “6” on the third reel (Reel3) 3c, and “MAJOR jackpot payout (MAJOR JP)” of “MAJOR” is associated with the BONUS89 with the code number “1111” on the fifth reel (Reel5) 3e. When the payout level is determined to be “MAJOR1”, as shown in FIG. 35, 15 credits of “VALUE_7” corresponding to the column of “GOLD1” and the row of “MAJOR1” are associated with the GOLD symbol with the code number “1137” on the fifth reel 3e of the normal game video reels.

Next, the main CPU71 executes an each-BONUS-symbol corresponding benefit display process (S15). In this each-BONUS-symbol corresponding benefit display process, the payout amounts associated with the “BONUS” symbol and the “GOLD” symbol provided on the normal game video reels, which have been determined in the payout level random determination process in S14, are displayed on the “BONUS” symbol and the “GOLD” symbol, respectively.

Then, the main CPU 71 executes a normal game symbol random determination process (S16). In this normal game symbol random determination process, to-be-stopped symbols are randomly selected from symbols provided on the normal game video reels (see FIG. 8 to FIG. 18). The to-be-stopped symbols are data for determining five symbols displayed in the middle stage of the symbol display area 4, among the symbols provided on the five symbol arrays (normal game video reels 3a, 3b, 3c, 3d, and 3e). In the present embodiment, five symbols to be displayed in the middle stage of the symbol display area 4 are selected from the symbols provided on the normal game video reels 3a, 3b, 3c, 3d, and 3e, as to-be-stopped symbols. In this way, 15 symbols displayed in the symbol display area 4 (the upper stage area, the middle stage area, and the lower stage area) are determined (see FIG. 6).

For example, in case of the first reel 3a (Reel1) of the normal game video reels, when a code number “31” is randomly selected from 64 symbols (code numbers “0” to “63”) forming the symbol array, the “FEATURE” symbol corresponding to the code number “31” is selected as the to-be-stopped symbol. In case of the second reel 3b (Reel2), when a code number “53” is randomly selected from 64 symbols (code numbers “0” to “63”) forming the symbol array, the “DOG” symbol corresponding to the code number “53” is selected as the to-be-stopped symbol. In case of the third reel 3c (Reel3), when a code number “40” is randomly selected from 64 symbols (code numbers “0” to “63”) forming the symbol array, the “DOG” symbol corresponding to the code number “40” is selected as the to-be-stopped symbol. In case of the fourth reel 3d (Reel4), when a code number “58” is randomly selected from 64 symbols (code numbers “0” to “63”) forming the symbol array, the “WILD” symbol corresponding to the code number “58” is selected as the to-be-stopped symbol. In case of the fifth reel 3e (Reel5), when a code number “1130” is randomly selected from 976 symbols (code numbers “0” to “1188”) forming the symbol array, the “QUEEN” symbol corresponding to the code number “1130” is selected as the to-be-stopped symbol.

The main CPU 71 stores the five selected symbols to be stopped on the normal game video reels 3a, 3b, 3c, 3d, and 3e in a symbol storing area in the RAM 73.

Then, the main CPU 71 executes an effect contents determination process (S17). The main CPU 71 extracts an effect-use random number and randomly selects one of a plurality of predetermined effect contents.

The main CPU 71 then determines whether no “GOLD” symbol is rearranged and six or more “BONUS” symbols in total are rearranged in the symbol display area 4 as a result of the normal game symbol random determination process in S16 (S18). When no “GOLD” symbol is rearranged and six or more “BONUS” symbols in total are rearranged in the symbol display area 4 (S18: YES), the GOLD symbol change random determination display process is executed (S19).

In this GOLD symbol change random determination display process, a random determination table to be used is selected with reference to the number of “BONUS” symbols selected to be rearranged in the symbol display area 4 determined in the normal game symbol random determination process in S16 and an each-number-of-appearing-bonus-symbols change symbol random determination table (see FIG. 41). Then random determination is carried out based on the selected random determination table to determine which “BONUS” symbol is to be changed to the “GOLD” symbol, among the six or more “BONUS” symbols to be rearranged in the symbol display area 4. Even if the “BONUS” symbol is changed to the “GOLD” symbol by random determination, the payout amounts which are associated in the BONUS-symbol corresponding benefit display process in S15 are not changed. Furthermore, while the “BONUS” symbol is changed to the “GOLD” symbol by random determination in the case above, rearranged “BONUS” symbols may be changed to “GOLD” symbols in a predetermined order, or which “BONUS” symbol is changed to the “GOLD” symbol may be determined in advance.

For example, when six “BONUS” symbols in total are to be rearranged in the symbol display area 4 as a result of the normal game symbol random determination process in S16, with reference to the each-number-of-appearing-bonus-symbols change symbol random determination table (see FIG. 41), a random determination table in which the probabilities are set as follows is selected: the probability that the “BONUS” symbol rearranged first is changed to the “GOLD” symbol is “2/100”, the probability that the “BONUS” symbol rearranged second is changed to the “GOLD” symbol is “3/100”, the probability that the “BONUS” symbol rearranged third is changed to the “GOLD” symbol is “10/100”, the probability that the “BONUS” symbol rearranged fourth is changed to the “GOLD” symbol is “10/100”, the probability that the “BONUS” symbol rearranged fifth is changed to the “GOLD” symbol is “25/100”, and the probability that the “BONUS” symbol rearranged sixth is changed to the “GOLD” symbol is “50/100”. When it is determined that the “BONUS” symbol rearranged second is to be changed to the “GOLD” symbol at the random determination probability of 3/100 as a result of the random determination based on the selected random determination table, the “BONUS” symbol rearranged second is changed to the “GOLD” symbol in a later-described symbol display control process in S20.

After S19 or in S18, if the “GOLD” symbol is rearranged in the symbol display area 4 or six or more “BONUS” symbols are not rearranged in total (S18: NO), the main CPU 71 executes a symbol display control process (S20). In this symbol display control process, when a predetermined time elapses after the scroll of the normal game video reels 3a, 3b, 3c, 3d, and 3e starts, the to-be-stopped symbols corresponding to the normal game video reels 3a, 3b, 3c, 3d, and 3e selected in the normal game symbol random determination process in S16 stop one by one in the middle stage of the symbol display area 4. In other words, 15 symbols including the to-be-stopped symbols are rearranged in the symbol display area 4.

For example, when the “FEATURE” symbol with the code number “31” is selected as the to-be-stopped symbol on the first reel 3a (Reel1) of the normal game video reels, the “DOG” symbol with the code number “53” is selected as the to-be-stopped symbol on the second reel 3b (Reel2), the “DOG” symbol with the code number “40” is selected as the to-be-stopped symbol on the third reel 3c (Reel3), the “WILD” symbol with the code number “58” is selected as the to-be-stopped symbol on the fourth reel 3d (Reel4), and the “QUEEN” symbol with the code number “1130” is selected as the to-be-stopped symbol on the fifth reel 3e (Reel5), the “FEATURE”, “DOG”, “DOG”, “WILD”, and “QUEEN” symbols are rearranged in the middle stage of the symbol display area 4. In the upper stage and the lower stage of the symbol display area 4, symbols having code numbers each of which is one number off the to-be-stopped symbols are rearranged.

When in S19 the “BONUS” symbol to be changed to the “GOLD” symbol is selected from the six or more “BONUS” symbols to be rearranged in the symbol display area 4, the “BONUS” symbol to be changed to the “GOLD” symbol is changed to the “GOLD” symbol when the scroll of the normal game video reels 3a, 3b, 3c, 3d, and 3e starts. Then the “BONUS” symbol having been changed to the “GOLD” symbol is rearranged in the symbol display area 4.

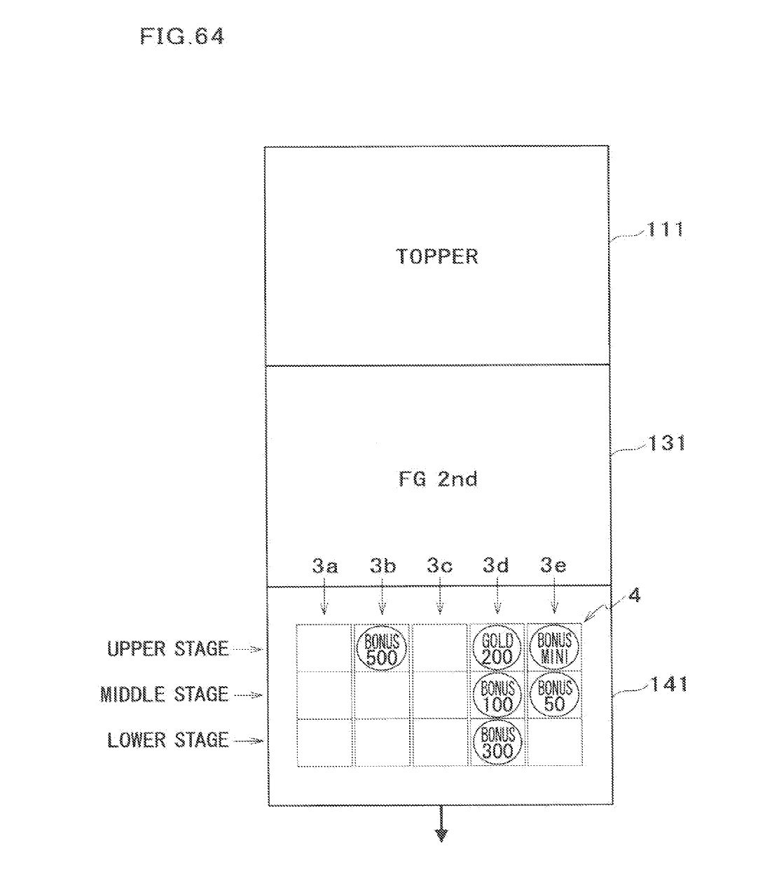

For example, when the “BONUS” symbol rearranged second is to be changed to the “GOLD” symbol, the scroll of the normal game video reels 3a, 3b, 3c, 3d, and 3e starts, and the “BONUS” symbol to be rearranged in the upper stage of the fourth reel 3d (Reel4) is changed to the “GOLD” symbol, as shown in FIG. 64, the normal game video reels 3a, 3b, 3c, 3d, and 3e are stopped one by one and the “GOLD” symbol changed from the “BONUS” symbol is rearranged in the upper stage of the fourth reel 3d (Reel4) in the symbol display area 4.

In the normal game, shift to the JP free game process occurs not only when the “GOLD” symbol is rearranged in the symbol display area 4 (trigger condition 1) but also when six or more “BONUS” symbols are rearranged in the symbol display area 4 (trigger condition 2). In short, there are two trigger conditions for shifting to the JP free game process.

The trigger conditions 1 and 2, however, are different in the type of the symbol rearranged in the symbol display area 4 (i.e., the “GOLD” symbol or the six or more “BONUS” symbols). Therefore the player may not recognize that they are both trigger conditions for shifting to the JP free game process, given as benefits.

For this reason, when six or more “BONUS” symbols are to be rearranged in the symbol display area 4 (trigger condition 2), one of the six or more “BONUS” symbols to be rearranged in the symbol display area 4 is randomly changed to the “GOLD” symbol and rearranged. With this, the type of the symbol rearranged in the symbol display area 4 when the trigger condition 2 is established (i.e., change from the “BONUS” symbol to the “GOLD” symbol) is identical (same) with the type of the symbol rearranged in the symbol display area 4 when the trigger condition 1 is established (“GOLD” symbol). On this account, the type of the symbol rearranged in the symbol display area 4 is identical (same) even if there are two trigger conditions for shifting to the JP free game process, and hence the player easily recognizes that they are both the trigger conditions for shifting to the same JP free game process (i.e., complicated the game rules are avoided).

Then, the main CPU 71 executes a payout amount determination process (S21). In this process, whether a combination of symbols rearranged on an activated winning line is a combination of symbols defined in the symbol combination table shown in FIG. 26 is determined. In accordance with the winning and the betted credit value, a benefit such as a payout is awarded. The payout awarded is stored in a payout amount storage area of the RAM 73. For example, when 5 credits are betted by the 5-BET button 39 and a combination of three “DOG” symbols is established, a payout is 25 credits calculated by multiplying 5 by 5 with reference to the symbol combination table shown in FIG. 26, and the payout is stored in the payout amount storage area in the RAM 73.

Then, the main CPU 71 executes a payout process (S22). The main CPU 71 adds a value stored in the payout amount storage area to a value in a credit counter provided in the RAM 73.

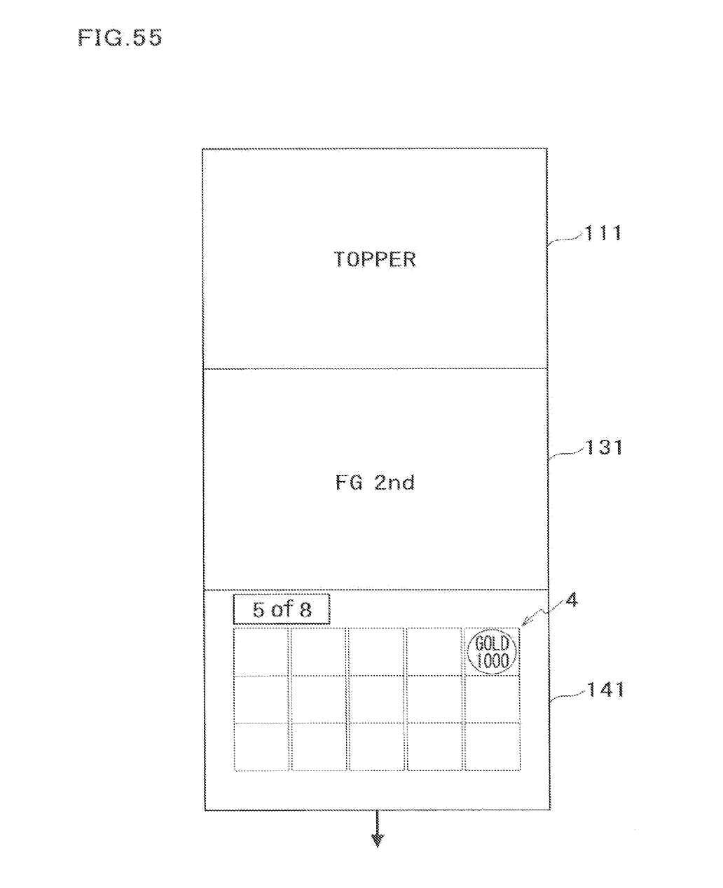

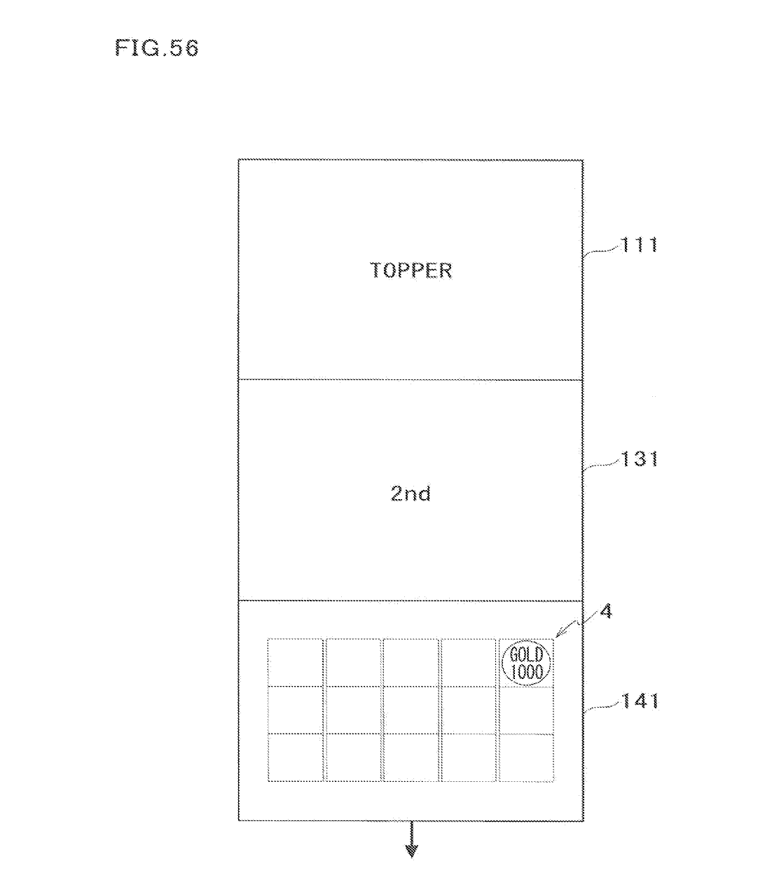

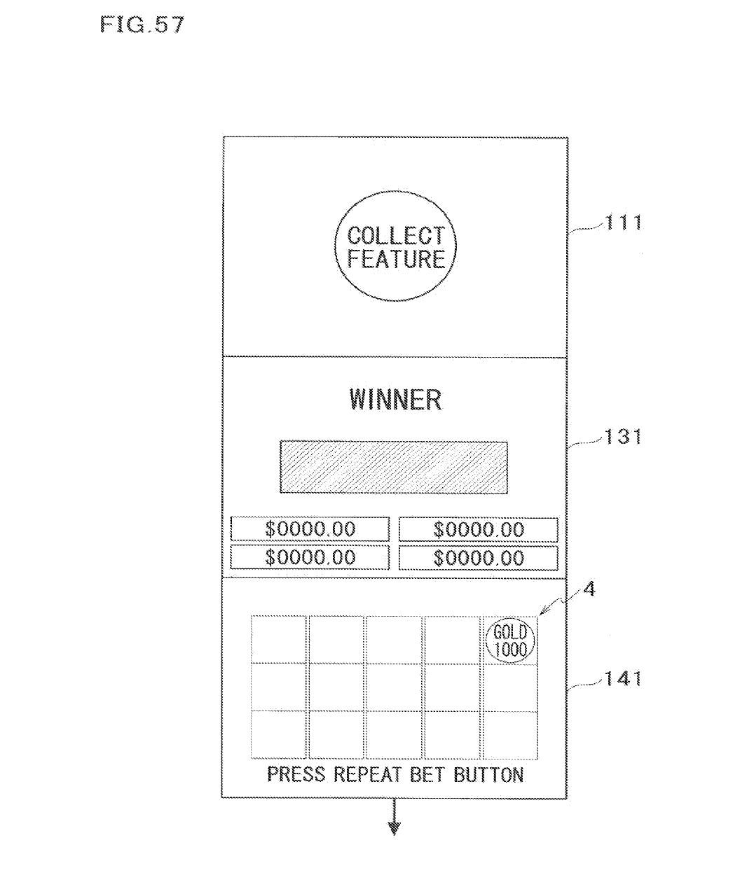

Subsequently, the main CPU 71 determines whether the “GOLD” symbol is rearranged in the symbol display area 4 (S23). When the “GOLD” symbol is rearranged in the symbol display area 4 (S23: YES) as shown in FIG. 55, an effect of shifting to the JP free game is executed and then the later-described JP free game process is executed as shown in FIG. 56 and FIG. 57 (S25).

In the meanwhile, when the “GOLD” symbol is not rearranged in the symbol display area 4 (S23: NO), the main CPU 71 determines whether six or more “BONUS” symbols are rearranged in total in the symbol display area 4 (S24). When six or more “BONUS” symbols are rearranged in total in the symbol display area 4 (S24: YES), the later-described JP free game process is executed (S25).

When six or more “BONUS” symbols are rearranged in total in the symbol display area 4 (S24: YES), one “GOLD” symbol changed from the “BONUS” symbol as a result of the above-described GOLD symbol change random determination display process is rearranged in the symbol display area 4 (see FIG. 64).

When six or more “BONUS” symbols are not rearranged in total (S24: NO), the main CPU 71 executes a mystery progressive random determination process (S26). In the mystery progressive random determination process, to begin with, with reference to the mystery progressive random determination tables (FIG. 38 to FIG. 40), “current denominations (1 cent, 2 cents, and 5 cents): cent(s)”, “bet amount betted on each activated winning line: Bet Multiplier”, and “numbers of activated winning lines: LINE”, the type of the mystery payout (“GRAND” (GRAND jackpot payout), “MAJOR” (MAJOR jackpot payout), or “LOSE” (lose)) is randomly selected and awarded.

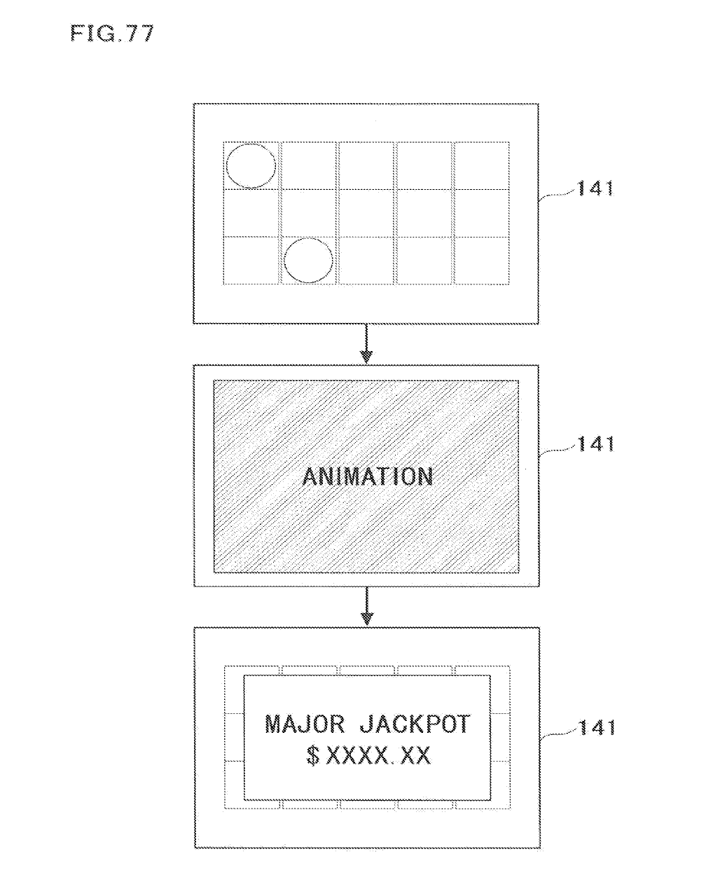

For example, assume that “current denomination” is 1 cent, “bet amount betted on each activated winning line” is 5 bets, and “number of activated winning lines” is 10 lines, a random determination table in which the probabilities are defined as follows is used: the probability of the selection of “LOSE” is “999999951986900/1000000000000000”, the probability of the selection of “GRAND” is “942150/1000000000000000”, and the probability of the selection of “MAJOR” is “47070950/1000000000000000”, and “MAJOR” (MAJOR jackpot payout) is selected as a result of random determination based on the table. In this case, “MAJOR” (MAJOR jackpot payout which will be detailed later) is awarded. To be more specific, a value stored in the MAJOR payout counter is added to a value in a credit counter provided in the RAM 73. At this stage, as shown in FIG. 77, after animation display, winning of “MAJOR” (MAJOR jackpot payout) and a MAJOR jackpot payout amount are displayed on the lower image display panel 141.

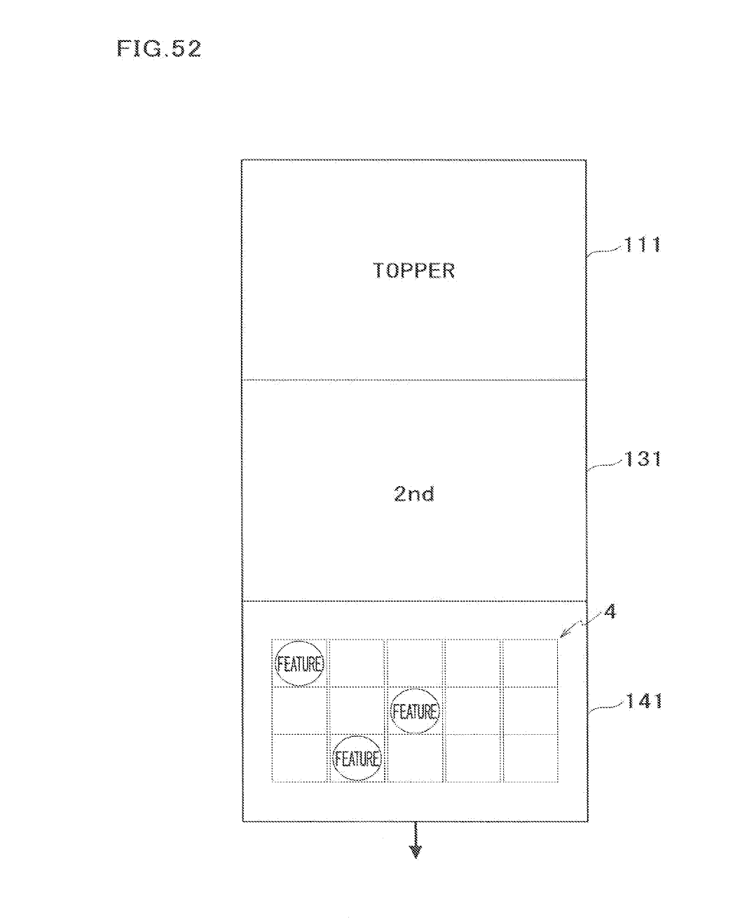

After S25 or S26, the main CPU 71 determines whether three or more “FEATURE” symbols have been rearranged in total in the symbol display area 4 in S20 (S27). As shown in FIG. 52, when three or more “FEATURE” symbols have been rearranged in total in the symbol display area 4 (S27: YES), a later-described free game process is executed (S28).

After S28 or when three or more “FEATURE” symbols have not been rearranged in total in the symbol display area 4 in S27 (S27: NO), the routine proceeds to S12.

(Bet/Start-Check Process)

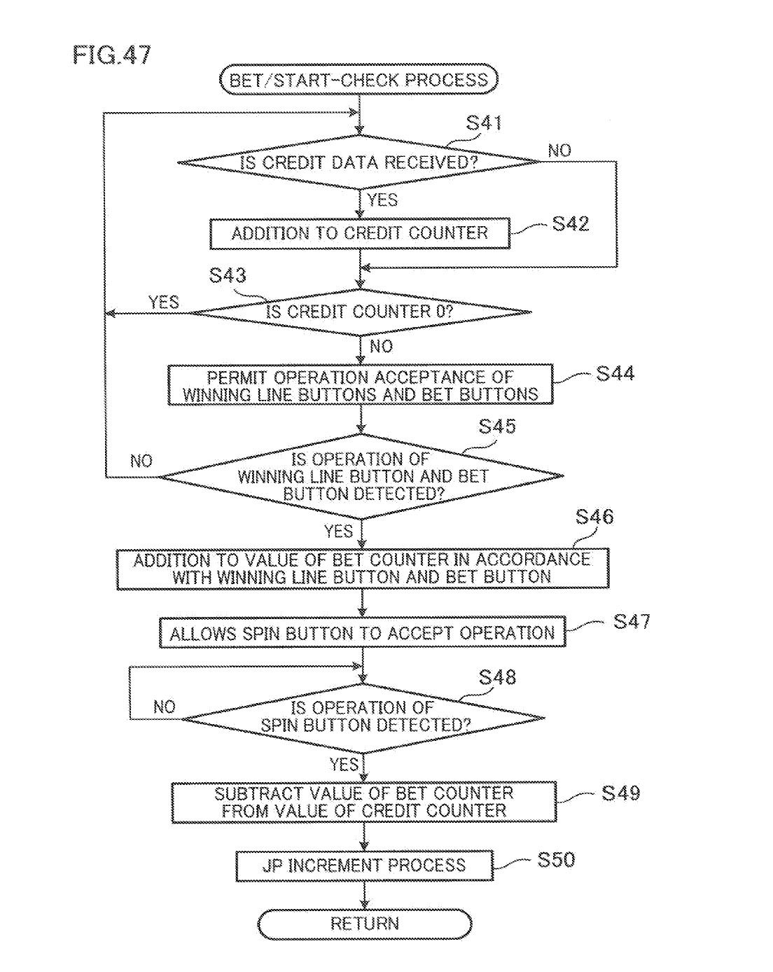

Now the bet/start-check process will be described with reference to FIG. 47.

To begin with, the main CPU 71 determines whether credit data is received from the PTS device 700 (S41). The credit data is sent from the PTS device 700 to the main CPU 71, for example, when the IC card is inserted into the card insertion slot and when the bill entry 115 receives a genuine bill.

When determining that credit data is received (S41: YES), the main CPU 71 adds the amount indicated by the received credit data to the value of the credit counter (S42).

After S42 or when determining that no credit data is received in S41 (S41: NO), the main CPU 71 determines whether the value of the credit counter is 0 (S43). When determining that the value of the credit counter is 0 (S43: YES), the main CPU 71 goes back to S41.

In the meanwhile, when determining that the value of the credit counter is not 0 (S43: NO), the main CPU 71 enables operation of the winning line buttons (play-1-line button 40, play-10-line button 41, play-20-line button 42, play-30-line button 43, and play-50-line button 44) and the bet buttons (1-BET button 34, 2-BET button 35, 3-BET button 37, 4-BET button 38, 5-BET button 39, and MAX-BET button 45) (S44). As the winning line button is selected, the number of activated winning lines is determined (see FIG. 7). Furthermore, as the BET button is selected, the credit amount to be betted on each activated winning line is determined.

Next, the main CPU 71 determines if an operation of the winning line button or the BET button is detected (S45). When the operation of the winning line button or the BET button is not detected (S45: NO), the routine proceeds to S41. When the main CPU 71 detects pressing of the winning line button by the player through the winning line button switch (1-line switch 40S, 10-line switch 41S, 20-line switch 42S, 30-line switch 43S, and 50-line switch 44S) and detects pressing of the BET button by the player through the BET switch (1-BET switch 34S, 2-BET switch 35S, 3-BET switch 37S, 4-BET switch 38S, 5-BET switch 39S) (S45: YES), the main CPU 71 adds, to the bet counter provided in the RAM 73, a value which is the product of the amount of credit necessary for activating the winning line (1 credit when one winning line is activated by the play-1-line button 40, 10 credits when 10 winning lines are activated by the play-10-line button 41, 20 credits when 20 winning lines are activated by the play-20-line button 42, 30 credits when 30 winning lines are activated by the play-30-line button 43, 50 credits when 50 winning lines are activated by the play-50-line button 44) multiplied by the amount of credit corresponding to the BET button operated (1 credit for the 1-BET button 34, 2 credits for the 2-BET button 35, 3 credits for the 3-BET button 37, 4 credits for the 4-BET button 38, and 5 credits for the 5-BET button 39) (S46).

For example, when the play-10-line button 41 and 2-BET button 35 are selected, 20 credits, which is a product of 10×2, are added to the bet counter. Further, when the play-50-line button 44 and 5-BET button 39 are selected, 250 credits, which is a product of 50×5, are added to the bet counter.

After the step S46, the main CPU 71 allows the spin button 46 to accept an operation (S47).

After S47, the main CPU 71 determines whether or not an operation of the spin button 46 is detected (S48). When the main CPU 71 determines that an operation of the spin button 46 is not detected (S48: NO), an operation of the spin button 46 is waited for.

In the meanwhile, when the main CPU 71 determines that operation of the spin button 46 is detected (S48: YES), the main CPU 71 subtracts the value of the bet counter calculated in S46 from the value of the credit counter (S49).

Then, the main CPU 71 executes a JP increment process (S50). In the JP increment process, a GRAND payout counter (equivalent to the progressive counter) and a MAJOR payout counter (equivalent to the progressive counter) of the RAM 73 are incremented with a value calculated by multiplying the value of the bet counter calculated in S46 by an increment rate (0.5% for “GRAND” of the progressive payout and 1.0% for “MAJOR” of the progressive payout) set in the present embodiment, as resources for “GRAND” of the progressive payout and “MAJOR” of the progressive payout. For example, when the value of the bet counter calculated in S46 is 100, 0.5 credit calculated by multiplying 0.005 by 100 is added to the value of the GRAND payout counter, and 1.0 credit calculated by multiplying 0.010 by 100 is added to the value of the MAJOR payout counter. In the present embodiment, the value of the GRAND payout counter and the value of the MAJOR payout counter are at initial values (850000 credits are set at the GRAND payout counter and 100000 credits are set at the MAJOR payout counter). For this reason, to the initial value of 850000 credits of the GRAND payout counter, a value calculated by multiplying the value of the bet counter by the increment rate (0.5%) is accumulatively added in each game play. Similarly, to the initial value of 100000 credits of the MAJOR payout counter, a value calculated by multiplying the value of the bet counter by the increment rate (1.0%) is accumulatively added in each game play. When “MAJOR” is won in accordance with the game progress, the value of the MAJOR payout counter is awarded as a MAJOR jackpot payout. When “GRAND” is won in accordance with the game progress, the value of the GRAND payout counter is awarded as a GRAND jackpot payout.

Then the bet/start-check process is terminated.

(Free Game Process)

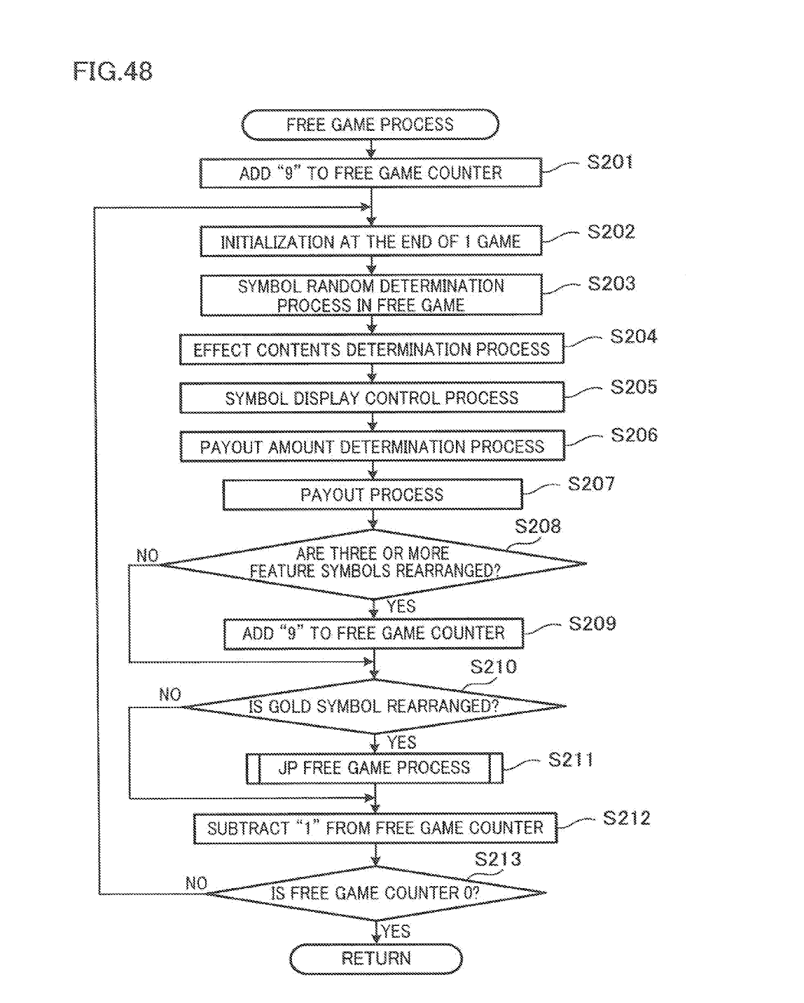

Now, a free game process executed in the main control process will be described with reference to FIG. 48.

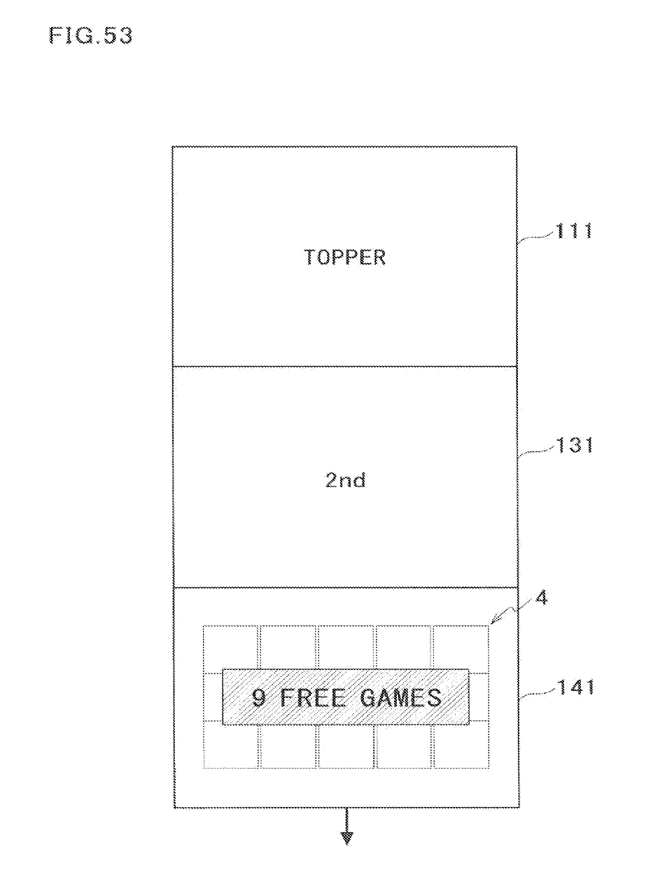

First, the main CPU 71 adds “9” to the free game play counter in the RAM 73 (S201). At this stage, a message “9 FREE GAMES” is displayed on the lower image display panel 141 as shown in FIG. 53.

Next, the main CPU 71 executes the at-one-game-end initialization process (S202) in the same manner as the step S12.

The main CPU 71 then executes a symbol random determination process in the free game (S203). In the symbol random determination process in the free game, to-be-stopped symbols are randomly selected from symbols provided on free game video reels (see FIG. 19 to FIG. 23). The to-be-stopped symbols are data for determining five symbols displayed in the middle stage of the symbol display area 4, among the symbols provided on the five symbol arrays (free game video reels 3a, 3b, 3c, 3d, and 3e).

The main CPU 71 stores the five selected to-be-stopped symbols to be stopped on the free game video reels in a symbol storing area in the RAM 73.

Then, the main CPU 71 executes an effect contents determination process (S204). The main CPU 71 extracts an effect-use random number and randomly selects one of a plurality of predetermined effect contents.

Then, the main CPU 71 executes a symbol display control process (S205). In this symbol display control process, the scroll of the free game video reels is started, and the five to-be-stopped symbols determined in the symbol random determination process of S203 are stopped one by one in the middle stage of the symbol display area 4. In other words, 15 symbols including the five to-be-stopped symbols are rearranged in the symbol display area 4.

When 15 symbols are rearranged in the symbol display area 4 and at least one “WILD” symbol is rearranged in the upper stage, the middle stage, or the lower stage of the symbol display area 4 on each of the reels 3a to 3e, “WILD” symbols successively provided on the free game video reels (see FIG. 19 to FIG. 23) are pushed (nudged) into the symbol display area 4 (upper stage, middle stage, or lower stage) where no “WILD” symbol is rearranged, with the result that three “WILD” symbols are rearranged in the upper stage, the middle stage, and the lower stage of the symbol display area 4 (nudge process).

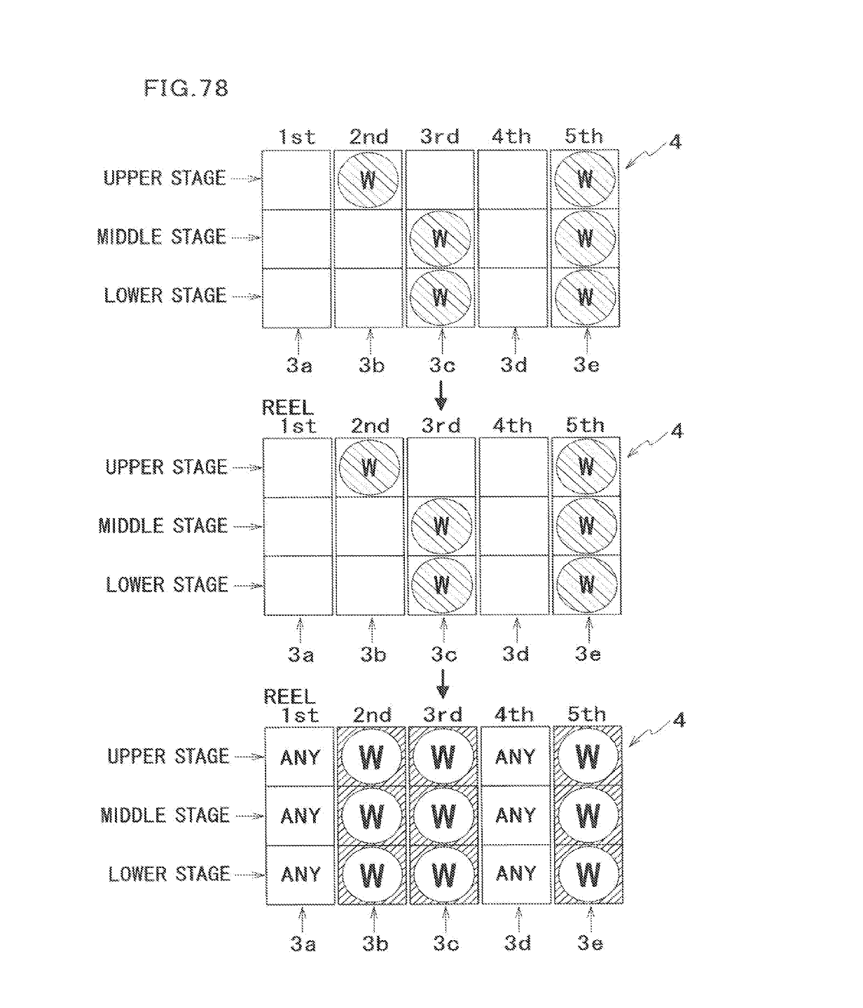

For example, as shown in FIG. 78, when the “WILD” symbol with the code number “45” is rearranged in the upper stage of the reel 3b in the symbol display area 4 as a result of S205, three “WILD” symbols (code numbers 43 to 45) successively arranged on “Reel2” of the free game video reels (see FIG. 19 to FIG. 23) are pushed downward by two stages (nudge process). As a result, three “WILD” symbols are rearranged in the upper stage, the middle stage, and the lower stage of the reel 3b in the symbol display area 4. Furthermore, as shown in FIG. 78, when two “WILD” symbols with the code numbers “33” and “34” are rearranged in the middle stage and the lower stage of the reel 3c in the symbol display area 4 as a result of S205, three “WILD” symbols (code numbers 33 to 35) successively arranged on “Reel3” of the free game video reels (see FIG. 19 to FIG. 23) are pushed upward by one stage (nudge process). As a result, three “WILD” symbols are rearranged in the upper stage, the middle stage, and the lower stage of the reel 3c in the symbol display area 4. When, as shown in FIG. 78, three “WILD” symbols are rearranged in the upper stage, the middle stage, and the lower stage of the reel 3e in the symbol display area 4 as a result of S205, this rearrangement of the three “WILD” symbols is maintained. The nudge process is simultaneously executed when in S205 15 symbols including five to-be-stopped symbols are rearranged in the symbol display area 4.

When three “WILD” symbols are rearranged in the upper stage, the middle stage, and the lower stage of each of the reels 3a to 3e on account of the above-described nudge process or the like and a combination of symbols rearranged on a winning line activated in the main control process (normal game) is a combination (winning) of symbols defined in the symbol combination table shown in FIG. 26, an effect by an integrated image is carried out on the three “WILD” symbols rearranged in the upper stage, the middle stage, and the lower stage of each of the reels 3a to 3e.

Then, the main CPU 71 executes a payout amount determination process (S206). In this process, whether a combination of symbols rearranged on a winning line activated in the main control process (normal game) is a combination (winning) of symbols defined in the symbol combination table shown in FIG. 26 is determined. It is noted that the activated winning line and the betted credit value in the free game are identical with those input in the bet/start-check process (S13) in the normal game. In accordance with the winning and the betted credit value in the normal game, a benefit such as a payout is awarded. The payout awarded is stored in a payout amount storage area of the RAM 73. For example, when in the normal game 5 credits are betted by the 5-BET button 39 and a combination of three “DOG” symbols is established, a payout is 25 credits calculated by multiplying 5 by 5 with reference to the symbol combination table shown in FIG. 26, and the payout is stored in the payout amount storage area in the RAM 73.

Then, the main CPU 71 executes a payout process (S207). The main CPU 71 adds a value stored in the payout amount storage area to a value in a credit counter provided in the RAM 73.

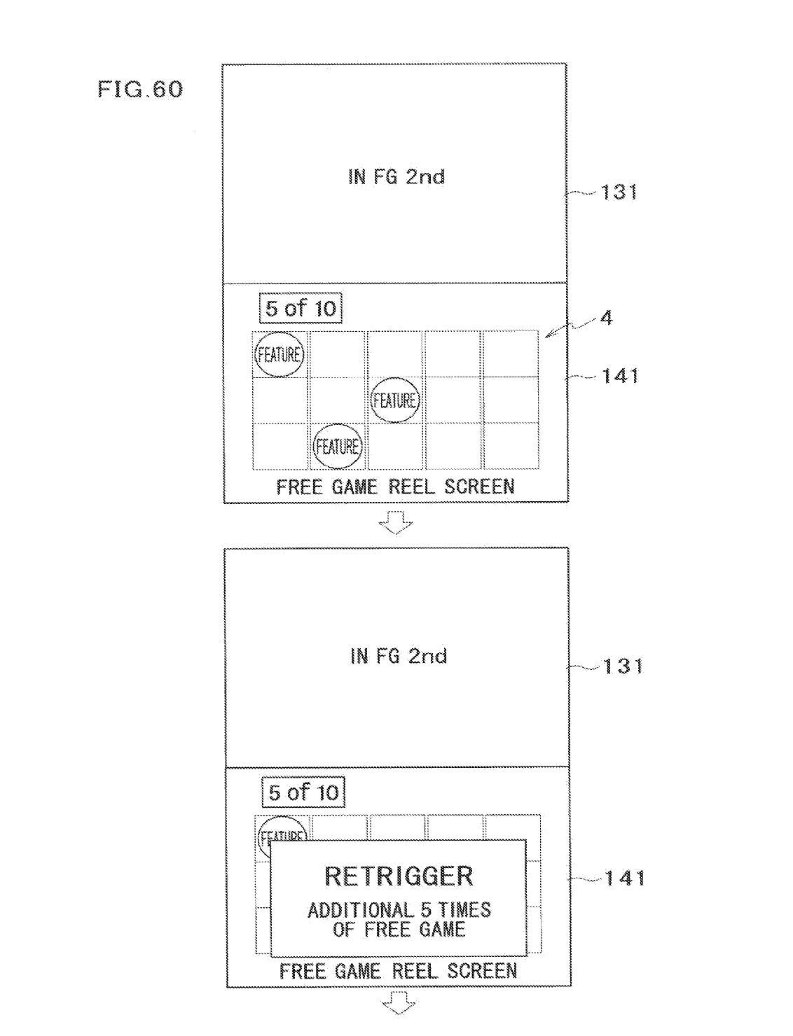

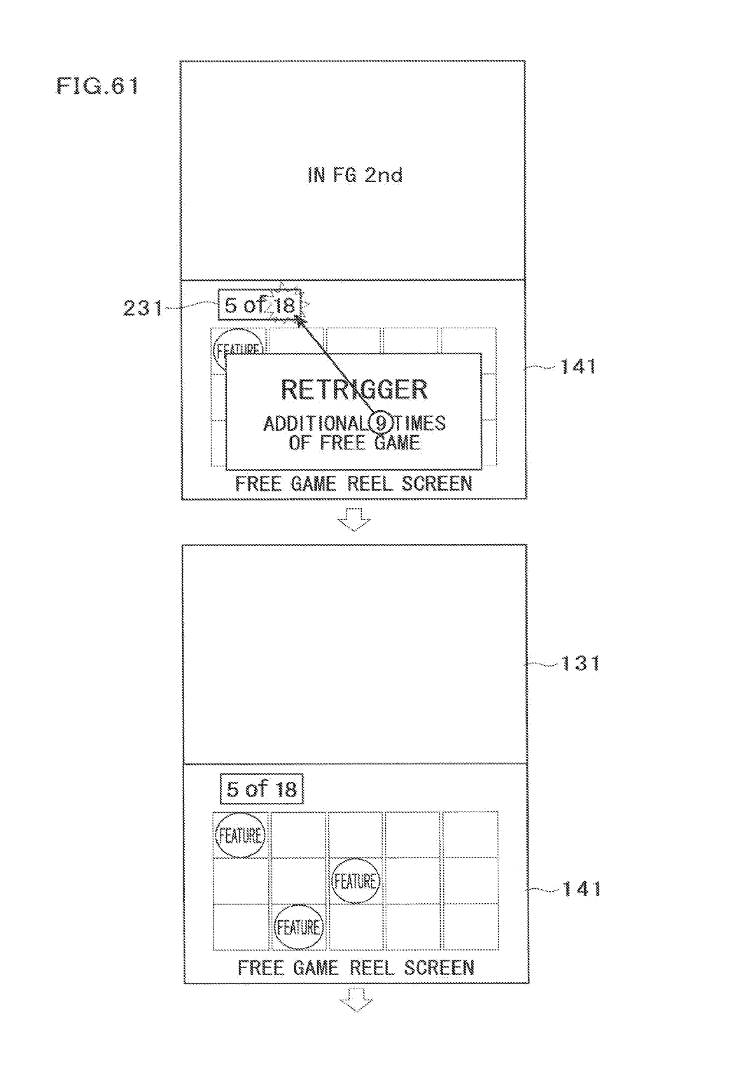

Subsequently, the main CPU 71 determines whether three or more “FEATURE” symbols are rearranged in the symbol display area 4 (S208). When three or more “FEATURE” symbols are rearranged in the symbol display area 4 (S208: YES), “9” is added to the value of the free game play counter in the RAM 73 (S209). For example, when three or more “FEATURE” symbols are rearranged in the symbol display area 4 as shown in FIG. 60, a message is displayed on the lower image display panel 141 to notify that re-trigger has been carried out and 9 times of execution of the free game are added. Subsequently, as shown in FIG. 61, an effect of adding “9” which is the additional number of times of execution of the free game to the current number of times of execution of the free game in a free game number display field 231 is executed on the lower image display panel 141.

In the meanwhile, when three or more “FEATURE” symbols are not rearranged in the symbol display area 4 (S208: NO) or after S209, the main CPU 71 determines whether the “GOLD” symbol is rearranged in the symbol display area 4 (S210). When the “GOLD” symbol is rearranged in the symbol display area 4 (S210: YES), the later-described JP free game process is executed (S211).

When no “GOLD” symbol is rearranged in the symbol display area 4 (S210: NO) or after S211, the main CPU 71 subtracts “1” from the value of the free game play counter of the RAM 73 (S212).

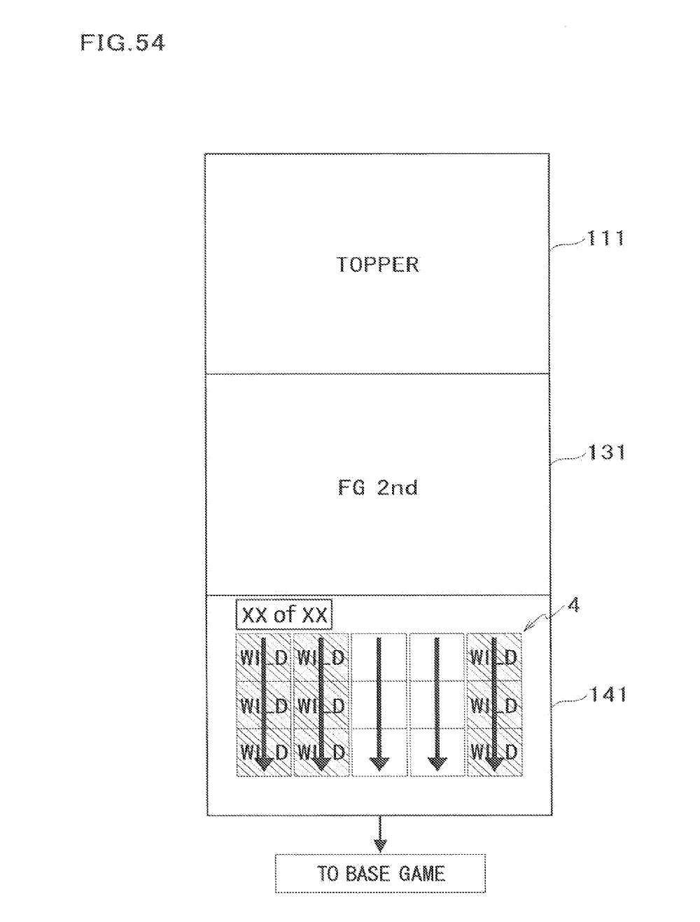

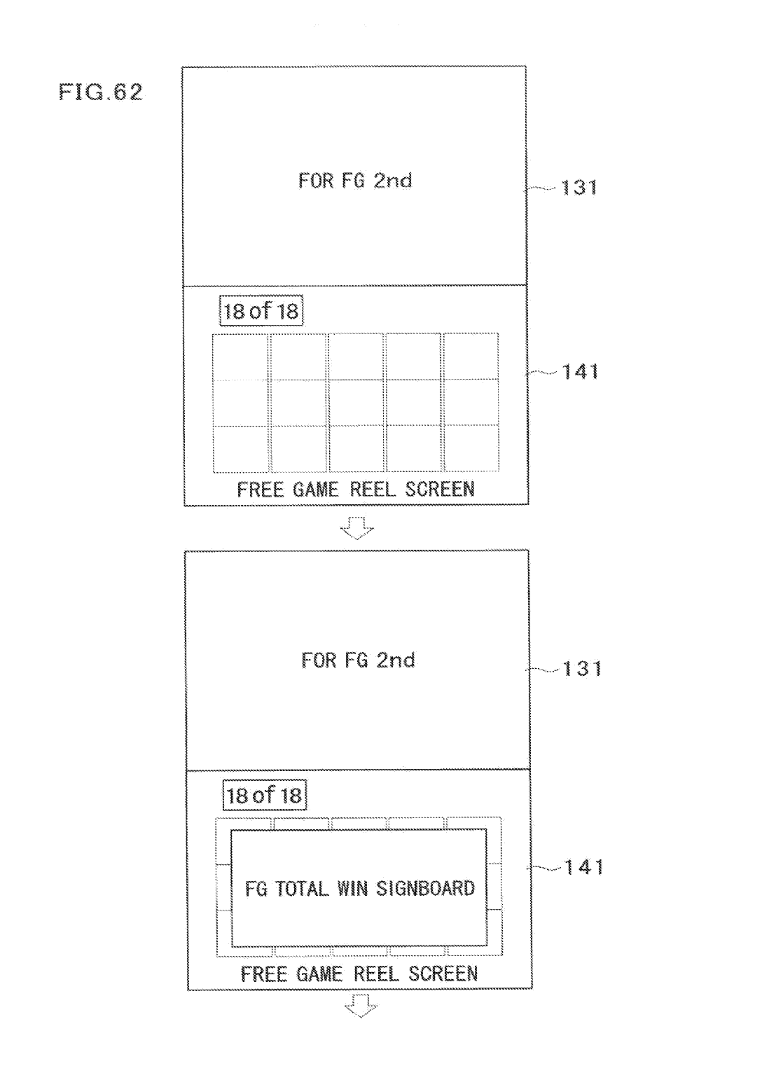

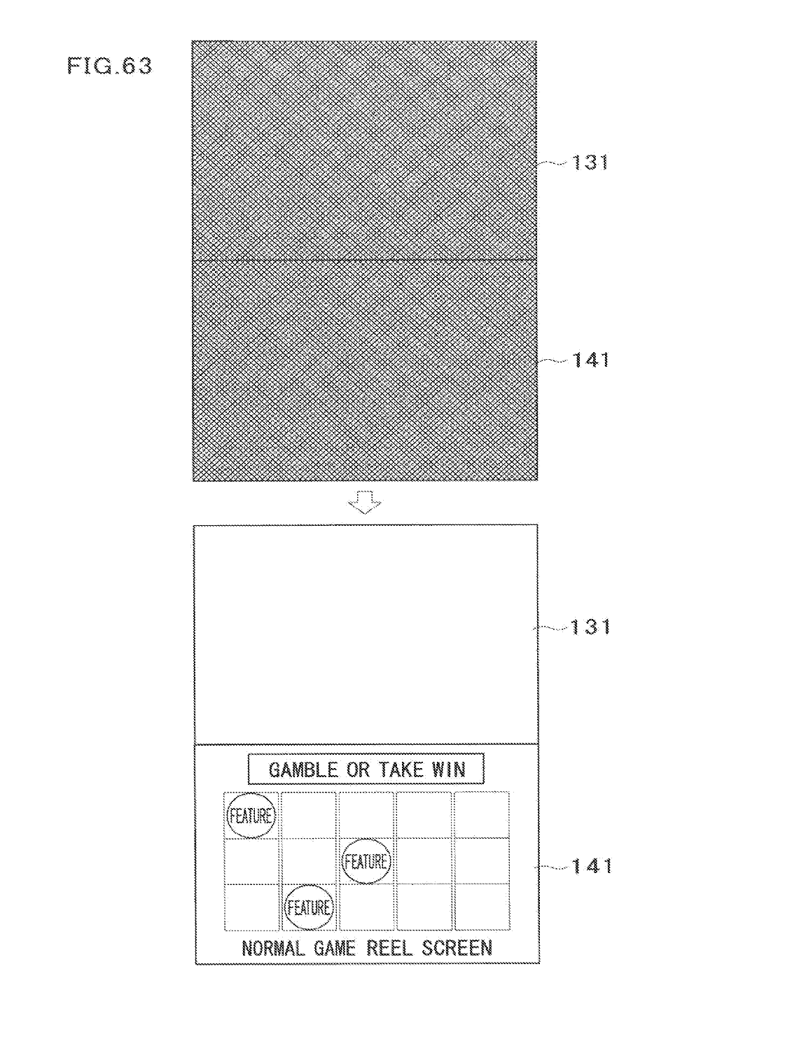

Then the main CPU 71 determines whether the value of the free game play counter of the RAM 73 is 0 (S213). When the value of the free game play counter is not 0 (S213: NO), the process proceeds to S202. When the value of the free game play counter is 0 (S213: YES), the process is terminated. When the process is terminated, as shown in FIG. 62, the total payout obtained in the free game process is displayed on the lower image display panel 141, and as shown in FIG. 63, dark change is performed and then the display screen before the shifting to the free game process returns (see FIG. 54).

(JP Free Game Process)

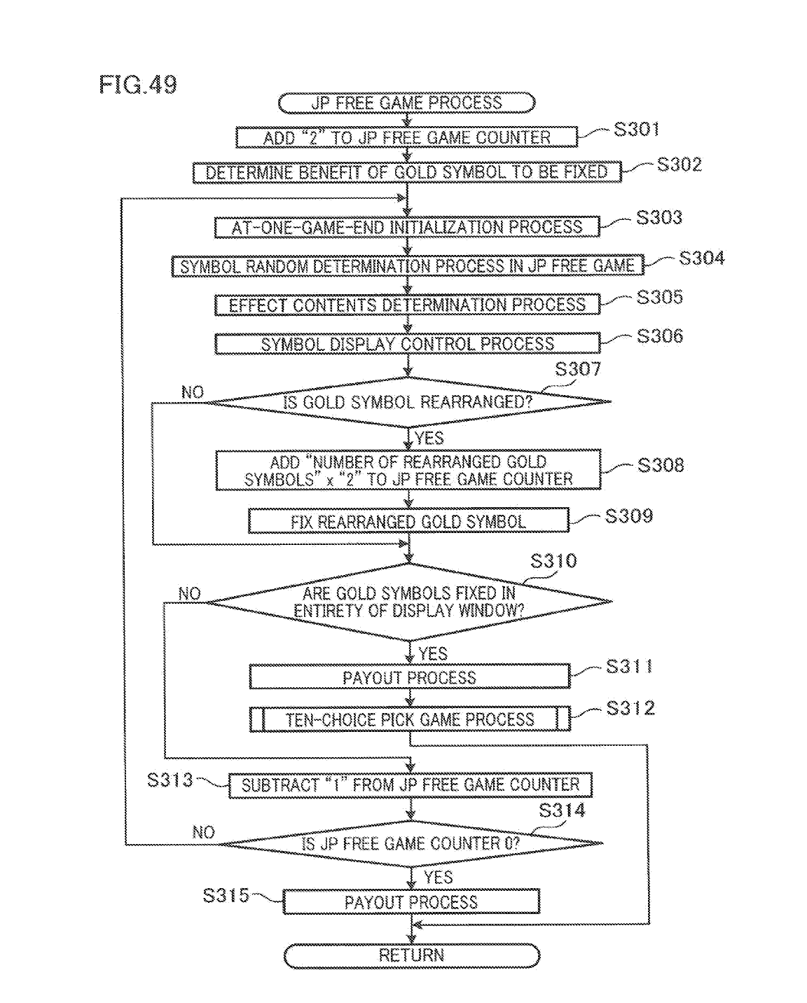

The following describes a JP free game process with reference to FIG. 49.

First, the main CPU 71 adds “2” to the JP free game play counter in the RAM 73 (S301).

Then the main CPU 71 determines the payout value of the “GOLD” symbol which is rearranged and fixed in the symbol display area 4 during the JP free game, with reference to the payout level (“LOW”, “MEDIUM”, “HIGH”, “MINI1”, “MINI2”, “MINI3”, “MINOR1”, “MINOR2”, “MINOR3”, “MAJOR1”, “MAJOR2”, or “MAJOR3”) determined in the payout level random determination process in S14 in the main control process and the payouts of the GOLD symbols of each level (JP free game) shown in FIG. 36 (S302).

For example, when the payout level determined in the payout level random determination process in S14 in the main control process is “MAJOR1” and the “GOLD” symbol is rearranged and fixed first in the middle stage of the first reel (Reel1) 3a during the JP free game, the payout value is 2 credits of “VALUE_2” associated with GOLD1. Furthermore, when the “GOLD” symbol is rearranged and fixed sixth in the lower stage of the third reel (Reel3) 3c, the payout value is 2 credits of “VALUE_2” associated with GOLD6. Furthermore, when the “GOLD” symbol is rearranged and fixed fifteenth in the upper stage of the fifth reel (Reel5) 3e, the payout value is “MAJOR jackpot payout (MAJOR JP)” of “MAJOR” associated with GOLD15.

Next, the main CPU 71 executes the at-one-game-end initialization process (S303) in the same manner as the step S12.

The main CPU 71 then executes a symbol random determination process in the JP free game (S304). In the symbol random determination process in the JP free game, to-be-stopped symbols are randomly selected from symbols provided on the JP free game video reels (see FIG. 24). The to-be-stopped symbols are data for determining five symbols displayed in the middle stage of the symbol display area 4, among the symbols provided on the five symbol arrays.

The main CPU 71 then stores the five selected symbols to be stopped on the JP free game video reels in a symbol storing area in the RAM 73.

Then, the main CPU 71 executes an effect contents determination process (S305). The main CPU 71 extracts an effect-use random number and randomly selects one of a plurality of predetermined effect contents.

Then, the main CPU 71 executes a symbol display control process (S306). In this symbol display control process, before the scroll of the JP free game video reels is started, the “GOLD” symbol and the “BONUS” symbol rearranged in the process which has triggered the shifting to the JP free game process are fixed in the rearranged symbol display area 4. Thereafter, the scroll of the JP free game video reels is started, and the five to-be-stopped symbols determined in the symbol random determination process of the JP free game in S304 are stopped one by one in the middle stage of the symbol display area 4. In other words, 15 symbols including the five to-be-stopped symbols are rearranged in the symbol display area 4. When the rearranged symbols are overlapped with the fixed “GOLD” symbol or “BONUS” symbol, the fixed “GOLD” symbol or “BONUS” symbol is displayed in a preferential manner.

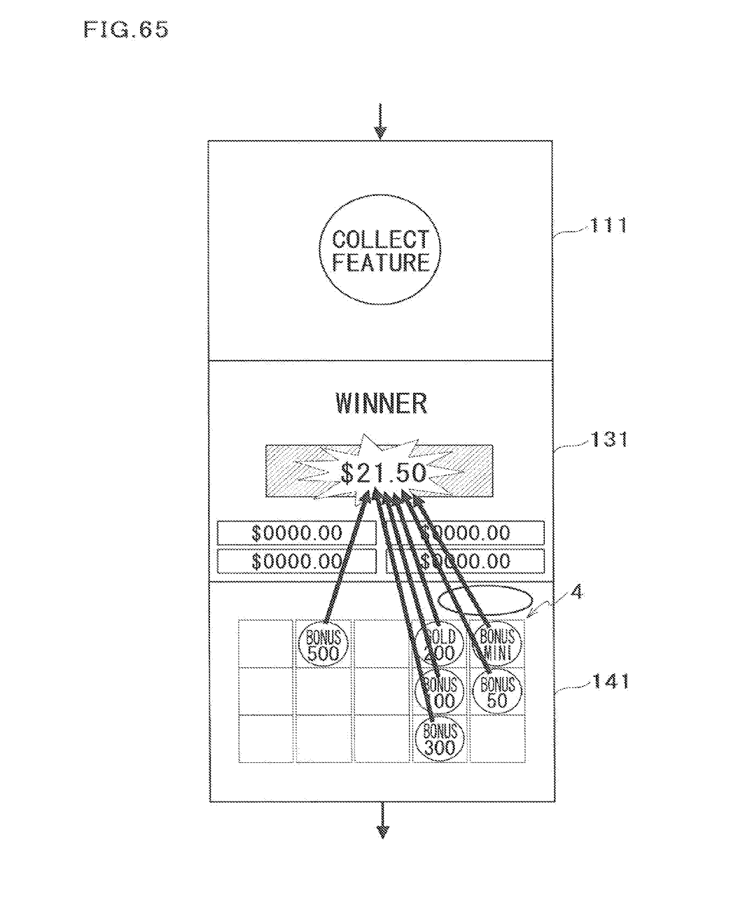

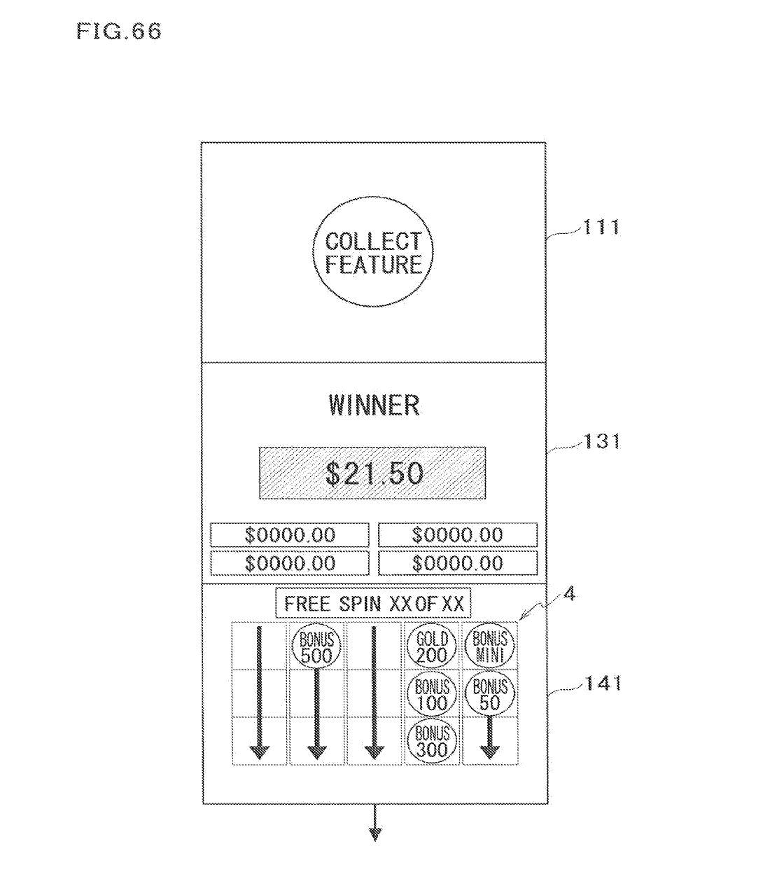

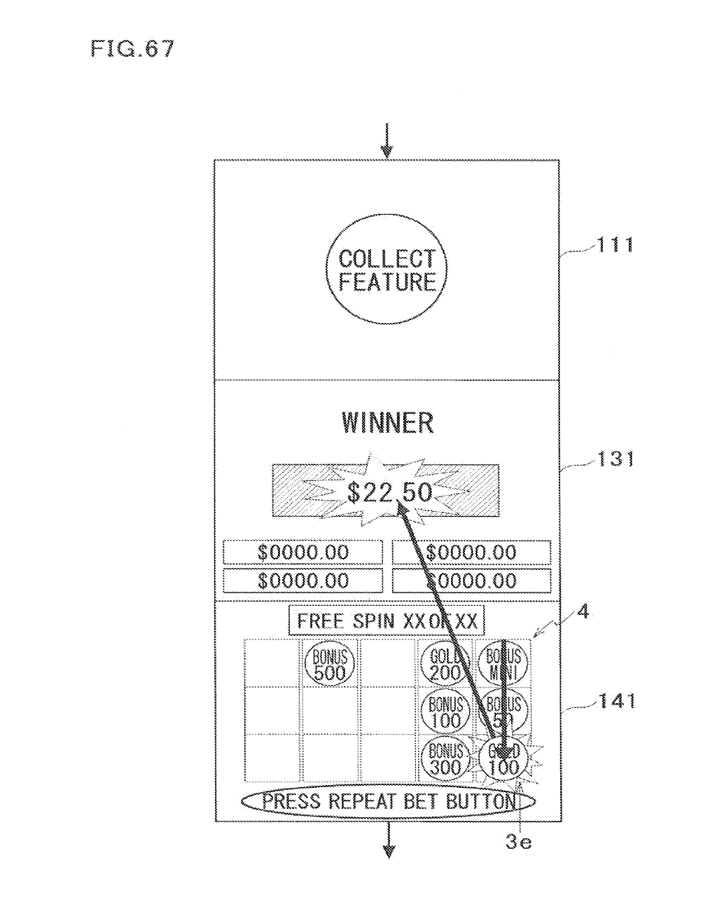

To be more specific, the “GOLD” symbol rearranged in S23 in the main control process and the “BONUS” symbol rearranged in S24 in the main control process, or the “GOLD” symbol rearranged in S210 in the free game process are/is fixed in the symbol display area 4. For example, as shown in FIG. 64, six “BONUS” symbols (one of which has been changed to the “GOLD” symbol) rearranged in the symbol display area 4 in S24 in the main control process are fixed. Thereafter, as shown in FIG. 65, after an effect of awarding a payout amount corresponding to the six “BONUS” symbols rearranged in the symbol display area 4 is executed, as shown in FIG. 66, the scroll of the JP free game video reels is started while the “GOLD” symbol and the “BONUS” symbol are fixed in the symbol display area 4. Thereafter, the five to-be-stopped symbols selected in the symbol random determination process in the JP free game in S304 are stopped one by one in the middle stage of the symbol display area 4. As a result, 15 symbols including the five to-be-stopped symbols are rearranged in the symbol display area 4. When, as shown in FIG. 67, the rearranged symbols are overlapped with the fixed “GOLD” symbol or “BONUS” symbol, the fixed “GOLD” symbol or “BONUS” symbol is displayed in a preferential manner.

When 14 “GOLD” symbols (which may include the “BONUS” symbol) in total are fixed in 15 display frames forming a 5×3 matrix in the symbol display area 4, a sound effect highlighting whether the “GOLD” symbol is to be rearranged in the remaining one display frame in the symbol display area 4 is carried out when the reels 3a to 3e are scrolled, and then these reels 3a to 3e are stopped at the same timing in accordance with the sound effect. This effect is continued until the value of the JP free game play counter becomes 0.

Subsequently, the main CPU 71 determines whether the “GOLD” symbol is rearranged in an area where the “GOLD” symbol or the “BONUS” symbol is fixed in the symbol display area 4 (S307). When new “GOLD” symbol is rearranged in the symbol display area 4 (S307: YES), the main CPU 71 adds, to the value of the JP free game play counter in the RAM 73, a value calculated by adding 2 to the number of the “GOLD” symbols (S308).

After S308, the newly-provided “GOLD” symbol is fixed in the symbol display area 4 (S309). For example, when, as shown in FIG. 67, the “GOLD” symbol is newly rearranged in the lower stage of the fifth reel 3e in the symbol display area 4, the newly-rearranged “GOLD” symbol is fixed to the symbol display area 4.

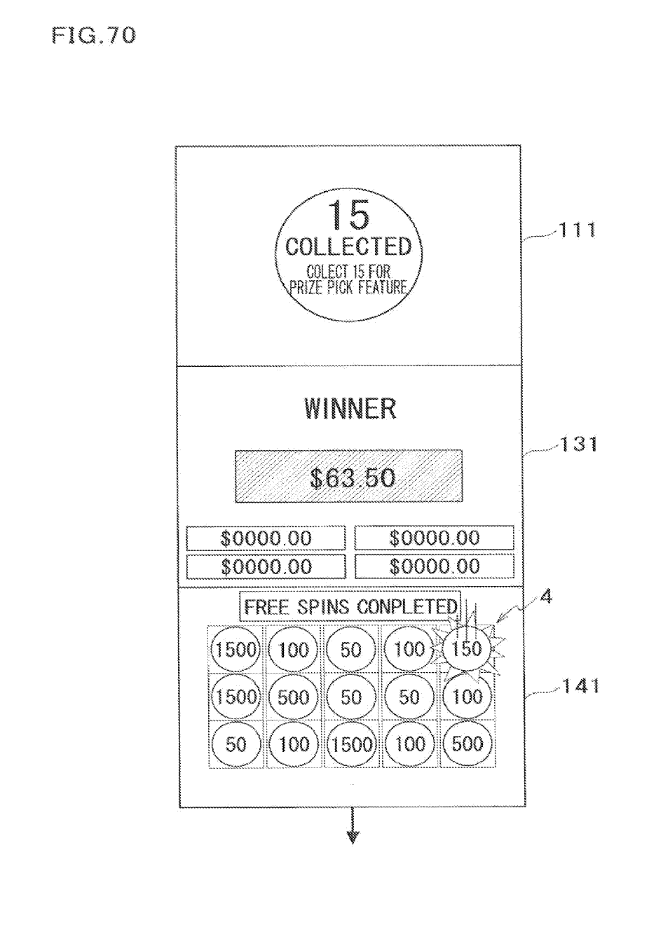

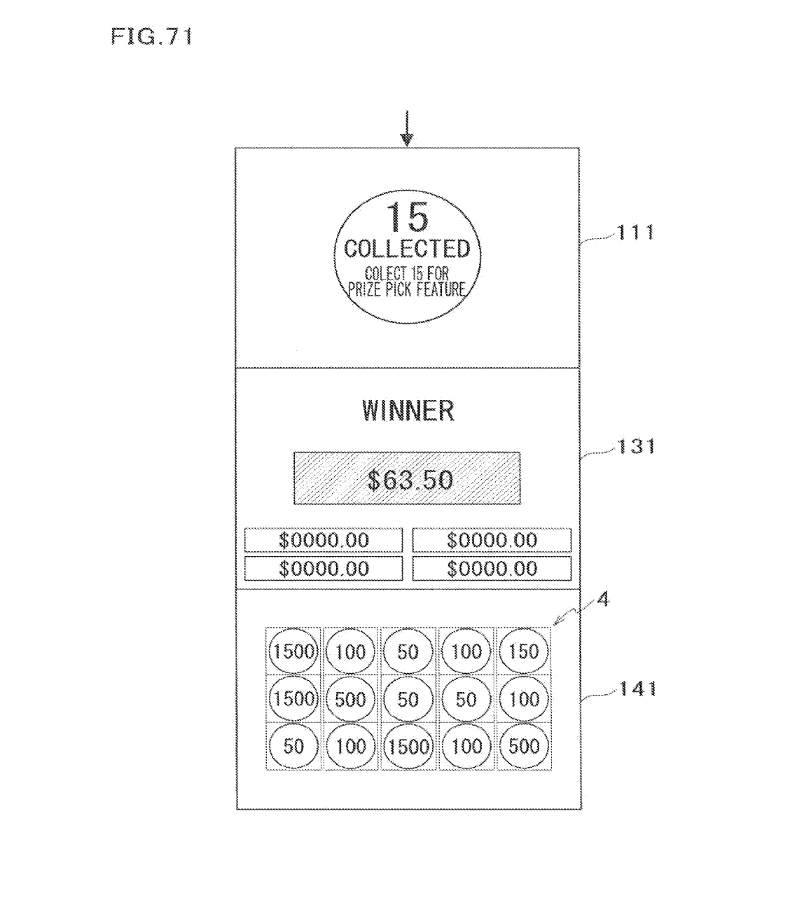

In the meanwhile, when no “GOLD” symbol is newly rearranged in the symbol display area 4 (S307: NO) or after S309, the main CPU 71 determines whether the “GOLD” symbols (which may include the “BONUS” symbol) are fixed in all of the 15 display frames forming a 5×3 matrix in the symbol display area 4 (S310). When the “GOLD” symbols (which may include the “BONUS” symbol) are fixed in all (i.e., the upper limit) of the 15 display frames in the symbol display area 4 (S310: YES). the total payout value of the fixed “GOLD” symbols (including the “BONUS” symbol) is, as a payout to be awarded, added to the value of the credit counter of the RAM 73 (payout process: S311). Subsequently, as shown in FIG. 70 and FIG. 71, the payout values associated with the “GOLD” symbols (including the “BONUS” symbol) are serially added to the total value displayed on the upper image display panel 131 one by one from the first reel 3a to the fifth reel 3e. Then the total of the payout values corresponding to the fixed “GOLD” symbols (including the “BONUS” symbol) is displayed on the upper image display panel 131 as a payout to be awarded.

After S311, the main CPU71 executes a later-described ten-choice pick game process (S312). After S312, the present process ends.

When the “GOLD” symbols (which may include the “BONUS” symbol) are not fixed in all of the 15 display frames in the symbol display area 4 (S310: NO), “1” is subtracted from the JP free game play counter of the RAM 73 (S313).

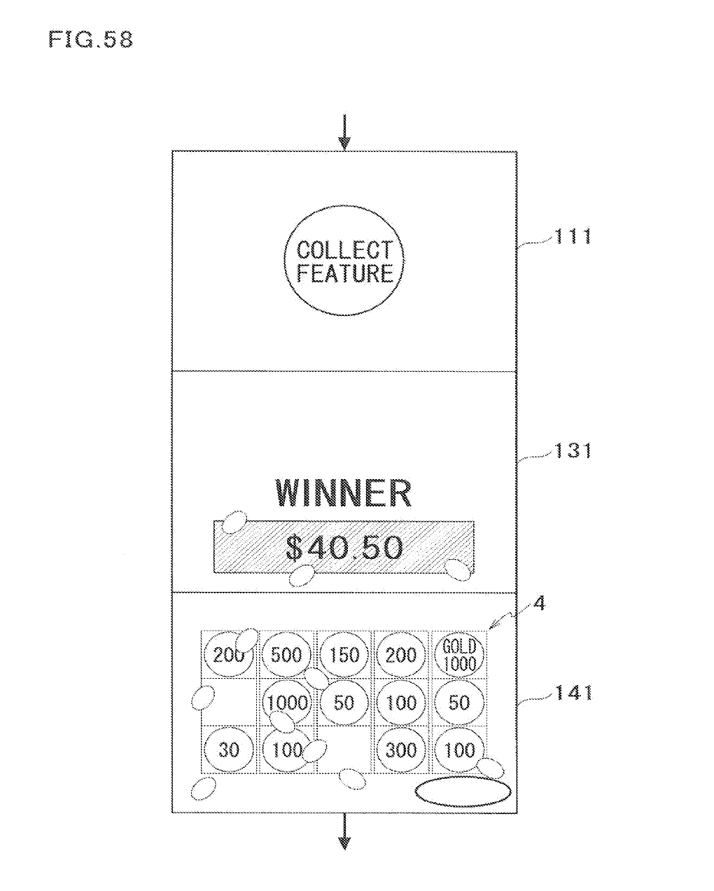

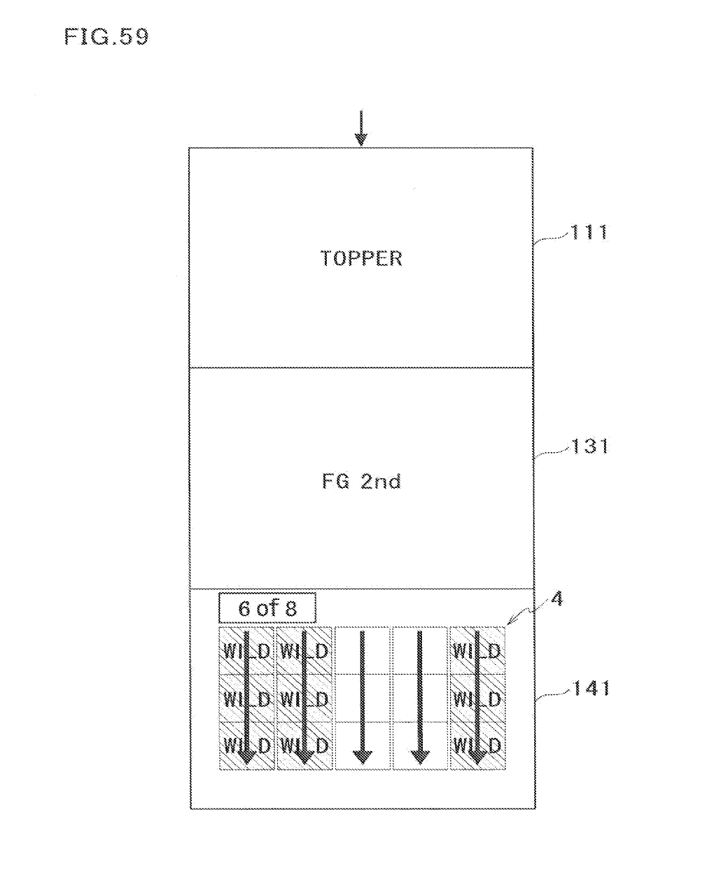

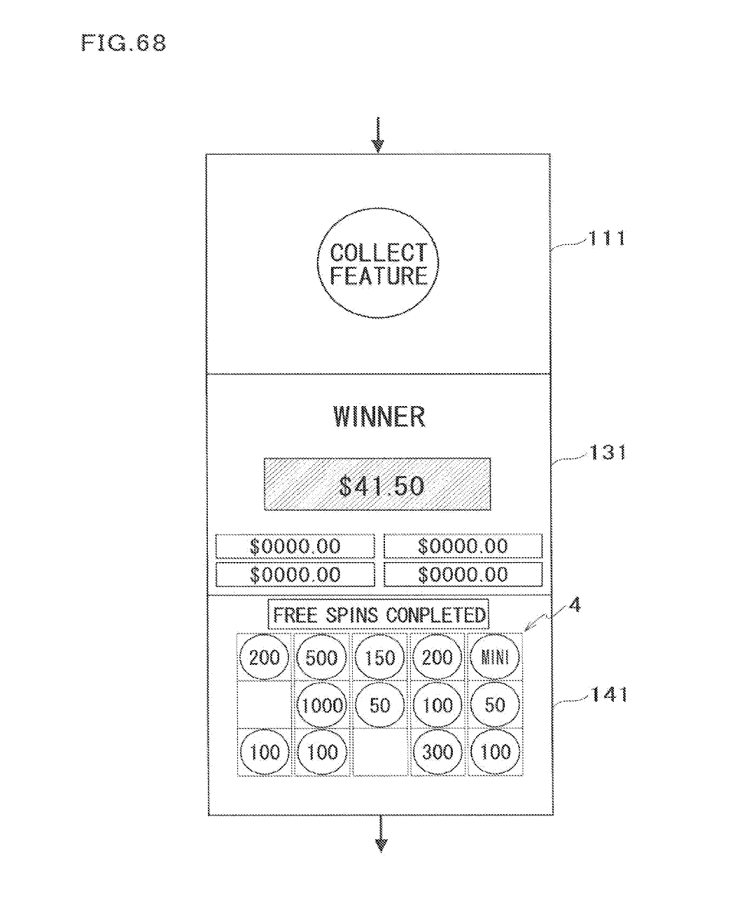

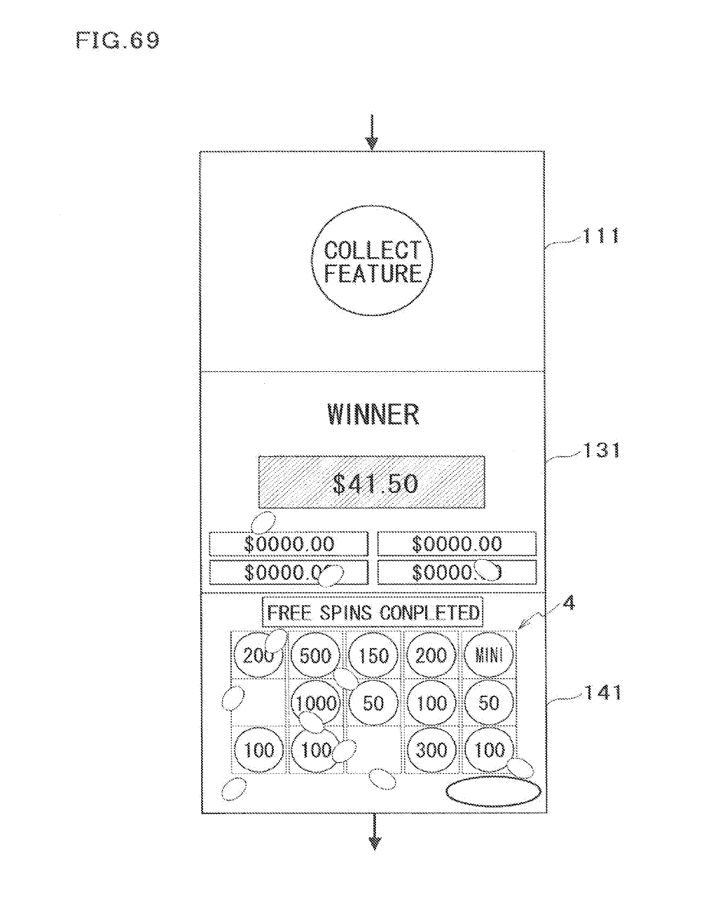

Then the main CPU 71 determines whether the value of the JP free game play counter of the RAM 73 is 0 (S314). When the value of the JP free game play counter is not 0 (S314: NO), the process proceeds to S303. When the value of the JP free game play counter is 0 (S314: YES), the total of the payout values corresponding to the fixed “GOLD” symbols (including the “BONUS” symbol) is, as a payout to be awarded, added to the credit counter of the RAM 73 (payout process: S315). For example, when the “GOLD” symbols (which may include the “BONUS” symbol) are not fixed in all of the 15 display frames of the symbol display area 4 before the value of the JP free game play counter becomes 0, as shown in FIG. 68 and FIG. 69, the total of the payout values corresponding to the fixed “GOLD” symbols (including the “BONUS” symbol) is displayed on the upper image display panel 131 as a payout to be awarded. Then, the present routine ends. When the process is terminated, as shown in FIG. 58, and FIG. 59, a display screen before the shifting to the JP free game process returns.

(Ten-Choice Pick Game Process)

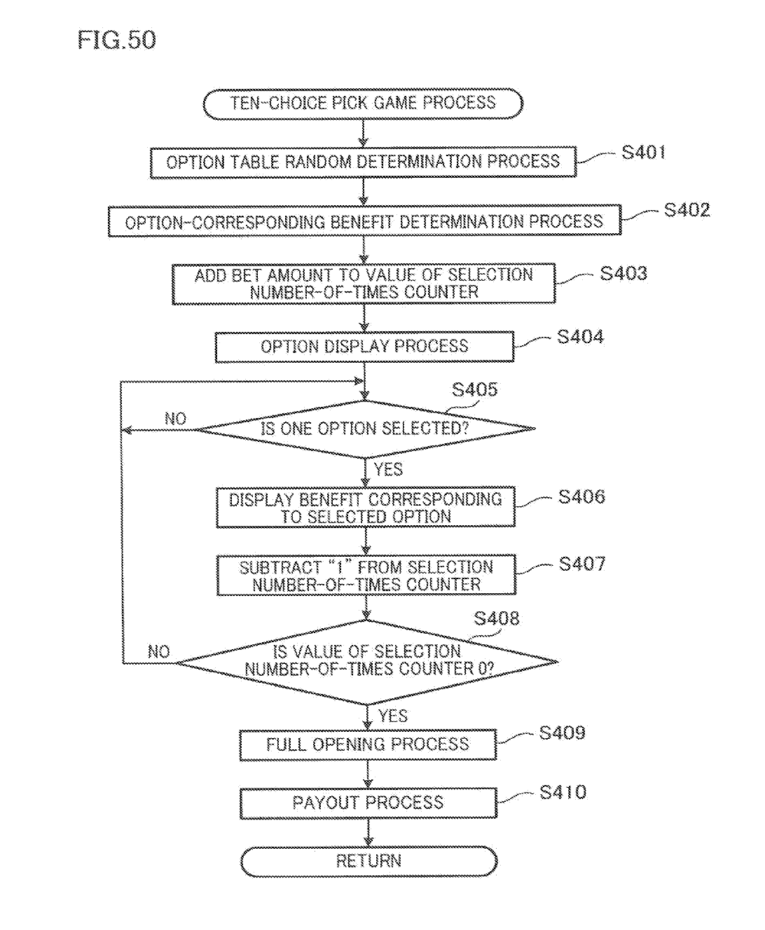

Now, the ten-choice pick game process executed in S312 in the JP free game process will be described with reference to FIG. 50.

To begin with, the main CPU 71 executes an option table random determination process (S401). In the option table random determination process, with reference to the ten-choice payout table random determination tables (FIG. 42 to FIG. 44), “current denominations (1 cent, 2 cents, and 5 cents): cent(s)”, “bet amount betted on each activated winning line: Bet Multiplier”, and “numbers of activated winning lines: LINE”, one of seven ten-option payout tables (Table_0, Table_1, Table_2, Table_3, Table_4, Table_5, and Table_6) is selected.

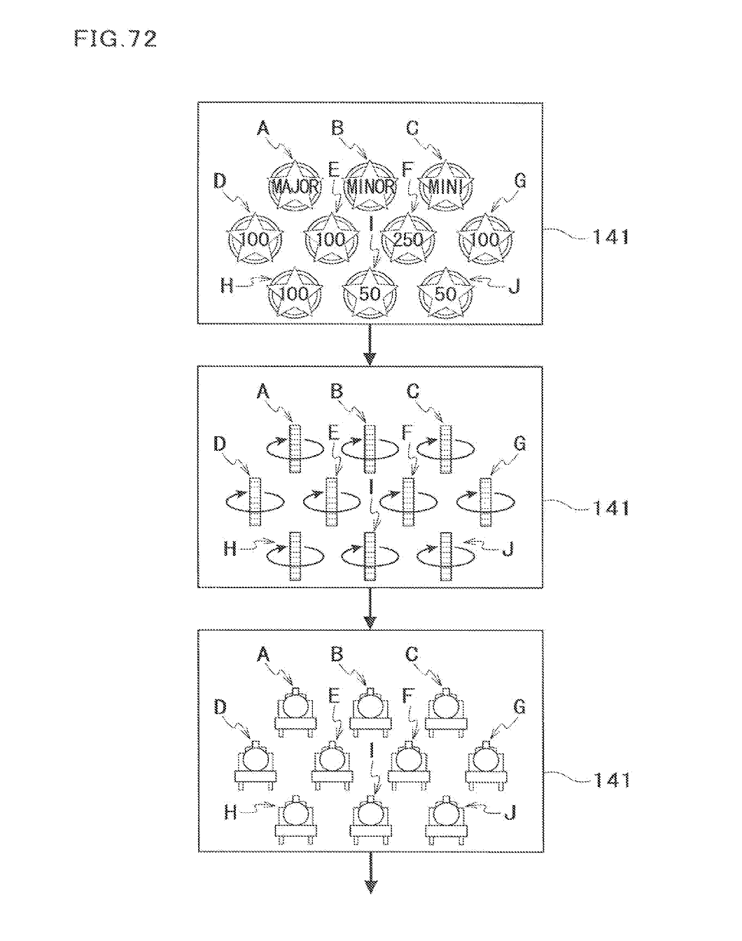

Subsequently, the main CPU 71 executes an option-corresponding benefit determination process (S402). In the option-corresponding benefit determination process, ten types of payouts (No. 0 to No. 9) of the ten-choice payout table (one of Table_0, Table_1, Table_2, Table_3, Table_4, Table_5, and Table_6) (see FIG. 45) selected in S401 are randomly associated with ten options A to J (see FIG. 72) displayed in a later-described option display process in S404. The types of the payouts to be associated are values calculated by multiplying the number of winning lines activated in S13 in the main control process, except the “MAJOR” (MAJOR jackpot payout) and “GRAND” “GRAND jackpot payout).

For example, when “current denomination” is 1 cent, “bet amount betted on each activated winning line” is 5 bets, and “number of activated winning lines” is 10 lines, a random determination table in which the probabilities are defined as follows is used: the probability of the selection of “Table_0” is “2000/2500”, the probability of the selection of “Table_1” is “490/2500”, the probability of the selection of “Table_2” is “0/2500”, the probability of the selection of “Table_3” is “0/2500”, the probability of the selection of “Table_4” is “0/2500”, the probability of the selection of “Table_5” is “0/2500”, and the probability of the selection of “Table_6” is “10/2500”. When the Table_1 is selected at the probability of 490/2500 based on the random determination table, the ten-choice payout table shown in FIG. 45 is referred to and values (except “MAJOR” and “GRAND”) calculated by multiplying ten types of payouts, i.e., “5”, “5”, “10”, “10”, “10”, “10”, “25”, “MINI”, “MINOR” and “MAJOR” corresponding to No. 0 to No. 9 by “10” which is the number of activated winning lines are randomly associated with ten options A to J (see FIG. 72). That is to say, each of the ten types of payouts, i.e., “50”, “50”, “100”, “100”, “100”, “100”, “250”, “MINI”, “MINOR” and “MAJOR” is associated with one of the ten options A to J. When the ten types of payouts are associated with the ten options A to J, random determination may not be performed and options to be associated may be determined in advance.

Subsequently, the main CPU 71 adds the “bet amount betted on each activated winning line: Bet Multiplier” to the value of a selection number-of-times counter (S403). For example, when the bet amount on each activated winning line made by the 5-BET button 39 in S13 is 5, “5” is added to the value of the selection number-of-times counter.

Subsequently, the main CPU 71 executes an option display process (S404). In the option display process, as shown in FIG. 72, the ten options A to J associated with the ten types of payouts in the option-corresponding benefit determination process in S402 are displayed on the lower image display panel 141. For example, as shown in FIG. 72, the lower image display panel 141 displays the option A associated with “MAJOR”, the option B associated with “MINOR”, the option C associated with “MINI”, the option D associated with “100”, the option E associated with “100”, the option F associated with “250”, the option G associated with “100”, the option H associated with “100”, the option I associated with “50”, and the option J associated with “50”.

On the lower image display panel 141, after the ten options A to J associated with the ten types of payouts are displayed, as shown in FIG. 72, an image effect is executed in such a way that the options A to J are turned over and the types of payouts associated with the options A to J are hidden (non-displayed). As a result, as shown in FIG. 72, the options A to J look the same pictures of a steam locomotive.

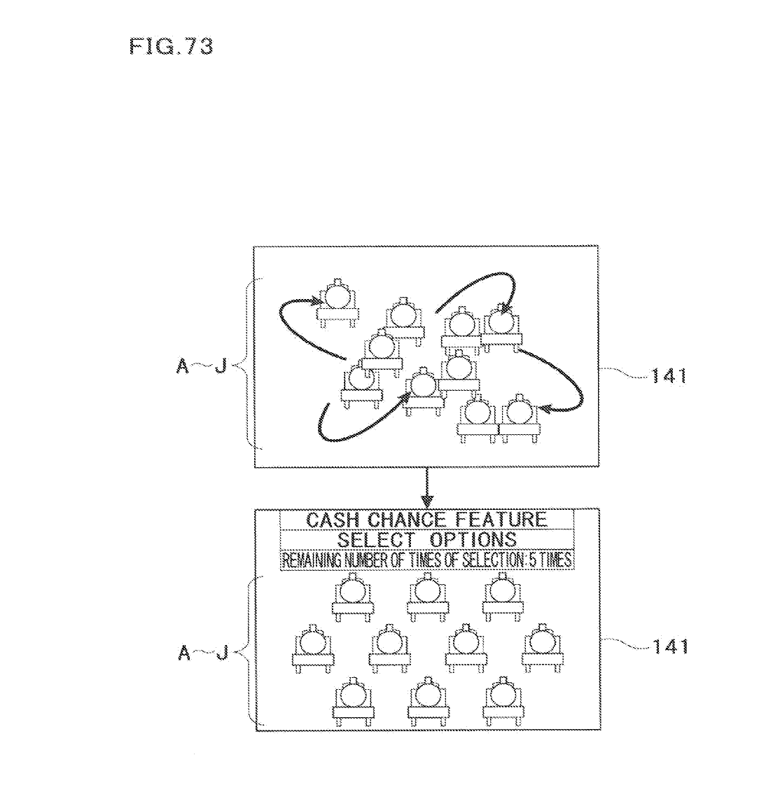

After the options A to J are displayed as pictures of the same steam locomotive, as shown in FIG. 73, (shuffle) effect display is executed so that the ten options A to J displayed on the lower image display panel 141 are shuffled by moving the options in an intersecting manner. The effect display of mixing (shuffling) the ten options A to J may be executed by moving the options in a non-intersecting manner. The effect display of mixing (shuffling) the ten options A to J may be executed in such a way that all of the options A to J are gathered to one part and are then scattered. Because the options are moved in an intersecting manner as above, the options A to J are shuffled at the points where the options intersect with one another, with the result that the player is unable to or hardly able to recognize which type of payout corresponds to each option.

After the effect display of shuffling the options A to J, as shown in FIG. 73, a message “select options” and a message “remaining number of times of selection: xx times” (the value of the selection number-of-times counter) are displayed on the lower image display panel 141. For example, when the value of the selection number-of-times counter in the RAM 73 is 5, a message “remaining number of times of selection: 5 times” is displayed on the lower image display panel 141.

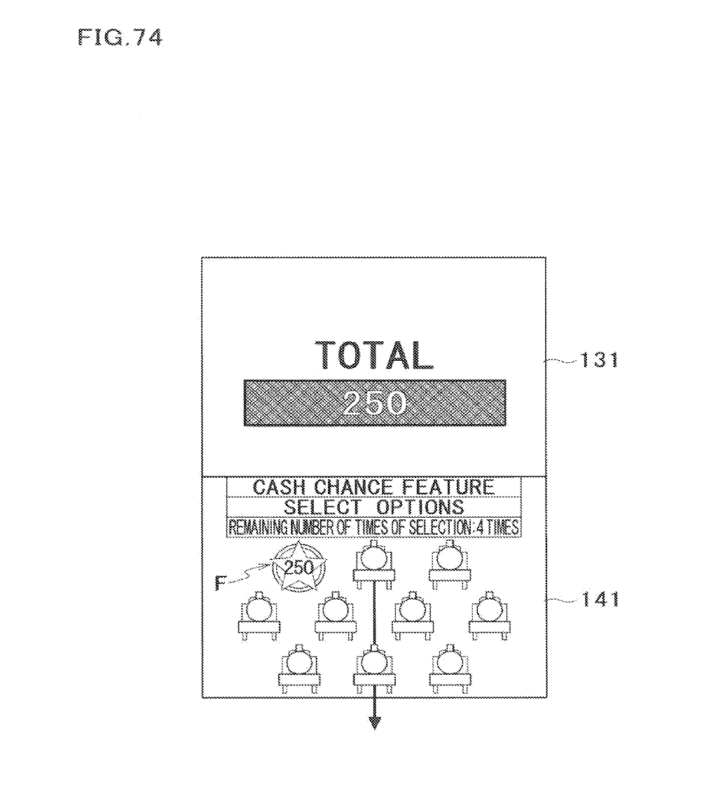

Then, the main CPU 71 determines which one of the options A to J displayed on the lower image display panel 141 has been selected (S405). When one of the options A to J has been selected (S405: YES), the type of payout corresponding to the selected one of the options A to J is displayed (S406). For example, when the option F is associated with “250” in S402, the payout amount of “250” is displayed when the option F is selected as shown in FIG. 74. At the same time, the upper image display panel 131 displays the total payout amount which is displayed as a result of the selection of the options A to J. The selection of the options A to J is done by means of a touch panel 114.

The main CPU 71 then subtracts 1 from the value of the selection number-of-times counter in the RAM 73 (S407). At the same time, the message “remaining number of times of selection: xx times” displayed on the lower image display panel 141 is updated. For example, when the value of the selection number-of-times counter in the RAM 73 is updated to 4 in S407, a message “the remaining number of times of selection: 4 times” is displayed on the lower image display panel 141 as shown in FIG. 74.

Then the main CPU 71 determines whether the value of the selection number-of-times counter of the RAM 73 is 0 (S408). When the value of the selection number-of-times counter is not 0 (S408: NO), the process proceeds to S405. In other words, the selection of the options A to J is possible until the value of the selection number-of-times counter becomes 0. Each option cannot be selected more than once.

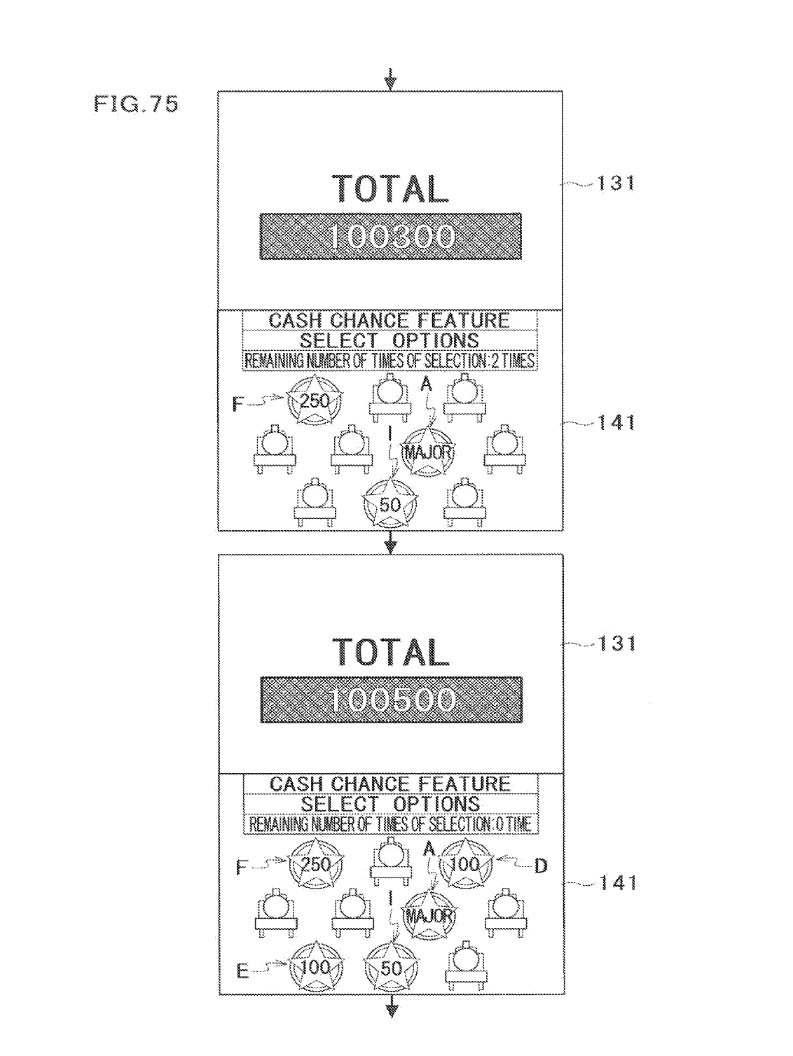

For example, when 5 is added to the value of the selection number-of-times counter in S403, the steps S405 to S407 are repeated five times. On this account, as shown in FIG. 75, each time one of the options A to J is selected five times, the type of payout corresponding to the selected ones of the options A to J is displayed. For example, as shown in FIG. 75, the payout amount of “250” is displayed when the option F is selected, “MAJOR” is displayed when the option A is selected, the payout amount of “50” is displayed when the option I is selected, the payout amount of “100” is displayed when the option D is selected, and the payout amount of “100” is displayed when the option E is selected.

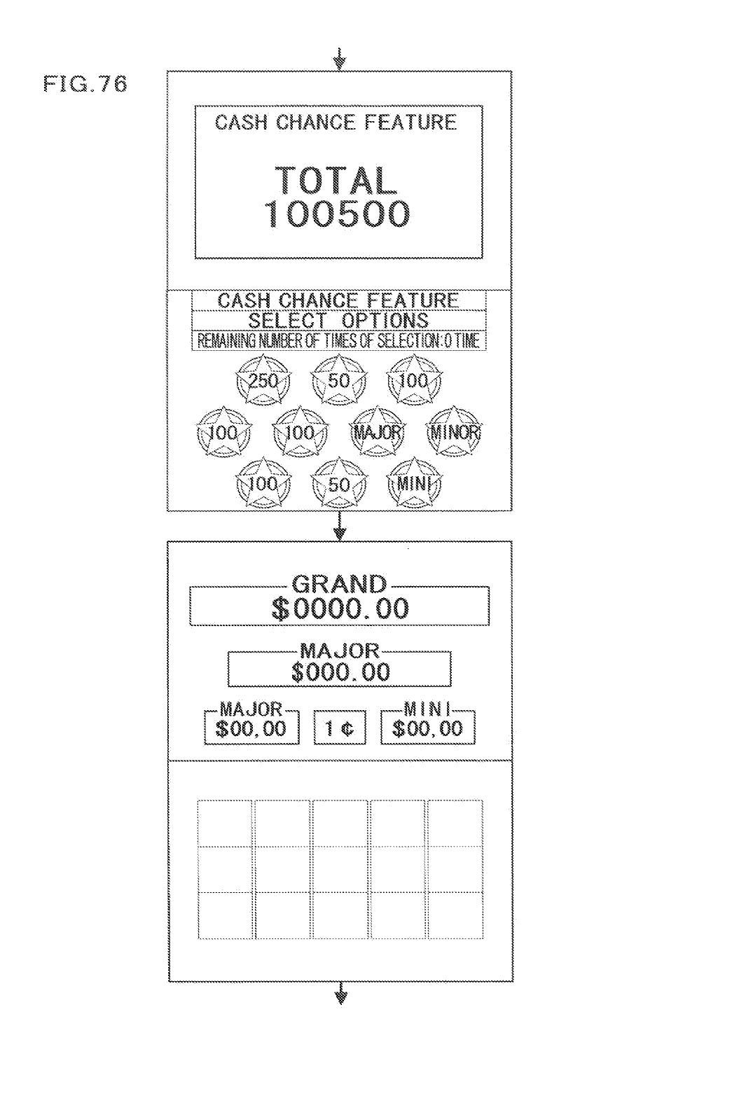

When the value of the selection number-of-times counter is 0 (S408: YES), the main CPU 71 executes a full opening process (S409). In this full opening process, the types of payouts corresponding to the options A to J which are not selected in the steps S405 to S407 are displayed. For example, when the types of payouts corresponding to the options (F, A, I, D, and E) selected in the steps S405 to S407 are displayed as shown in FIG. 75, the types of payouts corresponding to the options (B, C, G, H, and J) not selected in the steps S405 to S407 are displayed as shown in FIG. 76. That to is to say, “MINOR” associated with the option B, “MINI” associated with the option C, the payout amount of “100” associated with the option G, the payout amount “100” associated with the option H, and the payout amount of “50” associated with the option J are displayed. The options (F, A, I, D, and E) selected in the steps S405 to S407 and the options (B, C, G, H, and J) not selected in the steps S405 to S407 are shown in different colors for the player's recognition.

This arrangement makes it possible to display the types of payouts corresponding to the options not selected in the steps S405 to S407. Because the types of payouts corresponding to all options A to J are disclosed to the player, the player is able to verify his/her selection.

Then, the main CPU 71 executes a payout process (S410). In this payout process, the total of the types of payouts displayed on the options A to J selected in the steps S405 to S407 is added to the value of the credit counter in the RAM 73. At this stage, as shown in FIG. 76, the total amount of the types of payouts is displayed on the upper image display panel 131.

Then, this process ends. When the process is terminated, as shown in FIG. 76, a display screen before the shifting to the ten-choice pick game process returns.

In the ten-choice pick game process, to begin with, as the types of payouts randomly associated with the options A to J are displayed, the player recognizes in advance what types of payouts are available before the selection of the options A to J. As such, it is possible to inform the whole picture of the types of payout to the player. Thereafter, the displayed types of payouts are hidden, and effect display of mixing the options A to J is executed, with the result that the options A to J are shuffled and it becomes impossible or difficult to recognize which type of payout is associated with each option. Subsequently, the selection of the options A to J is received by the touch panel 114 (equivalent to an input device). As the type of payout associated with the selected option, the player recognizes which payout is selected from the plural types of payouts which have been informed in advance.

[GAMBLE Specification]

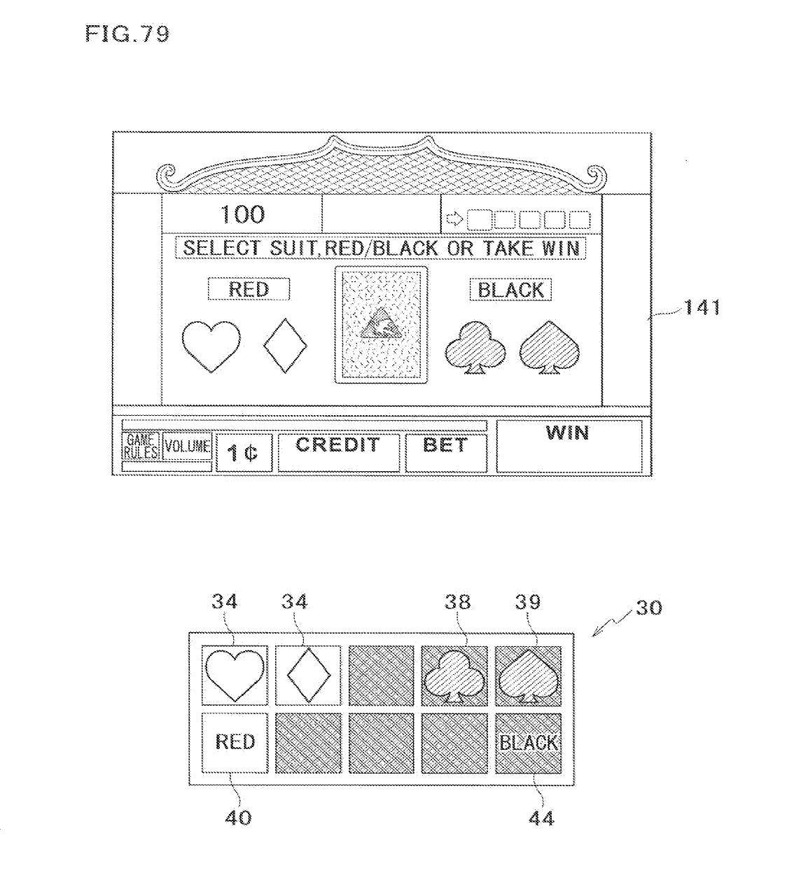

Now, the GAMBLE specification in the slot machine 1 will be described with reference to FIG. 79 to FIG. 81. Each of FIG. 79 to FIG. 81 illustrates GAMBLE specification in the slot machine of the embodiment of the present invention. The GAMBLE is a game which can be run based on the selection by the player, when a winning (WIN) is achieved in the slot game. A person who installs the slot machine 1 is allowed to set so that a game related to the GAMBLE cannot be run.

To begin with, when a winning (WIN) is achieved in the slot game, a message “PLAY ON, GAMBLE or TAKE WIN” is displayed on the lower image display panel 141. Thereafter, when GAMBLE is executed, as shown in FIG. 79, a red heart, a red diamond, a black clover, and a black spade are displayed on the lower image display panel 141, and a message “SELECT SUIT, RED/BLACK OR TAKE WIN” is displayed on the lower image display panel 141.

At this stage, as shown in FIG. 79, on the control panel 30, the 1-BET button 34 becomes a button for selecting the heart, the 2-BET button 35 becomes a button for selecting the diamond, the 4-BET button 38 becomes a button for selecting the clover, the 5-BET button 39 becomes a button for selecting the spade, the play-1-line button 40 becomes a button for selecting “RED” (heart or diamond), and the play-50-line button 44 becomes a button for selecting “BLACK” (clover or spade).

Subsequently, on the lower image display panel 141 shown in FIG. 79, a betted amount is displayed on the lower image display panel 141 as “GAMBLE AMOUNT”. The player selects, by the control panel 30, one of the selection buttons “RED”, “BLACK”, “heart”, “diamond”, “clover”, and “spade”. When the TAKE WIN button 32 is selected, the current value of the WIN meter is added and a screen before the shifting to the GAMBLE returns.

In the present embodiment, the probability of success in the selection of “RED” is 1/2, the probability of success in the selection of “BLACK” is 1/2, the probability of success in the selection of “heart” is 1/4, the probability of success in the selection of “diamond” is 1/4, the probability of success in the selection of “clover” is 1/4, and the probability of success in the selection of “spade” is 1/4.

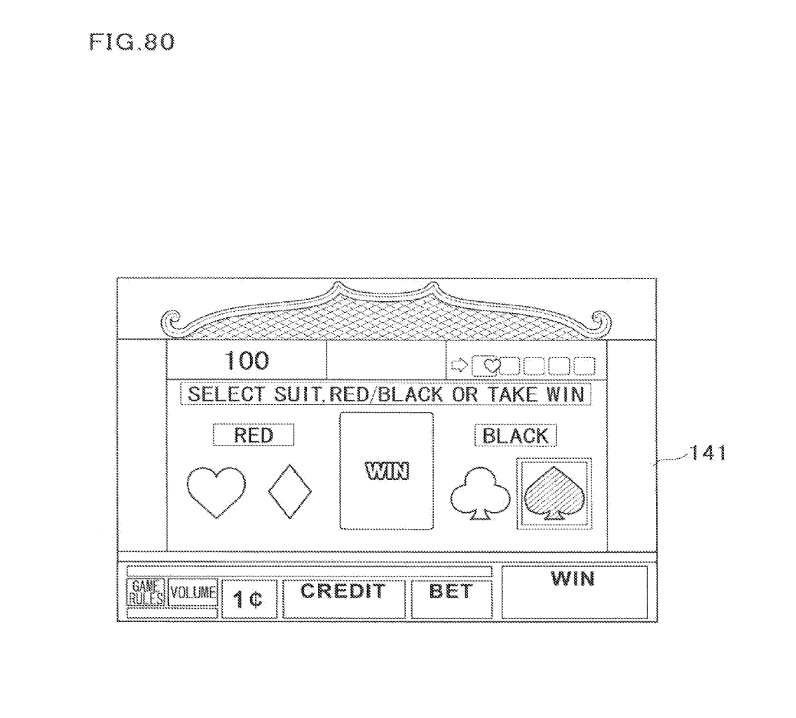

When the selection is succeeded as a result of random determination, on the lower image display panel 141, options which are not selected are darkened (changed in color) as shown in FIG. 80. Then the card design having been won is displayed in the leftmost part of the GAMBLE HISTORY column in the lower image display panel 141 (the card designs previously won are shifted rightward). Then, as shown in FIG. 80, the card design having been won and the message “WIN” are alternately displayed on the lower image display panel 141 (and sound indicating winning is reproduced). Then the payout obtained in the GAMBLE game is awarded. When the GAMBLE game is executed for the maximum number of times (five times), a screen before the shifting to the GAMBLE returns. When the GAMBLE game has not be executed for the maximum number of times (five times), a screen shown in FIG. 79 returns.

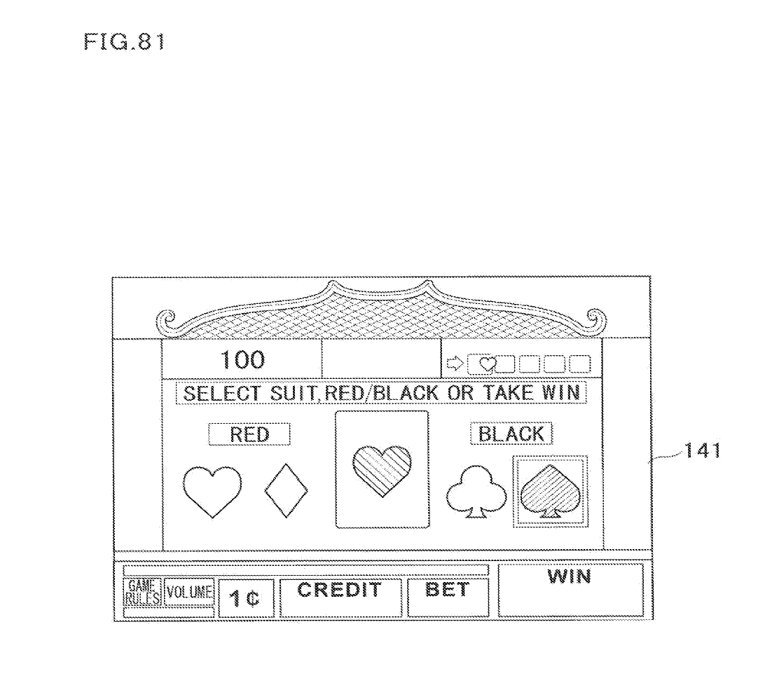

In the meanwhile, when the selection results in a failure, on the lower image display panel 141, the options other than the selected option are darkened (changed in color) as shown in FIG. 81. Then the card design having been won is displayed in the leftmost part of the GAMBEL HISTORY column in the lower image display panel 141 (the card designs previously won are shifted rightward). Then, as shown in FIG. 81, the card design having been won is displayed on the lower image display panel 141 (and sound indicating failure is reproduced and “0” is displayed on the WIN meter). Then a screen before the shifting to the GAMBLE returns.

(Others)

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine comprising:
a display device capable of displaying plural options;
a storage device configured to store a benefit table in which benefits to be associated with the options are stored;
an input device which allows the options to be selectable; and
a controller programmed to execute the processes of:
(A1) causing the options displayed on the display device to be randomly associated with the benefits stored in the benefit table, respectively;
(A2) displaying the benefits associated with the options, together with the options;
(A3) hiding the displayed benefits associated with the options;
(A4) executing effect display of shuffling the options;
(A5) receiving, by the input device, an input of selecting one of the options;
(A6) displaying the benefit associated with the one of the options selected by the input device; and
(A7) repeating the processes (A5) and (A6) for a predetermined number of times.

2. The gaming machine according to claim 1, wherein,
the controller is programmed to further execute a process of,
in the effect display of shuffling the options in the process (A4), executing effect display of moving the options so that the options intersect one another.

3. The gaming machine according to claim 1, wherein,
the controller is programmed to further execute a process of,
(A8) after the process (A7), displaying the benefits associated the options which are not selected.

4. A gaming machine comprising:
a display device capable of displaying options; and
a controller programmed to execute the processes of:
displaying the benefits associated with the options, together with the options;
hiding the displayed benefits associated with the options;
executing effect display of shuffling the options; and
displaying the benefit associated with the selected one of the options.
